(19) United States
(12) Patent Application Publication
(10) Pub. No.: US 2013/0010187 A1
(43) Pub. Date: Jan. 10, 2013

(54) SIGNAL TRANSMITTING DEVICE, SIGNAL TRANSMITTING METHOD, SIGNAL RECEIVING DEVICE, SIGNAL RECEIVING METHOD, AND SIGNAL TRANSMISSION SYSTEM

(76) Inventor: Shigeyuki Yamashita, Kanagawa (JP)

(21) Appl. No.: 13/537,761

(22) Filed: Jun. 29, 2012

(30) Foreign Application Priority Data
Jul. 7, 2011 (JP) 2011-151191

(51) Int. Cl. H04N 7/01

(52) U.S. Cl. 348/441; 348/E07.003

(57) ABSTRACT

A signal transmitting device includes: a first mapping unit including a two-pixel thinning control unit that thins out two pixel samples adjacent to each other in the same line from a class image whose number of pixels in a frame is greater than that of pixels defined in the HD-SDI format and that maps the thinned-out pixel samples onto a video data area of first to N-th sub-images, and a line thinning control unit that converts the first to N/2-th sub-images into 4:2:2/r bit signals and converts the (N/2+1)-th to N-th sub-images into 4:0:0/r bit signals; and a second mapping unit that outputs a dual link HD-SDI signal obtained by converting a data structure of the 4:2:2/r bit signal and a data structure of the 4:0:0/r bit signal in a basic stream output from the first mapping unit into a data structure of a 4:4:4/r bit signal.

### FIELD

The present disclosure relates to a signal transmitting device, a signal transmitting method, a signal receiving device, a signal receiving method, and a signal transmission system, which can be suitably used to serially transmit a video signal in which the number of pixels in a frame is greater than the number of pixels defined in the HD-SDI format.

### BACKGROUND

An image receiving system or an imaging system for an ultra-high definition video signal higher in definition than the current RD (High Definition) video signal which is a video signal with a frame of 1920 samples×1080 lines has been developed. For example, an UHDTV (Ultra High Definition TV) standard which is a next-generation broadcast system with the number of pixels 4 times or 16 times the number of pixels defined in the current HD has been standardized by international associations. Examples of the international associations include the ITU (International Telecommunication Union) or the SMPTE (Society of Motion Picture and Television Engineers).

JP-A-2005-328494 discloses a technique of transmitting a 3840×2160/30P and 30/1.001P/4:4:4/12 bit signal which is a kind of 4 k×2 k signal (ultra-high-definition signal of 4 k×2 k) at a bit rate of 10 Gbps or higher. A video signal expressed by m samples×n lines is substantially referred to as an “m×n” signal. [3840×2160/30P] represents [number of pixels in the horizontal direction]×[number of lines in the vertical direction]/[number of frames per second]. [4:4:4] represents the ratio of [red signal R:green signal G:blue signal B] in the case of a primary color signal transmission system and represents the ratio of [luminance signal Y:primary color-difference signal Cb:secondary color-difference signal Cr] in the case of a color-difference signal transmission system.

In the following description, 50P, 59.94P, and 60P representing the frame rate of a progressive signal are abbreviated to “50P-60P” and 47.95P, 48P, 50P, 59.94P, and 60P are abbreviated to “48P-60P”. 100P, 119.88P, and 120P are abbreviated to “100P-120P” and 95.9P, 96P, 100P, 119.88P, and 120P are abbreviated to “96P-120P”. 50I, 59.94I, and 60I representing the frame rate of an interlaced signal are approximately referred to as “50I to 60I” and 47.95I, 48I, 50I, 59.94I, and 60I are abbreviated to “48I to 60I”. 3840×2160/100P-120P/4:2:0/10 bit or 12 bit signal are also abbreviated to “3840×2160/100P-120P signals”.

### SUMMARY

In the recent SMPTE or ITU, a video signal standard or an interface standard of 3840×2160 or 7680×4320 with a frame rate of 23.9P-60P has been standardized. When the mode D (see FIG. 8 to be described later) is used to transmit video data, a video signal of 3840×2160/23.98P-30P can be transmitted at 10 G-SDI of 1 channel. However, an interface used to transmit a video signal with a frame rate of equal to or higher than 120P has not been studied nor standardized. Since a video signal standard corresponding to 1920×1080 or 2048×1080 defines only a frame rate of at most 60P, a large number of pixel samples cannot be transmitted via an existing interface even using the technique disclosed in JP-A-2005-328494.

In the SMPTE, the video signal standard of 4096×2160/23.98P-60P is standardized, but an interface included in a signal transmitting device and a signal receiving device is not studied nor standardized. Accordingly, regarding video signals of 4096×2160/23.98P-30P, since the number of pixel samples stored in a video data area increases, the pixel samples cannot be multiplexed and transmitted with the line structure of the mode D.

With a video signal of 4096×2160, the frame rate thereof is defined in the range of 23.98P, 24P, 25P, 29.97P, 30P, 47.95P, 48P, 50P, 59.94P, and 60P. However, it should be considered in the future to transmit a video signal with a frame rate of equal to or higher than 90P which is a signal three times faster than the currently-used frame rate (for example, 30P). Accordingly, it is necessary to formulate a specification for transmitting video signals with various frame rates through the use of the current transmission interface.

It is therefore desirable to serially transmit a video signal, whose number of pixels in a frame is greater than the number of pixels defined in the HD-SDI format and which has a high frame rate, through the use of an HD-SDI interface or a 10 Gbps serial interface. It is also desirable to provide a data multiplexing system for transmission of a 120P, particularly, a 4:2:0 signal to reduce a transmission band.

According to an embodiment of the present disclosure, two pixel samples adjacent to each other in the same line are thinned out from a class image defined by an m×n (where m and n representing samples and n lines are positive integers)/a−b (where a and b represent a frame rate of a progressive signal)/4:2:0/r bit signal whose number of pixels in a frame is greater than the number of pixels defined in the HD-SDI format. The thinned-out pixel samples are mapped onto video data areas of first to N-th (where N is an integer equal to or greater than 2) sub-images defined by an m′×n′ (where m′ and n′ representing m′ samples and n′ lines are positive integers)/a′−b′ (where a′ and b′ represent a frame rate of a progressive signal)/4:2:2 and 4:0:0/r bit signal.

The pixel samples are thinned out at intervals of one line of the first to N-th sub-images onto which the pixel samples are mapped and are converted into interlaced signals. At this time, the first to N/2 th sub-images are converted into 4:2:2/r bit signals and the (N/2+1)-th to N-th sub-images are converted into 4:0:0/r bit signals.

Dual link HD-SDI signals obtained by converting a data structure of the 4:2:2/r bit signal and a data structure of the 4:0:0/r bit signal into a data structure of a 4:4:4/r bit signal are output.

According to another embodiment of the present disclosure, dual link HD-SDI signals with a data structure of a 4:4:4/r bit signal are converted into 4:2:2/r bit signals and 4:0:0/r bit signals.

The 4:2:2/r bit signals are multiplexed by the pixel samples for each line of first to N/2-th (where N is an integer equal to or greater than 2) sub-images which are defined by m′×n′ (where m′ and n′ representing m′ samples and n′ lines are positive integers)/a′−b′ (where a′ and b′ represent a frame rate of a progressive signal)/4:2:2/r bit signals. The 4:0:0/r bit signals are multiplexed by the pixel samples for each line of the (N/2+1)-th to N-th sub-images.

Two pixel samples extracted from the first to N-th sub-images are multiplexed to be adjacent to each other in the same line in a frame of the class image defined by m×n (where m and n representing m samples and n lines are positive integers)/a−b (where a and b represent a frame rate of a progressive signal)/4:2:0/r bit signals whose number of pixels in a frame is greater than the number of pixels defined in the HD-SDI format.

According to still another embodiment of the present disclosure, a provided a signal transmission system transmitting the video signals and receiving the video signals is provided.

According to yet another embodiment of the present disclosure, regarding an input video signal, two pixel samples included in the class image in units of two continuous frames (equal to or more than two frames) are thinned out, the line thinning and the word thinning are performed thereon, and signals obtained by multiplexing the pixel samples from the video data areas of the HD-SDI are transmitted. On the other hand, regarding a received video signal, pixel samples are extracted from the video data areas of the HD-SDI, the word multiplexing, the line multiplexing, and the two-pixel multiplexing are performed thereon, and the video signal is reproduced.

According to the embodiments of the present disclosure, it is possible to enable the transmission via the current 10 G serial interface by converting the data structures of 4:2:0/10 bit or 12 bit signal into the data structures of 4:4:4/10 bit or 12 bit signal. Accordingly, since the transmission standard used in the past can be used without formulating a new transmission standard, it is possible to improve convenience.

### BRIEF DESCRIPTION OF THE DRAWINGS

FIG. 1 is a diagram illustrating the overall constitution of a camera transmission system for a television broadcast station according to a first embodiment of the present disclosure;

FIG. 2 is a block diagram illustrating the internal constitution of a signal transmitting device in the circuit constitution of a broadcast camera according to the first embodiment of the present disclosure;

FIG. 3 is a block diagram illustrating the internal constitution of a first mapping unit mapping a 10 bit signal according to the first embodiment of the present disclosure;

FIG. 4 is a block diagram illustrating the internal constitution of a second mapping unit according to the first embodiment of the present disclosure;

FIGS. 5A to 5D are diagrams illustrating an example of a sample structure of a UHDTV standard of 3840×2160;

FIG. 6 is a diagram illustrating a process example where a two-pixel thinning control unit according to the first embodiment of the present disclosure thins out two pixel samples from first and second class images and maps the thinned pixel samples to first to fourth sub-images;

FIG. 7 is a diagram illustrating an example of a data structure corresponding to one line of 10.692 Gbps serial digital data in the case of 24P;

FIG. 8 is a diagram illustrating an example of a mode-D;

FIG. 9 is a diagram illustrating an example where the first to fourth sub-images are divided into Link A and Link B in accordance with the definition of the SMPTE 372M by thinning out the lines according to the first embodiment of the present disclosure;

FIG. 10 is a diagram illustrating an example of a line thinning operation according to the first embodiment of the present disclosure;

FIG. 11 is a diagram illustrating an example where a 4:2:2/10 bit signal and a 4:0:0/10 bit signal of 8 channels are converted into four sets of HD-SDI Link A and Link B according to the first embodiment of the present disclosure;

FIG. 12 is a diagram illustrating an example of a data structure when a 4:2:2/10 bit signal and a 4:0:0/10 bit signal of 8 channels are converted into four sets of HD-SDI Link A and Link B according to the first embodiment of the present disclosure;

FIG. 13 is a block diagram illustrating the internal constitution of a first mapping unit mapping a 4:2:0/12 bit signal according to the first embodiment of the present disclosure;

FIG. 14 is a diagram illustrating an example where the first to fourth sub-images are divided into Link A and Link B in accordance with the definition of the SMPTE 372M by thinning out the lines and thereafter thinning out the words according to the first embodiment of the present disclosure;

FIG. 15 is a diagram illustrating an example where a 4:2:2/12 bit signal and a 4:0:0/12 bit signal of 16 channels are converted into four sets of HD-SDI Link A and Link B according to the first embodiment of the present disclosure;

FIG. 16 is a diagram illustrating an example of a data structure when a 4:2:2/12 bit signal and a 4:0:0/12 bit signal of 16 channels are converted into four sets of HD-SDI Link A and Link B according to the first embodiment of the present disclosure;

FIGS. 17A and 17B are diagrams illustrating an example of a data multiplexing process performed by a multiplexing unit according to the first embodiment of the present disclosure;

FIG. 18 is a block diagram illustrating the internal constitution of a signal receiving device in the circuit constitution of a CCU according to the first embodiment of the present disclosure;

FIG. 19 is a block diagram illustrating the internal constitution of a second reproduction unit according to the first embodiment of the present disclosure;

FIG. 20 is a block diagram illustrating the internal constitution of a first reproduction unit reproducing a 10 bit signal according to the first embodiment of the present disclosure;

FIG. 21 is a block diagram illustrating the internal constitution of the first reproduction unit reproducing a 12 bit signal according to the first embodiment of the present disclosure;

FIG. 22 is a block diagram illustrating the internal constitution of a first mapping unit according to a second embodiment of the present disclosure;

FIG. 23 is a diagram illustrating a processed image to which pixel samples are mapped by a mapping unit according to the second embodiment of the present disclosure;

FIG. 24 is a diagram illustrating a process example where a two-pixel thinning control unit according to the second embodiment of the present disclosure thins out two pixel samples from the first and second class images and maps the thinned pixel samples to first to eighth sub-images;

FIG. 25 is a diagram illustrating an example where the first to eighth sub-images are divided into Link A and Link B in accordance with the definition of the SMOTE 372M by performing a line thinning process on the sub-images and then performing a word thinning process thereon according to the second embodiment of the present disclosure;

FIG. 26 is a block diagram illustrating the internal constitution of a first reproduction unit according to the second embodiment of the present disclosure;

FIG. 27 is a diagram illustrating a process example where a two-pixel thinning control unit according to a third embodiment of the present disclosure thins out two pixel samples from first and second UHDTV2 class images and maps the thinned pixel samples to first to fourth UHDTV1 class images;

FIG. 28 is a block diagram illustrating the internal constitution of a first mapping unit according to the third embodiment of the present disclosure;

FIG. 29 is a block diagram illustrating the internal constitution of first reproduction unit according to the third embodiment of the present disclosure;

FIG. 30 is a diagram illustrating a process example where a two-pixel thinning control unit according to a fourth embodiment of the present disclosure thins out two pixel samples from first and second UHDTV2 class images and maps the thinned pixel samples to the first to fourth UHDTV1 class images;

### DETAILED DESCRIPTION

Hereinafter, preferred embodiments (hereinafter, referred to as embodiments) for implementing the present disclosure will be described. The description is made in the following order.

1. First Embodiment (Mapping Control of Pixel Sample: Process Example of Reducing Number of HD-SDI or 10 G-SDI channels to be Transmitted to Half as Result of Investigation of 3840×2160/50P, 59.94P, 60P/4:2:0/10 bit or 12 bit Multiplexing System)

2. Second Embodiment (Process Example of Reducing Number of HD-SDI or 10 G-SDI channels to be Transmitted to Half as Result of Investigation of 3840×2160/100P, 119.88P, 120P/4:2:0/10 bit or 12 bit Multiplexing System)

3. Third Embodiment (Process Example of Reducing Number of HD-SDI or 10 G-SDI channels to be Transmitted to Half as Result of Investigation of UHDTV2 7680×4320/50P, 59.94P, 60P/4:2:0/10 bit or 12 bit Multiplexing System)

4. Fourth Embodiment (Process Example of Reducing Number of HD-SDI or 10 G-SDI channels to be Transmitted to Half as Result of Investigation of UHDTV2 7680×4320/100P, 119.88P, 120P/4:2:0/10 bit or 12 bit Multiplexing System)

5. Modifications

### 1. First Embodiment

### Mapping Control of Pixel Sample: Process Example of Reducing Number of HD-SDI or 10 G-SDI Channels to be Transmitted to Half as Result of Investigation of 3840×2160/50P, 59.94P, 60P/4:2:0/10 Bit or 12 Bit Multiplexing System

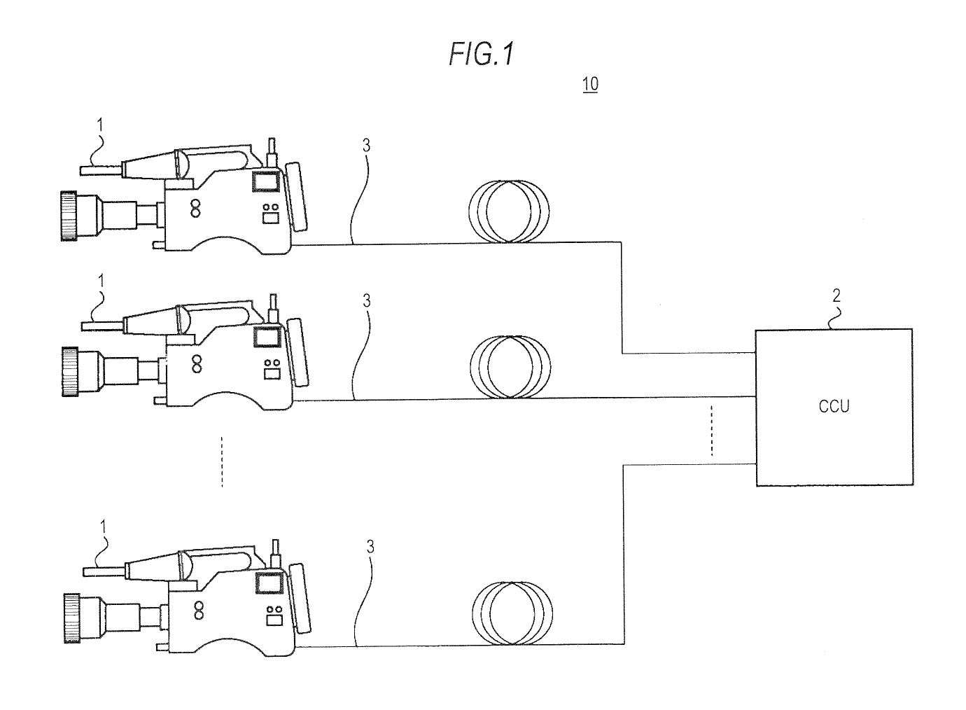

A first embodiment of the present disclosure will be described below with reference to FIGS. 1 to 21.

In a transmission system according to the first embodiment, a technique of thinning out pixel samples of 3840×2160/50P-60P/4:2:0/10 bit or 12 bit signal will be described.

FIG. 1 is a diagram illustrating the overall constitution of a signal transmission system 10 for a television broadcast station according to this embodiment. The signal transmission system 10 includes plural broadcasting cameras 1 having the same constitution and a CCU (Camera Control Unit) 2. The broadcasting cameras 1 are connected to CCU 2 via optical fiber cables. The broadcasting cameras 1 are used as a signal transmitting device employing a signal transmitting method of transmitting a serial digital signal (video signal) and the CCU 2 is used as a signal receiving device employing a signal receiving method of receiving the serial digital signal. The transmission system 10 in which the broadcasting cameras 1 and the CCU 2 are combined is used as a signal transmission system transmitting and receiving a serial digital signal. The processes performed by these devices may be implemented by hardware combinations or by executing a program.

Each broadcasting camera 1 generates 4 k×2 k ultra-high-resolution signals of UHDTV1 (3840×2160/50P-60P/4:2:0/10 bit or 12 bit signal) and transmits the generated signals to the CCU 2.

The CCU 2 controls the broadcasting cameras 1, receives video signals from the broadcasting cameras 1, or transmits video signals (return video) for displaying a video captured by another broadcasting camera 1 on the monitor of the respective broadcasting cameras 1. The CCU 2 serves as a signal receiving device receiving video signals of the broadcasting cameras 1.

### [Next-generation 2 k, 4 k, 8 k Video Signals]

Next-generation 2 k, 4 k, and 8 k video signals will be described below.

As an interface transmitting and receiving video signals with various frame rates, a transmission standard known as the mode-D (see FIG. 7 to be described later) is added to the SMPTE 435-2, whereby the SMPTE 435-2-2009 standard was completed. In the SMPTE 435-2, it is stated that data is multiplexed to the HD-SDI signals of plural channels which are 10 bit parallel streams defined in the SMPTE 292 by the use of a 10.692 Gbps serial interface. In general, the HD-SDI field is constructed in the sequence of an EAV, a horizontal auxiliary data space (also referred to as HANC data or horizontal blanking period), an SAV, and video data. In the UHDTV standard, a technique of transmitting 3840×2160/50P-60P signals via a 10 Gbps interface of 2 channels and transmitting 7680×4320/50P-60P signals via a 10 Gbps interface of 8 channels has been proposed in the SMPTE. This proposal was formulated as the SMPTE 2036-3 standard.

The video standard proposed in the ITU or the SMPTE relates to 3840×2160 or 7680×4320 video signals having the number of samples and the number of lines which are double or quadruple those of 1920×1080. Among these, the video standard standardized by the ITU is referred to as an LSDI (Large Screen Digital Imagery) and the video standard proposed in the SMPTE is referred to as a UHDTV. In the UHDTV, video signals in Table 1 are defined.

TABLE 1

| | | Luminance | | |
|---|---|---|---|---|
| | | or number of | Number of | |
| | | R′G′B′ | effective | |
| System | | samples per | lines | Frame rate |
| category | System title | effective line | per frame | (Hz) |
| UHDTV1 | 3840 × 2160/23.98/P | 3840 | 2160 | 24/1.001 |
| | 3840 × 2160/24/P | 3840 | 2160 | 24 |
| | 3840 × 2160/25/P | 3840 | 2160 | 25 |
| | 3840 × 2160/29.97/P | 3840 | 2160 | 30/1.001 |
| | 3840 × 2160/30/P | 3840 | 2160 | 30 |
| | 3840 × 2160/50/P | 3840 | 2160 | 50 |
| | 3840 × 2160/59.94/P | 3840 | 2160 | 60/1.001 |
| | 3840 × 2160/60/P | 3840 | 2160 | 60 |
| UHDTV2 | 7680 × 4320/23.98/P | 7680 | 4320 | 24/1.001 |
| | 7680 × 4320/24/P | 7680 | 4320 | 24 |
| | 7680 × 4320/25/P | 7680 | 4320 | 25 |
| | 7680 × 4320/29.97/P | 7680 | 4320 | 30/1.001 |
| | 7680 × 4320/30/P | 7680 | 4320 | 30 |
| | 7680 × 4320/50/P | 7680 | 4320 | 50 |
| | 7680 × 4320/59.94/P | 7680 | 4320 | 60/1.001 |
| | 7680 × 4320/60/P | 7680 | 4320 | 60 |

As standards employed by digital cameras in the movie business, the signal standard of 2048×1080 or 4096×2160 is standardized as SMPTE 2048-1 and SMPTE 2048-2 in Tables 2 and 3.

TABLE 2

| System | | |
|---|---|---|
| number | System title | Frame rate (Hz) |
| 1 | 2048 × 1080/60/P | 60 |
| 2 | 2048 × 1080/59.94/P | 60/1.001 |
| 3 | 2048 × 1080/50/P | 50 |
| 4 | 2048 × 1080/48/P | 48 |
| 5 | 2048 × 1080/47.95/P | 48/1.001 |
| 6 | 2048 × 1080/30/P | 30 |
| 7 | 2048 × 1080/29.97/P | 30/1.001 |
| 8 | 2048 × 1080/25/P | 25 |
| 9 | 2048 × 1080/24/P | 24 |
| 10 | 2048 × 1080/23.98/P | 24/1.001 |

TABLE 3

| System | | |
|---|---|---|
| number | System title | Frame rate (Hz) |
| 1 | 4096 × 2160/60/P | 60 |
| 2 | 4096 × 2160/59.94/P | 60/1.001 |
| 3 | 4096 × 2160/50/P | 50 |
| 4 | 4096 × 2160/48/P | 48 |
| 5 | 4096 × 2160/47.95/P | 48/1.001 |
| 6 | 4096 × 2160/30/P | 30 |
| 7 | 4096 × 2160/29.97/P | 30/1.001 |
| 8 | 4096 × 2160/25/P | 25 |
| 9 | 4096 × 2160/24/P | 24 |
| 10 | 4096 × 2160/23.98/P | 24/1.001 |

### [DWDM/CWDM Wavelength Multiplexing Technique]

A DWDM/CWDM wavelength multiplexing technique will be described below.

A method of multiplexing and transmitting light of plural wavelengths to a single optical fiber is referred to as WDM (Wavelength Division Multiplexing). The WDM can be approximately classified into the following three methods depending on the wavelength intervals.

### (1) Two-Wavelength Multiplexing Method

The two-wavelength multiplexing method is a method of multiplexing signals of different wavelengths such as 1.3 and 1.55 μm into about two or three waves and transmitting the multiplexed signals via a single optical fiber.

### (2) DWDM (Dense Wavelength Division Multiplexing) Method

The DWDM method is a method of multiplexing light of frequencies of 25 GHz, 50 GHz, 100 GHz, 200 GHz, . . . at a band of 1.55 μm with a high density. These intervals correspond to wavelength intervals of about 0.2 nm, 0.4 nm, 0.8 nm, . . . . The central wavelength and other wavelengths were standardized by the ITU-T (International Telecommunication Union Telecommunication standardization sector). Since the wavelength intervals in the DWDM method are 100 GHz which is narrow, it is possible to take a large number of multiplexings such as several tens to hundreds and thus to enable communications of ultra-high capacity. However, since the oscillation wavelength width needs to be sufficiently smaller than a wavelength interval 100 GHz and the temperature of a semiconductor laser needs to be controlled so as for the central wavelength to match with the ITU-T standard, the device is expensive and the power consumption of the system increases.

### (3) CWDM (Coarse Wavelength Division Multiplexing) Method

The CWDM method is a wavelength multiplexing technique employing wavelength intervals of 10 nm to 20 nm larger by 1 digit or more than that of the DWDM method. Since the wavelength intervals are relative large, the oscillation wavelength width of a semiconductor laser does not have to be a narrow bandwidth like the DWDM method and the temperature of the semiconductor laser does not have to be controlled, whereby it is possible to reduce the cost of the system and to reduce the power consumption of the system. Accordingly, this method is effectively advantageous for a system not having such a large capacity as in the DWDM method. Examples of the central wavelength generally include the following for the current 4 channels. That is, examples thereof include 1.511 μm, 1.531 μm, 1.551 μm, and 1.571 μm with the current 4 channels constitution and 1.471 μm, 1.491 μm, 1.511 μm, 1.531 μm, 1.551 μm, 1.571 μm, 1.591 μm, and 1.611 μm with the 8 channels constitution.

In this embodiment, the frame rate of 3840×2160/50P-60P/4:2:0/10 bit or 12 hit signal is double that of the signals defined in the SMPTE S2036-1. As described above, the signals defined in the SMPTE S2036-1 are 3840×2160/50P-60P/4:2:0/10 bit or 12 bit signal. It is assumed that the digital signal format such as a forbidden code is the same as the signals defined in the S2036-1 already.

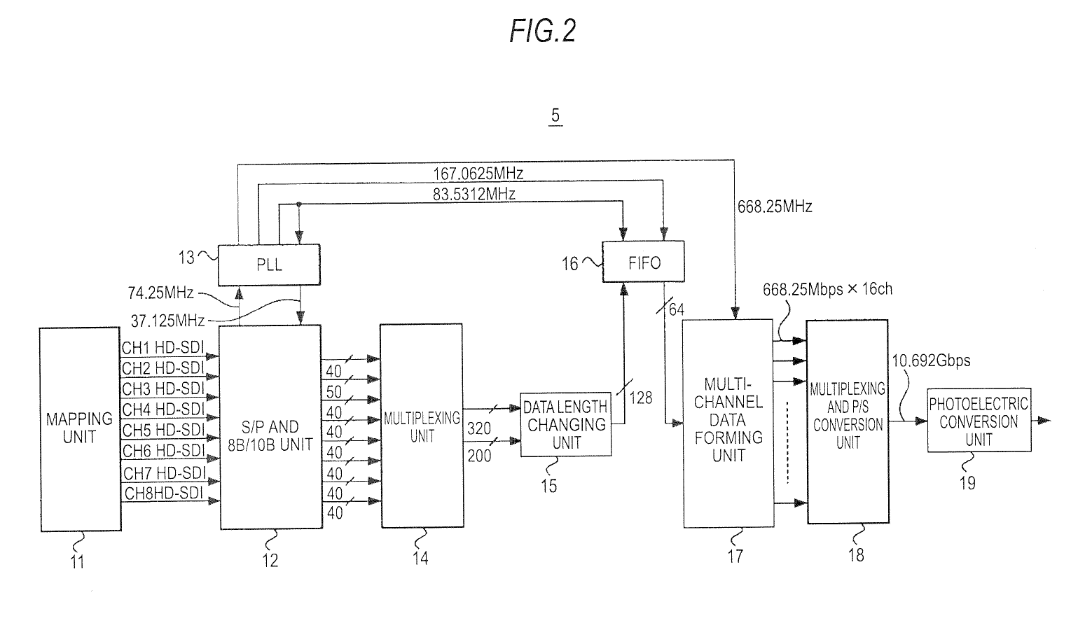

FIG. 2 is a block diagram illustrating the signal transmitting device according to this embodiment in the circuit constitution of a broadcasting camera 1. The 3840×2160/50P-60P/4:2:0/10 bit or 12 bit signal generated by an imaging unit and a video signal processing unit (not shown) in the broadcasting camera 1 are sent to a mapping unit 11.

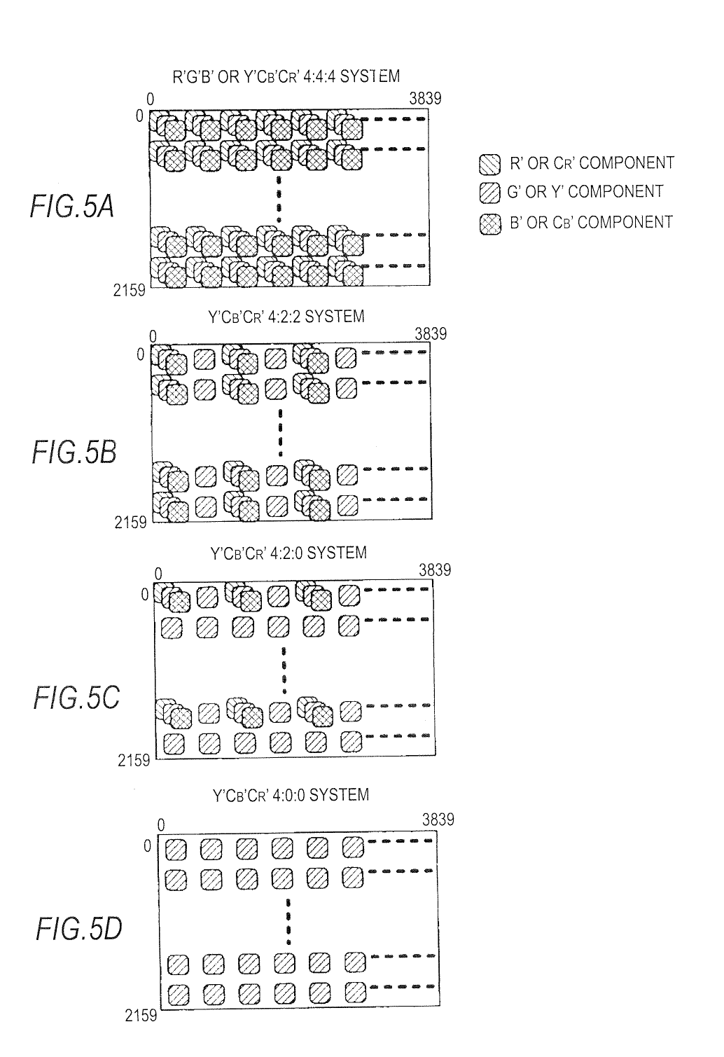

The 3840×2160/50P-60P/4:2:0/10 bit or 12 bit signal correspond to a frame of a UHDTV1 class image. These signals are signals in which Y′ data series, C′_{B} data series, and C′_{R} data series with a word length of 12 bits are synchronously arranged in parallel and C′_{B} and C′_{R} signals are thinned out by a quarter of the Y′ signals as shown in FIGS. 5A to 5D. The frame periods of these signals are 1/50, 1/59.94, and 1/60 seconds and 2160 effective line periods are included in one frame period. Accordingly, the number of pixels in a frame of the video signal is greater than the number of pixels defined in the HD-SDI format.

In a UHDTV1 class image defined in the S2036-1, the number of samples in an active line is 3840 and the number of lines is 2160. G, B, and R video data are arranged in the active lines of G data series, B data series, and R data series, respectively.

The mapping unit 11 maps the 3840×2160/50P-60P/4:2:0/10 bit or 12 bit signal onto video data areas of an 8-channel transmission stream defined in the HD-SDI format.

The process of mapping pixel samples of the 3840×2160/50P-60P/4:2:0/10 bit signals and the process of mapping pixel samples of the 3840×2160/50P-60P/4:2:0/12 bit signals will be separately described below. Here, the details common to both may be skipped, and for example, “4:2:0/10 bit signal” and “4:2:0/12 bit signal” may be described.

### [1-1. Internal Constitution and Operational Example of Mapping Unit (Example of 3840×2160/50P-60P/4:2:0/10 Bit)]

The internal constitution and the operational example of the mapping unit 11 will be described below.

First, an example of 3840×2160/50P-60P/4:2:0/10 bit will be described.

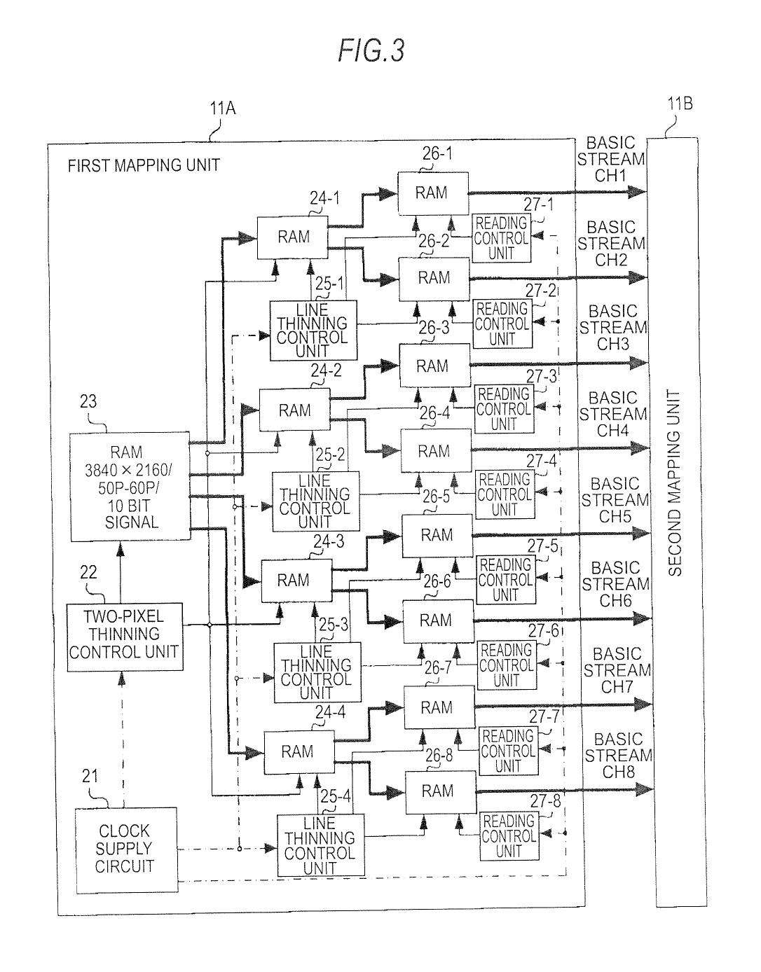

FIG. 3 shows a constitutional example of a first mapping unit 11A which performs the front-stage processes of the mapping unit 11 mapping a 10 bit signal.

The mapping unit 11 (see FIG. 2) in this example includes a first mapping unit 11A and a second mapping unit 11B.

The first mapping unit 11A includes a clock supply circuit 21 supplying clocks to the constituent units and a RAM 23 storing 3840×2160/50P-60P/4:2:0/10 bit video signals. The first mapping unit 11A further includes a two-pixel thinning control unit 22 controlling a two-pixel thinning (interleaving) process of reading two pixel samples from the RAM 23 and RAMs 24-1 to 24-4 storing the thinned two pixel samples.

The first mapping unit 11A includes line thinning control units 25-1 to 25-4 line-thinning out data read from the RAM 24-1 to 24-4 and RAMS 26-1 to 26-8 temporarily storing the data thinned out by the line thinning control unit 25-1 to 25-4.

The first mapping unit 11A further includes reading control units 27-1 to 27-8 outputting the pixel samples of the data read from the RAMs 26-1 to 26-8 as a basic stream of 8 channels (the 4:2:2/10 bit signal and the 4:0:0/10 bit signal). The clock supply circuit 21 supplies clocks to the two-pixel thinning control unit 22, the thinning control units 25-1 to 25-4, and the reading control unit 27-1 to 27-8. These clocks are used to read and record the pixel samples and the constituent units are synchronized with these clocks.

Operational examples of the processing blocks of the first mapping unit 11A will be described below.

First, an image signal of a UHDTV1 class image defined by an m×n (where m and n representing m samples and n lines are positive integers)/a−b (where a and b represent a frame rate of a progressive signal)/4:2:0/r bit signal whose number of pixels in a frame is greater than the number of pixels defined in the HD-SDI format and which is input from an image sensor not shown is stored in the RAM 23. The UHDTV1 image signal is 3840×2160/50P-60P/4:2:0/10 bit or 12 bit signal. This image signal is a class image defined in the UHDTV1.

The two-pixel thinning control unit 22 thins out two pixel samples adjacent to each other in the same line, which is a method defined in the SMPTE 435-1, out of the pixel samples extracted from each frame defined by the image signal, and then maps the thinned pixel samples on the video data areas of first to N-th (where N is an integer equal to or greater than 2) sub-images defined by m′×n′ (where m′ and n′ representing m′ samples and n′ lines are positive integers)/a′−b′ (where a′ and b′ represent a frame rate of a progressive signal)/4:2:2 or 4:0:0/r bit signals. These sub-images are 1920×1080/50P-60P/4:2:2 or 4:0:0/10 bit or 12 bit signal, where N=4 is set. Accordingly, the two-pixel thinning control unit 22 thins out two pixel samples adjacent to each other in the same line in a frame, maps the pixel samples in the even-number lines of the frame out of the first to fourth sub-images defined in the SMPTE 435-1 on the first sub-image and the second sub-image by two pixel samples, and then maps the pixel samples in the odd-number lines of the frame on the third sub-image and the fourth sub-image.

Specifically, the two-pixel thinning control unit 22 performs a control of extracting the pixel samples of the 3840×2160/50P-60P/4:2:0/10 bit signal in the line direction by two pixels every vertically-adjacent two lines and storing the extracted pixel samples in the RAMs 24-1 to 24-4. At this time, the two-pixel thinning control unit 22 forms the first to fourth sub-images corresponding to the 1920×1080/50P-60P defined in the SMPTE 435-1 in the RAMs 24-1 to 24-4.

The line thinning control unit 25-1 to 25-4 converts the first to fourth sub-images, which are progressive signals which are stored in the RAMs 24-1 to 24-4 and on which the pixel samples are mapped, into interlaced signals. At this time, the line thinning control units converts the first to N/2-th sub-images (the first and second sub-images in this example) into 4:2:2/r bit signals and converts the (N/2+1)-th to N-th sub-images (the third and fourth sub-images in this example) into 4:0:0/r bit signals. Specifically, the line thinning control units 25-1 to 25-4 read the first to fourth sub-images which are mapped by the two-pixel thinning control unit 22 and which are stored in the RAMS 24-1 to 24-4, respectively. At this time, the line thinning control units 25-1 to 25-4 convert one sub-image into 1920×1080/50I, 59.94I, and 60I/4:2:2/10 bit signals of 2 channels. Hereinafter, 50I, 59.94I, and 60I are as abbreviated to “50I to 60I”. The line thinning control units store the 4:2:2/10 bit signals and 4:0:0/10 bit signals of 8 channels, which are 1920×1080/50I-60I signals thinned out from the read first to fourth sub mages for each line and converted into the interlaced signals, in the RAMs 26-1 to 26-8.

Thereafter, the reading control units 27-1 to 27-8 output the 4:2:2/10 bit signals and 4:0:0/10 bit signals of 8 channels read from the RAMs 26-1 to 26-8.

Specifically, the reading control units 27-1 to 27-8 reads the 1920×1080/50I to 60I signals from the RAMs 26-1 to 26-8 in synchronization with a reference clock supplied from the clock supply circuit 21, and outputs the 4:2:2/10 bit signals and 4:0:0/10 bit signals of 8 channels, which are constructed in four pairs of two Links A and B, to the subsequent second mapping unit 11B.

In this example, two types of memories (RAMs 24-1 to 24-4 and RAMs 26-1 to 26-8) are used to perform the two-pixel thinning and the line thinning. However, data subjected to the two-pixel thinning may be subjected to the line thinning and then may be output as the 4:2:2/10 bit signals and 4:0:0/10 bit signals of 8 channels, by the use of a single type of memory.

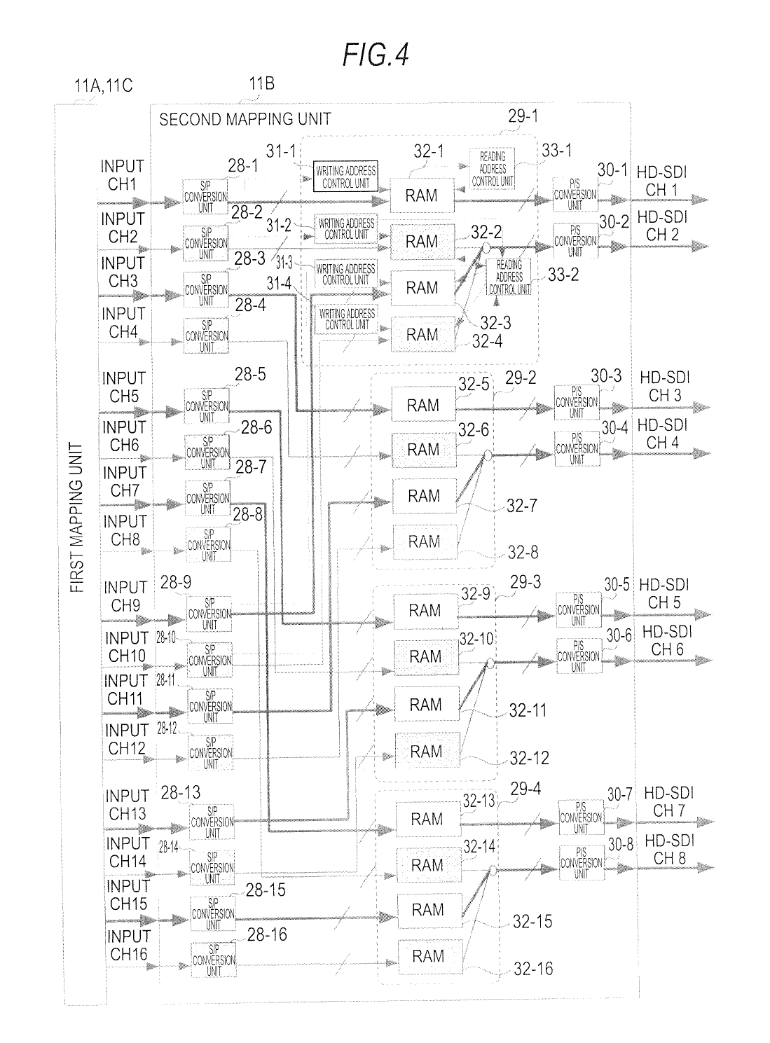

FIG. 4 shows a constitutional example of the second mapping unit 11B performing the subsequent-stage of the mapping unit 11.

The second mapping unit 11B includes S/P conversion units 28-1 to 28-16, composite units 29-1 to 29-4, P/S conversion units 30-1 to 30-8 as subsequent-stage processing blocks of the mapping unit 11. The composite unit 29-1 includes writing address control units 31-1 to 31-4, RAMs 32-1 to 32-4, and reading address control units 33-1 and 33-2. Each of the composite units 29-2 to 29-4 includes four RAMs.

The second mapping unit 11B has a function of outputting a dual link HD-SDI signal converted into the data structure of the 4:2:2/r bit signals output from the first mapping unit 11A. The second mapping unit 11B also has a function of outputting a dual link HD-SDI obtained by converting the data structure of the 4:0:0/r bit signals output from the first mapping unit 11A into the data structure of the 4:4:4/r bit signals.

The 4:2:2/10 bit signals and 4:0:0/10 bit signals of 8 channels read by the reading control unit 27-1 to 27-8 shown in FIG. 3 are input to input channels CH1, CH3, CH5, CH7, CH9, CH11, CH13, and CH15 of the second mapping unit 11B. The input 4:2:2/10 bit signals and 4:0:0/10 bit signals of 8 channels are converted into parallel data by the S/P conversion units 28-1, 28-3, . . . , and 28-15 corresponding to the input channels. The S/P conversion units 28-2, 28-4, . . . , and 28-16 are used to process video signals of 3840×2160/50P-60P/4:2:0/12 bit along with the S/P conversion units 28-1, 28-3, . . . , and 28-15.

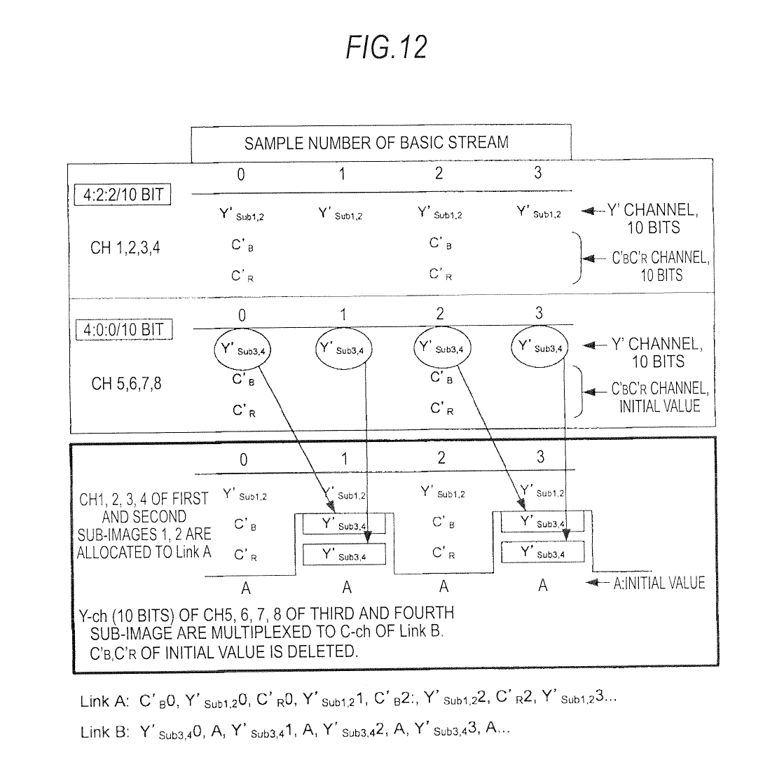

The parallel data output from the S/P conversion units 28-1, 28-3, . . . , and 28-15 are input to the composite units 29-1 to 29-4. Here, since the processing blocks of the composite units 29-1 to 29-4 are complex, only the composite unit 29-1 will be described and the description of the other composite units 29-2 to 29-4 will not be repeated. The detailed processing examples of the composite units 29-1 to 29-4 will be described later (see FIG. 12).

The writing address control units 31-1 and 31-3 included in the composite unit 29-1 write the parallel data output from the S/P conversion units 28-1 and 28-9 to the RAMs 32-1 and 32-3. The parallel data input to the input channel CH3 and output from the S/P conversion unit 28-3 is written to the RAM 32-5.

The reading address control units 33-1 and 33-3 included in the composite unit 29-1 read the parallel data from the RAMs 32-1 and 32-3 and outputs the read parallel data to the P/S conversion units 30-1 and 30-2. The P/S conversion units 30-1 and 30-2 output the parallel data read from the RAMs 32-1 and 32-3 as HD-SDI signals of 2 channels which are serial data.

In the composite unit 29-2, the parallel data input to the input channels CH3 and CH11 and SP-converted by the S/P conversion units 28-3 and 28-11 are written to the RAMs 32-5 and 32-7. Thereafter, the parallel data read from the RAMs 32-5 and 32-7 are converted into serial data by the P/S conversion units 30-3 and 30-4 and are then output as HD-SDI signals (CH3 and CH4) of 2 channels.

In the composite unit 29-3, the parallel data input to the input channels CH5 and CH13 and SP-converted by the S/P conversion units 28-5 and 28-13 are written to the RAMs 32-9 and 32-11. Thereafter, the parallel data read from the RAMs 32-9 and 32-11 are converted into serial data by the P/S conversion units 30-5 and 30-6 and are then output as HD-SDI signals (CH5 and CH6) of 2 channels.

In the composite unit 29-4, the parallel data input to the input channels CH7 and CH15 and SP-converted by the S/P conversion units 28-7 and 28-15 are written to the RAMs 32-13 and 32-15. Thereafter, the parallel data read from the RAMs 32-13 and 32-15 are converted into serial data by the P/S conversion units 30-7 and 30-8 and are then output as HD-SDI signals (CH7 and CH8) of 2 channels.

### [Example of Sample Structure of UHDTV Signal Standard]

Here, an example of the sample structure of the UHDTV signal standard will be described with reference to FIGS. 5A to 5D.

FIGS. 5A to 5D are diagrams illustrating an example of a sample structure of the UHDTV signal standard of 3840×2160. As to the frame used for the description of FIGS. 5A to 5D, a frame includes 3840×2160 pixels.

The sample structure of the signal standard of 3840×2160 is classified into the following four systems. In the SMPTE standard, a signal with a dash “′” added thereto such as R′G′B′ represents a signal having been subjected to gamma correction or the like.

FIG. 5A shows an example of a R′G′B′ or Y′Cb′Cr′ 4:4:4 system. In this system, all the samples include a RGB or YCbCr component.

FIG. 5B shows an example of a Y′Cb′Cr′ 4:2:2 system. In this system, the even-number pixel samples include a YCbCr component and the odd-number pixel samples include a Y component.

FIG. 5C shows an example of a Y′Cb′Cr′ 4:2:0 system. In this system, the even-number pixel samples include a YCbCr component, and the odd-number pixel samples include a Y component and a component obtained by thinning out the CbCr components from the odd-number lines.

FIG. 5D shows an example of a Y′Cb′Cr′ 4:0:0 system. In this system, the overall samples include only a Y component, and the CbCr components are thinned out therefrom.

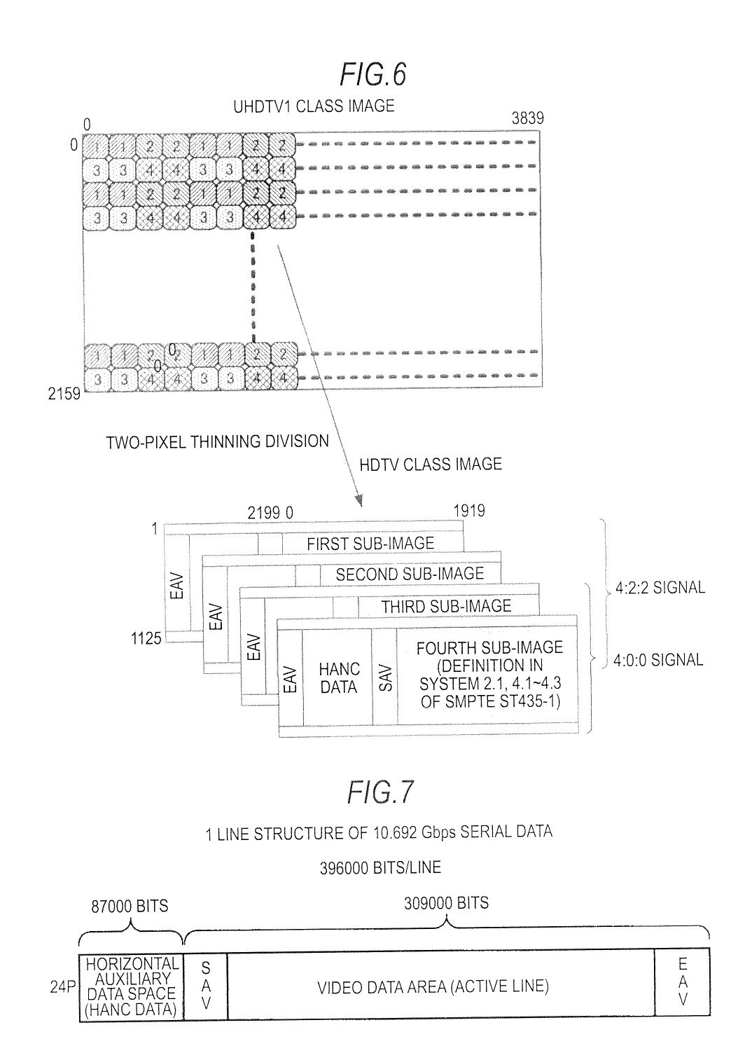

FIG. 6 is a diagram illustrating an example where the first mapping unit 11A maps the pixel samples included in a UHDTV1 class image on the first to fourth sub-images.

First, the two-pixel thinning control unit 22 (see FIG. 3) included in the first mapping unit 11A divides one frame (one screen) of the 3840×2160/50P-60P/4:2:0/10 hit signal into four parts. At this time, the 3840×2160/50P-60P/4:2:0/10 bit signals are mapped on the 1920×1080/50P-60P/4:2:0/10 bit signals of 4 channels.

Specifically, the two-pixel thinning control unit 22 thins out the pixel samples every two pixels in the line direction from the UHDTV1 class image in which one frame (one screen) includes a 3840×2160/50P-60P/4:2:0/10 bit signal, and then creates the first to fourth sub-images from the signals thinned out every two pixels. At this time, the thinned signals are mapped on the 1920 samples in the video data areas of the HD image format which are 1920×1080/50P-60P/4:2:2 or 4:0:0/10 bit signals of 4 channels to create the first to fourth sub-images. In the following description, the UHDTV1 class image is referred to as a “class image”.

When the 3840×2160/50P-60P/4:2:0/10 bit signals are thinned out by two pixel samples, the first and second sub-image obtained by thinning out two pixel samples from the even-number lines has a data structure of 4:2:2. On the other hand, the third and fourth sub-images obtained by thinning out two pixel samples from the odd-number lines has a data structure of 4:0:0, because there is no C′_{B}/C′_{R} sample. The 3840×2160/50P-60P/4:2:0/10 bit signals are mapped on effective video areas of the first to fourth sub-images in System 2.1 defined in the SMPTE ST435-1. On the other hand, the 3840×2160/50P-60P/4:2:0/12 bit signals are mapped on the effective video areas of the first to fourth sub-images in System 4.1 defined in the SMPTE ST435-1. At this time, in the SMPTE ST435-1 or the SMPTE ST2036-3, it is defined to allocate 200 h out of signals corresponding to 0 having no pixel sample in the case of 10 bits and to allocate 800 h in the case of 12 bits. The first to fourth sub-images on which the 3840×2160/50P-60P/4:2:0/10 bit signals are mapped are line-thinned out and are multiplexed to the HD-SDI of 8 channels in accordance with FIG. 2 of the SMPTE ST372. This multiplexing method is defined in the SMPTE ST435-1.

### [Constitutional Example of 10.692 Gbps Serial Data]

A constitutional example of 10.692 Gbps serial data defined in the HD-SDI format of I line will be described below with reference to FIG. 7.

FIG. 7 shows an example of a data structure corresponding to I line of 10.692 Gbps serial digital data when the frame rate is 24P.

In the drawing, fields including line number LN and error detection code CRC are indicated by EAV, active line, and SAV, and a field including an additional data area is indicated by horizontal auxiliary data space. An audio signal is mapped on the horizontal auxiliary data space and can be synchronized with an input HD-SDI signal by adding auxiliary data to the audio signal to construct the horizontal auxiliary data space.

### [Mode-D]

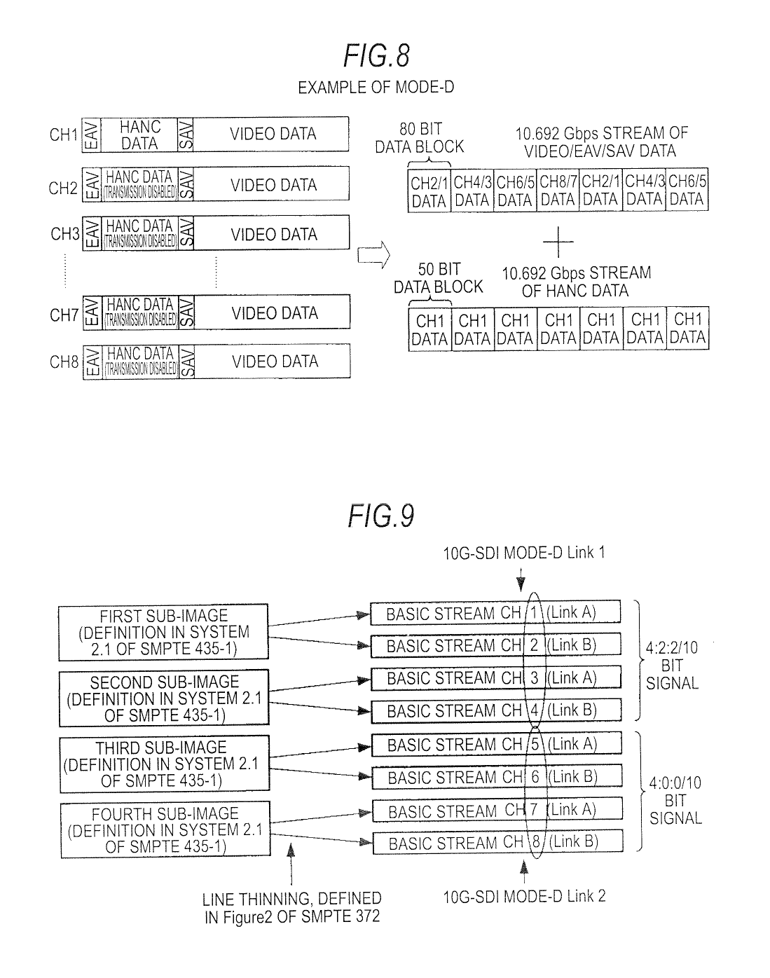

An example where data included in HD-SDI signals of plural channels are multiplexed will be described below with reference to FIG. 8. The method of multiplexing data is defined as mode-D in the SMPTE 435-2.

FIG. 8 is a diagram illustrating mode-D.

The mode-D is a method of multiplexing HD-SDI signals of 8 channels (CH1 to CH8) and defines that data are multiplexed to the video data area of a 10.692 Gbps stream and the horizontal auxiliary data space. Here, 40 bits of HD-SDI video/EAV/SAV data of CH1, Ch3, CH5, and CH7 are extracted and scrambled and converted into 40 bits of data. On the other hand, 32 bits of HD-SDI video/EAV/SAV data of CH2, Ch4, CH6, and CH8 are extracted and converted into 40 bits of data through 8 B/10 B conversion. The data pieces are added and combined and converted into 80 bits of data. Encoded 8 word (80 bit) data are multiplexed to the video data areas of the 10.692 Gbps stream.

The 8 B/10 B-converted 40 bit data block of the even-number channels is allocated to the first-half 40 bit data block out of the 80 bit data block. The scrambled 40 bit data block of the odd-number channels is allocated to the second-half 40 bit data block. Accordingly, data blocks are multiplexed to a single data block, for example, in the order of CH2 and CH1. The reason for alternation of the order is that a content ID for identifying a used mode is included in the 8 B/10 B-converted 40 bit data block of the even-number channels.

On the other hand, the horizontal auxiliary data space of the HD-SDI signal of CH1 is 8 B/10 B-converted and is encoded in a 50 bit data block and is then multiplexed to the horizontal auxiliary data space of the 10.692 Gbps stream. Here, the horizontal auxiliary data spaces of the HD-SDI signals of CH2 to CH8 are not transmitted.

Processes subsequent to the process of converting the first to fourth sub-images into the HD-SDI signals of 8 channels, which is shown in FIG. 6, will be described below with reference to FIGS. 9 to 12.

FIG. 9 shows an example where the pixel samples of the first to fourth sub-images are mapped on the HD-SDI signals of 8 channels.

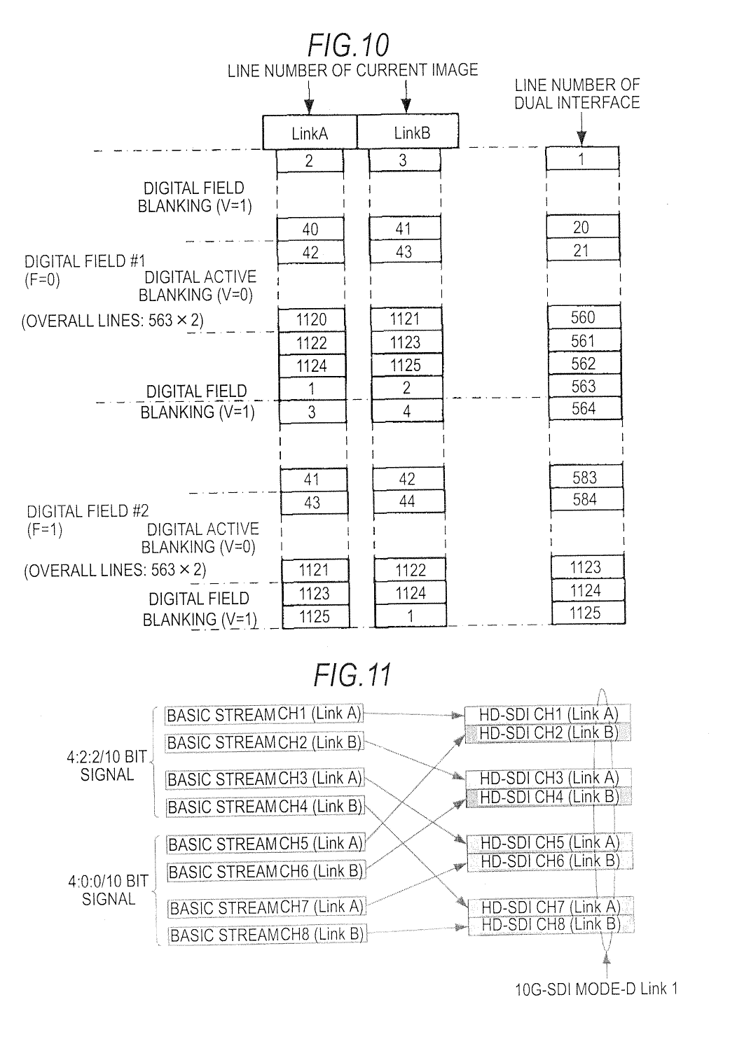

As described above, the line thinning control units 25-1 to 25-4 line-thin out the first to fourth sub-images and convert the line-thinned signals into the 4:2:2/10 bit signals and 4:0:0/10 bit signals of 8 channels in total by two channels of Link A and Link B. Here, Link A and Link B will be described with reference to FIG. 10.

FIG. 10 shows an example of the line thinning based on the SMPTE 372.

Here, the line thinning will be described with reference to an example of the line number and the package of a dual link interface.

The mapping unit 11 converts the 3840×2160/50P-60P/4:2:0/10 bit signals into the first to fourth sub-images and then creates the HD-SDI signals of 8 channels through plural processes. Thereafter, the line thinning control units 25-1 to 25-4 line-thin out the 1920×1080/50P-60P/4:2:0/10 bit signals in the data structures of Link A and Link B. Accordingly, the line-thinned signals are converted into signals corresponding to the 1920×1080/50I-60I/4:2:0/10 bits of 2 channels.

FIGS. 11 and 12 will be described below.

FIG. 11 shows an example of a process where the second mapping unit 11B converts the 4:2:2/10 bit signals and 4:0:0/10 bit signals of 8 channels into four sets of Link A and Link B.

4:2:2/10 bit signals and 4:0:0/10 bit signals of 8 channels shown in FIG. 9 are converted into HD-SDI signals of 8 channels having newly-changed details. At this time, CH1 of an original basic stream can be applied to CH1 (Link A) of the HD-SDI signals and CH5 of the original basic stream is applied to CH2 (Link B) of the HD-SDI signals.

Here, the 4:2:2/10 bit signals and 4:0:0/10 bit signals are multiplexed to the HD-SDI signals of 8 channels on the basis of the following rule.

(1) CH1, CH2, CH3, and CH4 of the basic stream created from the first and second sub-images shown in FIG. 6 are set to CH1, CH3, CH5, and CH7 which are Link A of four sets of dual link HD-SDI (SMPTE ST372), respectively.

(2) CH5, CH6, CH7, and CH8 of the basic stream created from the third and fourth sub-images shown in FIG. 6 multiplex the even-number pixel samples of the Y signals multiplexed to the Y′ channels to the C_{B} channels of the odd-number pixel samples subsequent to CH2, CH4, CH6, and CH8 which are Link B of the four sets of dual link HD-SDI signals.

(3) CH5, CH6, CH7, and CH8 of the basic stream multiplex the odd-number pixel samples of the Y signals multiplexed to the Y′ channels to the C′_{R} channels with the same sample numbers as CH2, CH4, CH6, and CH8 which are Link B of the four sets of dual link HD-SDI signals again.

Accordingly, the second mapping unit 11B multiplexes the first to fourth basic streams, into which the first and second sub-images are converted and which has the data structure of the 4:2:2/10 bit signal, to Link A of the dual link HD-SDI. The second mapping unit 11B multiplexes the Y signals whose sample number is an even number, out of the fifth to eighth basic streams into which the third and fourth sub-images and which has the data structure of a 4:0:0/10 bit signal, as Link B of the dual link HD-SDI signal to the (sample number+1)-th C′_{B} channels. The odd-number samples of the Y signals in the 4:0:0/10 bit signals are multiplexed as Link B of the HD-SDI signal to the (even sample number)-th C′_{R} channels. The first to eighth basic streams are converted to the HD-SDI signals with the data structure of a 4:4:4/10 bit signal.

In this way, the second mapping unit 11B arranges the HD-SDI signals of 8 channels including CH1 to CH4 of the first and second sub-images which are the 4:2:2/10 bit signals and CH5 to CH8 of the third and fourth sub-images which are 4:0:0/10 bit signals into four sets of Link A and Link B.

FIG. 12 shows an example of the process of converting the 4:2:2/10 bit signal and 4:0:0/10 bit signal into the data structure of the 4:4:4/10 bit signal.

In this example, the data transfer sequence of Link A/B is shown. Here, the pixel samples of Link A and Link B are converted in accordance with the notation that “sub1,2” such as Y′_{sub1,2}0 represent the first and second sub-images and “0” represents the n-th pixel sample in the Y′ channel.

Link A: C′_{B}0, Y′_{Sub1,2}0, C′_{R}0, Y′_{Sub1,2}1, C′B2:, Y′_{Sub1, 2}2, C′_{R}2, Y′_{Sub1,2}3, . . . .

Link B: Y′_{sub3,4}0, A, Y′_{Sub3,4}1, A, Y′_{Sub3,4}2, A, Y′_{sub3,4}3, A, . . . .

At this time, Link A has CH1 to CH4 acquired from the first and second sub-images without any change and Ych (10 bits) of CH5 to CH8 acquired from the third and fourth sub-images are multiplexed to the Cch of Link B. The initial values C′_{B} and C′_{R} included in CH5 to CH8 are deleted.

Link A/B can have the same data structure as the data structure of 4:4:4 (R′G′B′ or Y′Cb′Cr′)/10 bit signal defined in the SMPTE ST372 which the dual link HD-SDI standard. Accordingly, the 10 G-SDI of mode-D can transmit four sets of dual link HD-SDI Link A/B of the 4:4:4 (R′G′B′ or Y′Cb′Cr′)/10 bit signals. That is, with the data structure in which the 4:2:0/10 bit signal is multiplexed again to the 4:4:4 (R′G′B′ or Y′Cb′Cr′)/10 bit signal, it is possible to transmit signals through the 10 G-SDI 1 channel of mode-D. This means that it is possible for signals to be abled to be transmitted through the use of the 10 G-SDI whose number of channels is half the number of channels defined in the current SMPTE ST2036-3 standard.

In this way, the 3840×2160/50P-60P/4:2:0/10 bit signal is multiplexed to 10.692 Gbps transmission stream defined in the mode-D of 4 channels. This multiplexing method employs the method disclosed in JP-A-2008-099189. Here, as shown in FIG. 9, the first and second sub-images are converted into 4:2:2/10 bit signals and the third and fourth sub-images are converted into 4:0:0/10 bit signals. The 4:2:2/10 bit signals and the 4:0:0/10 bit signals of 8 channels mapped by the mapping unit 11 are sent to the second mapping unit 11B (see FIG. 3).

In the SMPTE ST435-1 and 2 or the SMPTE ST2036-3, it is defined to allocate the HD-SDI signals of 8 channels to odd-number input channels CH1, CH3, CH5, and CH7 of the 10 G-SDI of mode-D defined in the SMPTE ST435-2 and to transmit the HD-SDI signals. On the other hand, it is defined that no signal is allocated to the even-number input channels. The transmission method using the 10 G-SDI of mode-D of 2 channels in total.

### [1-2. Internal Constitution and Operational Example of Mapping Unit (Example of 3840×2160/50P-60P/4:2:0/12 Bit)]

The internal constitution and the operational example of a mapping unit 11C when an input signal is 3840×2160/50P-60P/4:2:0/12 bit signal will be described below.

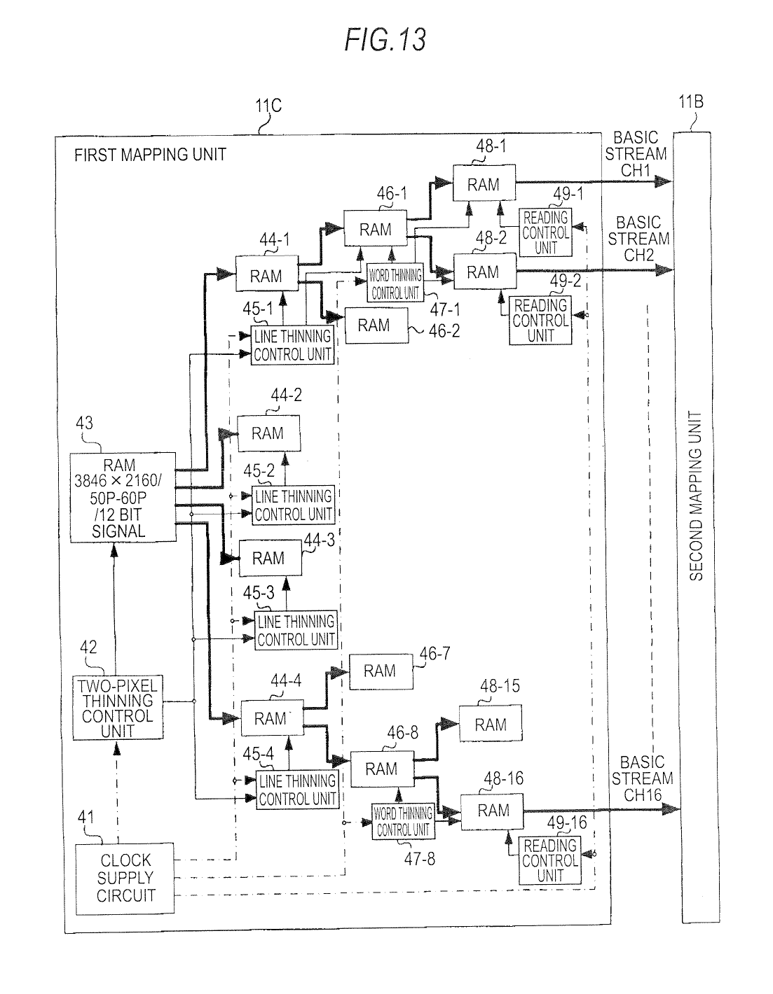

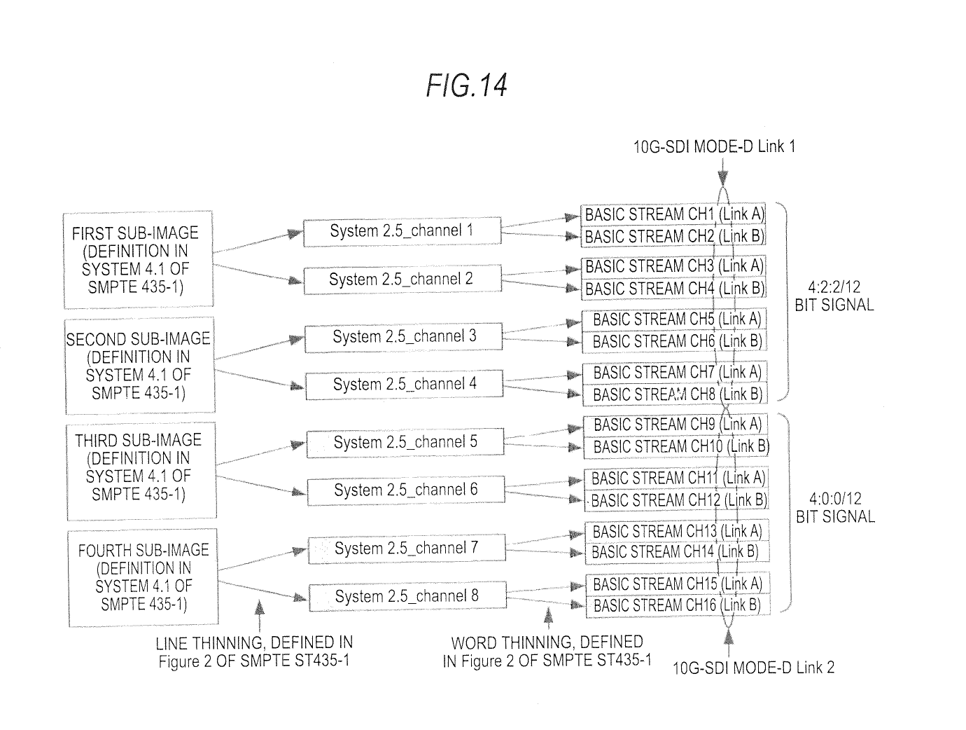

FIG. 13 shows an example of the internal constitution of the first mapping unit 11C mapping a 4:2:0/12 bit signal.

The first mapping unit 11C includes a clock supply circuit 41 supplying a clock to the constituent units and a RAM 43 storing a video signal of 3840×2160/50P-60P/4:2:0/12 bit. The first mapping unit 11C further includes a two-pixel thinning control unit 42 controlling the two-pixel thinning (interleaving) process of reading two pixel samples included in the UDHTV1 class image read from the RAM 43. The first mapping unit 11C further includes RAMS 44-1 to 44-4 to which the thinned two pixel samples are written as the first to fourth sub-images.

The first mapping unit 11C further includes a line thinning control units 45-1 to 45-4 controlling the line thinning process of converting the first to fourth sub-images read from the RAMs 44-1 to 44-4 from progressive signals to interlaced signals. The first mapping unit 11C further includes RAMs 46-1 to 46-8 to which the interlaced signals thinned out by the line thinning control units 45-1 to 45-4 are written for each line.

The first mapping unit 11C further includes word thinning control unit 47-1 to 47-8 controlling the word thinning of data read from the RAMs 46-1 to 46-8. The first mapping unit 11C further includes RAMs 48-1 to 48-16 storing words thinned out by the word thinning control units 47-1 to 47-8. The first mapping unit 11C further includes reading control units 49-1 to 49-16 outputting word data read from the RAMs 48-1 to 48-16 as basic streams of 16 channels (the 4:2:2/12 bit signals and the 4:0:0/12 bit signals).

The processing block creating CH1 and CH2 of the basic streams as the 4:2:2/12 bit signals is shown in FIG. 13, but the blocks creating CH3 to CH16 of the basic streams have the same constitution and thus the drawing and detailed description thereof will not be repeated.

The operational example of the first mapping unit 11C will be described below.

The clock supply circuit 41 supplies a clock to the two-pixel thinning control unit 42, the line thinning control units 45-1 to 45-4, the word thinning control units 47-1 to 47-8, and the reading control units 49-1 to 49-16. This clock is used to read or write pixel samples and the constituent units are synchronized by this clock.

Video signals defined by a UDHTV1 class image, input from an image sensor not shown, in which the number of pixels in a frame is greater than the number of pixels defined in the basic stream format with the maximum number of pixels of 3840×2160 are written to the RAM 43. The UHDTV1 class image in this example represents a video signal of 3840×2160/50P-60P/4:2:0/12 bits. In this example, the pixel samples thinned out every two pixels from the UHDTV1 class image are mapped on the video data areas of the first to fourth sub-images defined by 1920×1080/50P-60P/4:2:0/12 bit signals.

The two-pixel thinning control unit 42 thins out two pixel samples from the UHDTV1 class image and maps the thinned pixel samples on the effective areas of the first to fourth sub-images corresponding to 1920×1080/50P-60P. The 1920×1080/50P-60P is defined in the SMPTE 435-1. The detailed processing example of this mapping will be described later.

The line thinning control units 45-1 to 45-4 convert the progressive signals into interlaced signals. Specifically, the line thinning control units 45-1 to 45-4 read the pixel samples mapped on the video data areas of the first to fourth sub-images from the RAMs 44-1 to 44-4. At this time, the line thinning control units 45-1 to 45-4 convert a single sub-image into the 1920×1080/50I-60I/4:2:2 or 4:0:0/12 bit signals of 2 channels. Then, the line thinning control units 45-1 to 45-4 write the 1920×1080/50I-60I signals, which are thinned from the video data areas of the first to fourth sub-images for each line and converted into the interlaced signals, to the RAMs 46-1 to 46-8.

The word thinning control units 47-1 to 47-8 thin out the pixel samples, which have been thinned out for each line by the line thinning control units 45-1 to 45-4, for each word. The word thinning control units 47-1 to 47-8 map the thinned pixel samples on the video data areas of the HD-SDI defined in the SMPTE 435-1 and outputs first to sixteenth basic streams. Specifically, the word thinning control units 47-1 to 47-8 thin the interlaced signals, which have been read from the RAMs 46-1 to 46-8 and thinned out for each line, for each word and map the thinned signals on the video data areas of the basic streams defined in the SMPTE 435-1. At this time, the word thinning control units 47-1 to 47-8 multiplex the pixel samples on the video data areas of the 10.692 Gbps streams which are defined in the SMPTE 435-1 and which are determined by mode-D of four channels corresponding to the first to fourth sub-images. That is, the word thinning control units 47-1 to 47-8 convert the 1920×1080/50I-60I/4:2:2 or 4:0:0/12 bit signals into the 4:2:2/12 bit signals and the 4:0:0/12 bit signals of 16 channels. Then, the resultant signals are mapped on the video data areas of every four basic streams defined in the SMPTE 435-1 for each of the first to fourth sub-images.

Specifically, the word thinning control units 47-1 to 47-8 thin out and read the pixel samples for each word from the RAMs 44-1 to 44-8 in the same way as shown in FIG. 9 of the SMPTE 372. Then, the word thinning control units 47-1 to 47-8 convert the read pixel samples into the 1920×1080/50I-60I signals of 2 channels and write the resultant signals to the RAMs 48-1 to 48-16.

The reading control units 49-1 to 49-16 output transmission streams of the basic streams of 16 channels read from the RAMS 48-1 to 48-16. Specifically, the reading control units 49-1 to 49-16 read the pixel samples from the RAMs 48-1 to 48-16 in response to a reference clock supplied from the clock supply circuit 41. Then, the reading control units output the basic streams CH1 to CH16 of 16 channels including 16 pairs of two Link A and Link B to the subsequent mapping unit 1B.

In this example, in order to perform the two-pixel thinning, the line thinning, and the word thinning, three steps of thinning processes are performed using three types of memories (the RAMs 44-1 to 44-4, the RAMs 46-1 to 46-8, and the RAMs 48-1 to 48-16). However, data acquired through the two-pixel thinning, the line thinning, and the word thinning may be stored in a single memory and may be output as the basic streams of 16 channels.

FIG. 14 shows an example where the first mapping unit 11C maps the 3840×2160/50P-60P/4:2:0/12 bit signals on the basic streams of 16 channels.

As described above, the pixel samples of the first to fourth sub-images to which the 3840×2160/50P-60P/4:2:0/12 bit signals are multiplexed are sequentially subjected to the line thinning and the word thinning and then are multiplexed to the basic streams of 16 channels.

The basic streams CH1 to CH8 have the same sample constitution as the 4:2:2/10 bit signal and can be transmitted through the use of link 1 of the 10 G-SDI of mode-D. Similarly, the basic streams CH9 to CH16 have the same sample constitution as the 4:0:0/10 bit signal and can be transmitted through the use of link 2 of the 10 G-SDI of mode-D.

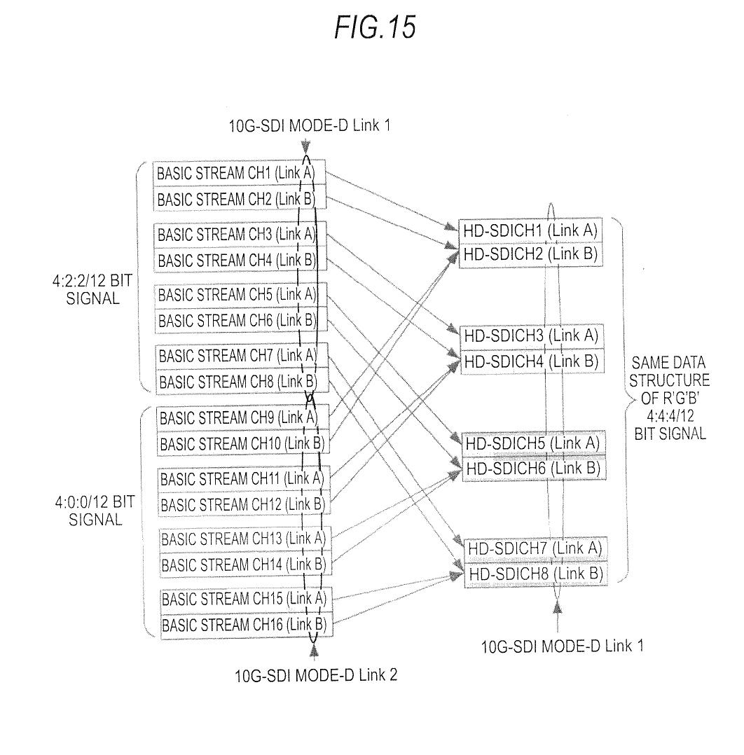

FIG. 15 shows an example where the 4:2:2/12 bit signals and the 4:0:0/12 bit signals of 16 channels are mapped on the HD-SDI signals which are four sets of Link A/B.

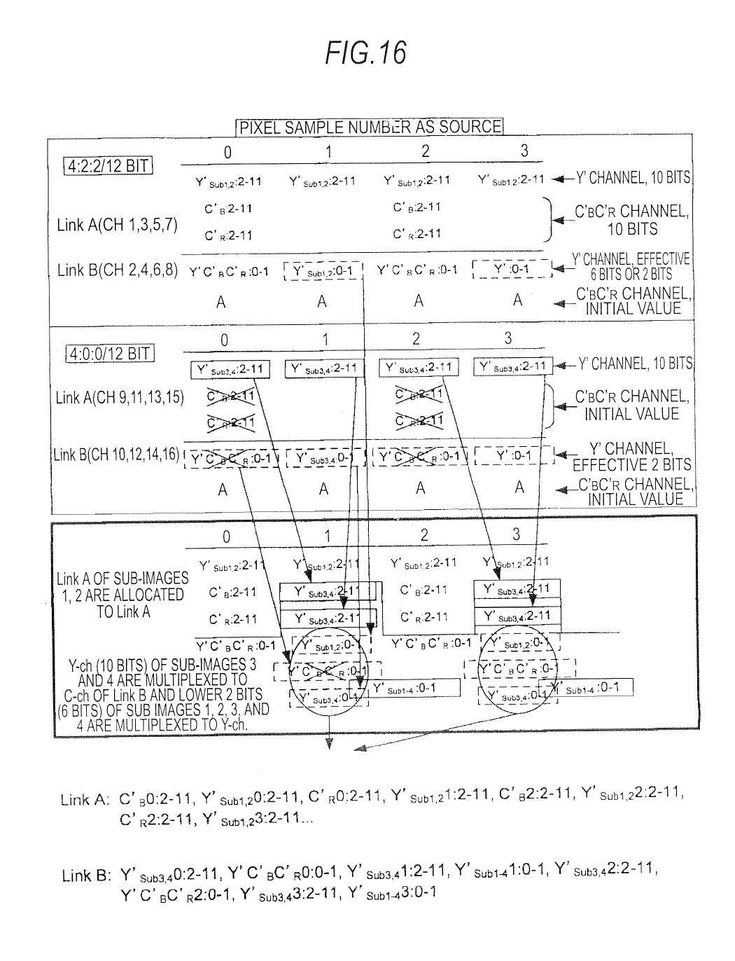

FIG. 16 shows a process example of converting the 4:2:2/12 bit signals and the 4:0:0/12 bit signals of 16 channels into the 4:4:4/12 bit signals.

The basic streams CH1 to CH16 shown in FIG. 14 are multiplexed again in the following sequence as shown in FIG. 15.

(1) The basic streams CH1, CH3, CH5, and CH7 are used as CH1, CH3, CH5, and CH7 which are Link A of four sets of dual link HD-SDI signals. Regarding the basic streams CH2, CH4, CH6, CH8, and CH9 to CH16, upper 10 bits of the Y′ signals of the third and fourth sub-images in the Y and C channels of Link B and lower 2 bits of the Y′C′_{B}C′_{R} signals of the first to fourth sub-images are multiplexed and the resultant signals are multiplexed again to the Y and C channels of CH2, CH4, CH6, and CH8 which are Link B of four sets of dual link HD-SDI signals. At this time, the default signals of CH2, CH4, CH6, CH8, and CH9 to CH16 of the basic streams are excluded.

(2) The Ych signals (6 bits) of the (even number)-th pixel samples of CH2, CH4, CH6, and CH8 created from the first and second sub-images are multiplexed to the same (even number)-th pixel samples of the Y channel of CH2, CH4, CH6, and CH8 which are Link B of four sets of dual link HD-SDI signals.

(3) The Y signals (10 bits) of CH9, CH11, CH13, and CH15 of the basic streams created from the third and fourth sub-images are multiplexed as follows. That is, the (even number)-th pixel samples of CH9, CH11, CH13, and CH15 of the basic streams are multiplexed to the C′_{B} channel of the (odd number)-th pixel samples subsequent to CH2, CH4, CH6, and CH8 which are Link B of four sets of dual link. HD-SDI signals. The (odd number)-th pixel samples are multiplexed again to the C′_{R} channel of the same (odd number)-th pixel samples of CH2, CH4, CH6, and CH8 which are Link B of four sets of dual link HD-SDI signals.

(4) The Ych signals (2 bits) of the (odd number)-th pixel samples of CH2, CH4, CH6, and CH8 of the basic streams created from the first and second sub-images and the lower 2 bits of the Y signals of CH10, CH12, CH14, and CH16 of the basic streams created from the third and fourth sub-images are allocated to the (odd number)-th pixel samples Ych of CH2, CH4, CH6, and CH8 which are Link B of four sets of dual link HD-SDI signals, for example, as shown in Table 4.

TABLE 4
Word

| 9 | | | | | | | | | 0 |
|---|---|---|---|---|---|---|---|---|---|
| (MSB) | 8 | 7 | 6 | 5 | 4 | 3 | 2 | 1 | (LSB) |
| B8 | Ē P̅ | Y′Sub1,2:1 | Y′Sub1,2:0 | Y′C′BC′R:1 | Y′C′BC′R:0 | Y′Sub3,4:1 | Y′Sub3,4:0 | Res | Res |

Note:
1. MSB: most significant bit
2. LSB: least significant bit
3. B8: even parity of B0 to B7
4. B9: inverted bit of B8
5. B0 and B1: reserved bit which is set to zero before being defined

The lower 2 bits is set to reserve (0)

The lower 2 bits of the (odd number)-th pixel samples of the Y signals of the third and fourth sub-images are multiplexed to bits 2 and 3.

The lower 2 bits of the (even number)-th pixel samples of the Y signals of the third and fourth sub-images are multiplexed to bits 4 and 5.

The lower 2 bits of the (odd number)-th pixel samples of the Y signals of the first and second sub-images are multiplexed to bits 6 and 7.

Bit 8 is even parity.

Bit 9 is the inverted bit of bit 8. 10 bits of the Y signal are expressed by Y′Sub1-4:0-1.

The data transmission order of Link A/B is changed as shown in FIG. 15.

Link A: C′_{B}0:2-11, Y′_{Sub1,2}0:2-11, C′_{R}0:2-11, Y′_{Sub1,2}1:2-11, C′_{B}2:2-11, Y′_{Sub1,2}2:2-11, C′_{R}2:2-11, Y′_{sub1,2}3:2-11 . . . .

Link B: Y′_{Sub3,4}0:2-11, Y′C′_{B}C′_{R}0:0-1, Y′_{Sub3,4}1:2-11, Y′_{Sub1-4}1:0-1, Y′_{Sub3,4}2:2-11, Y′C′_{B}C′_{R}2:0-1, Y′_{Sub3,4}3:2-11, Y′_{Sub1-4}3:0-1 . . . .

At this time, the second mapping unit 11B multiplexes the first, third, fifth, and seventh basic streams, into which the first and second sub-images are converted and which has the data structure of the 4:2:2/12 bit signal, to CH1, CH3, CH5, and CH7 which are Link A of the dual link HD-SDI signals.

The Y signals with an even sample number of the second, fourth, sixth, and eighth basic streams, into which the first and second sub-images are converted and which has the data structure of the 4:2:2/12 bit signal, are multiplexed to the Y signals with the same sample number of CH2, CH4, CH6, and CH8 which are Link B of the dual link HD-SDI signals. The Y signals with an even sample number of the ninth, eleventh, thirteenth, and fifteenth basic streams, into which the third and fourth sub-images are converted and which has the data structure of the 4:0:0/12 bit signal, are multiplexed to the (sample number+1)-th C′_{B} channels of CH2, CH4, CH6, and CH8 which are Link B of the dual link HD-SDI signals. The Y signals with an odd sample number of the ninth, eleventh, thirteenth, and fifteenth basic streams are multiplexed to the same (sample number)-th C′₅ channels of CH2, CH4, CH6, and CH8 which are Link B of the dual link HD-SDI signals. The Y signals with an odd sample number of the second, fourth, sixth, and eighth basic streams and the lower 2 bits of the Y signals of the tenth, twelfth, fourteenth, and sixteenth basic streams, into which the third and fourth sub-images are converted and which has the data structure of the 4:0:0/12 bit signal, are multiplexed to the Y signals with an odd sample number of CH2, CH4, CH6, and CH8 which are Link B of the dual link HD-SDI signals.

In this way, four links including CH1 and CH2 of the first sub-image corresponding to the 4:2:2/12 bit and CH9 and CH10 of the third sub-image corresponding to 4:0:0/12 bit are arranged into two links (Link A/B). The data structure is made to match with the same data structure as R′ G′ B′ (4:4:4/12 bit) of the dual link HD-SDI signals (SMOTE ST372).

Accordingly, the same data structure as the data structure of 4:4:4 (R′G′B′ or Y′C′_{B}C′_{R})/12 bit in the SMOTE ST372 which is the dual link HD-SDI standard can be achieved. As a result, the 10 G-SDI signals of mode-D can be transmitted with four sets of dual link HD-SDI Link A/B of 4:4:4 (R′G′B′ or Y′C′_{b}C′ᵣ)/12 bit. It is possible to reduce the number of channels of the HD-SDI signals to be transmitted from 16 channels to 8 channels. With the data structure multiplexed again to correspond to the 4:4:4 (R′G′B′ or Y′C′_{B}C′_{R})/12 bit, the 10 G-SDI signals of mode-D of 1 channel can be transmitted. Accordingly, it is possible to transmit the 10 G-SDI signals whose number is half the number of channels defined in the current SMPTE ST2036-3 standard.

Here, the second mapping unit 11B shown in FIG. 4 will be described again.

CH1, CH3, CH5, CH7, CH9, CH11, CH13, and CH15 drawn by bold lines in the drawing represent the paths through which the 4:2:0/10 bit signals are processed, and CH1 to CH16 drawn by bold lines and fine lines represent the paths through which the 4:2:0/12 bit signals are processed. Since the 4:2:0/10 bit signal is upward compatible with the 4:2:0/12 bit, it is possible to process the 4:2:0/10 bit signal by using some circuits for the 4:2:0/12 bit signal as a signal processing circuit. That is, by allocating the odd-number channels of the basic streams of 8 channels shown in FIG. 3 to the odd-number channels of input CH1 to CH16 in FIG. 4, the upward compatibility is taken between the 4:2:0/10 bit signal and the 4:2:0/12 bit signal. Accordingly, a writing control signal or a reading control signal of S/P-converted Y/C-CH1 data to or from the RAM is created from a reproduction clock or a word synchronization signal created by the S/P conversion circuit. When reading the pixel samples, the input Y/C-ch data are multiplexed again to Link B through the use of the conversion process shown in FIG. 12 or 16.

As described above, the second mapping unit 11B is a subsequent-stage processing block of the mapping unit 11 and includes S/P conversion units 28-1 to 28-16, composite units 29-1 to 29-4, and P/S conversion units 30-1 to 30-8.

The basic streams of 16 channels read by the reading control units 49-1 to 49-16 shown in FIG. 13 are input to the input CH1 to CH16 of the second mapping unit 11B, respectively. The input basic streams are converted into parallel data by the S/P conversion units 28-1 to 28-16 corresponding to the input channels.

The data output from the S/P conversion units 28-1 to 28-16 are input to the composite units 29-1 to 29-4. The composite unit 29-1 arranges the input data in Link A and Link B (CH1 and CH2) of the HD-SDI signal on the basis of the basic streams CH1, CH2, CH9, and CH10.

The composite unit 29-2 arranges the input data in Link A and Link B (CH3 and CH4) of the HD-SDI signal on the basis of the basic streams CH3, CH4, CH11, and CH12.

The composite unit 29-3 arranges the input data in Link A and Link B (CH5 and CH6) of the HD-SDI signal on the basis of the basic streams CH5, CH6, CH13, and CH14.

The composite unit 29-4 arranges the input data in Link A and Link B (CH7 and CH8) of the HD-SDI signal on the basis of the basic streams CH7, CH8, CH15, and CH16.

In this way, in any of the 4:2:0/10 bit signal and the 4:2:0/12 bit signal, the mapping unit 11 maps the pixel sample again and then outputs the HD-SDI signals of 8 channels to the S/P and 8 B/10 B conversion unit 12. Accordingly, the data structure of the HD-SDI signals of 8 channels can be matched with the same data structure as R′G′B′ or Y′C′_{B}C′_{R} (4:4:4/10 bit or 12 bit) of the dual link HD-SDI signals (SMPTE ST372). The data structure for transmission through the 10 G-SDI of 2 channels of mode-D can be converted into the data structure which can be transmitted through 1 channel of the 10 G-SDI of mode-D.

The parallel digital data with a width of 50 bits which is subjected to an 8 bit/10 bit encoding process is stored in an FIFO memory not shown in response to a 37.125 MHz clock received from a PLL 13. Thereafter, the parallel digital data with a width of 50 bits is read from the FIFO memory and is sent to the multiplexing unit 14 in response to a clock of 83.5312 MHz received from the PLL 13.

The multiplexing process performed by the multiplexing unit 14 will be described below.

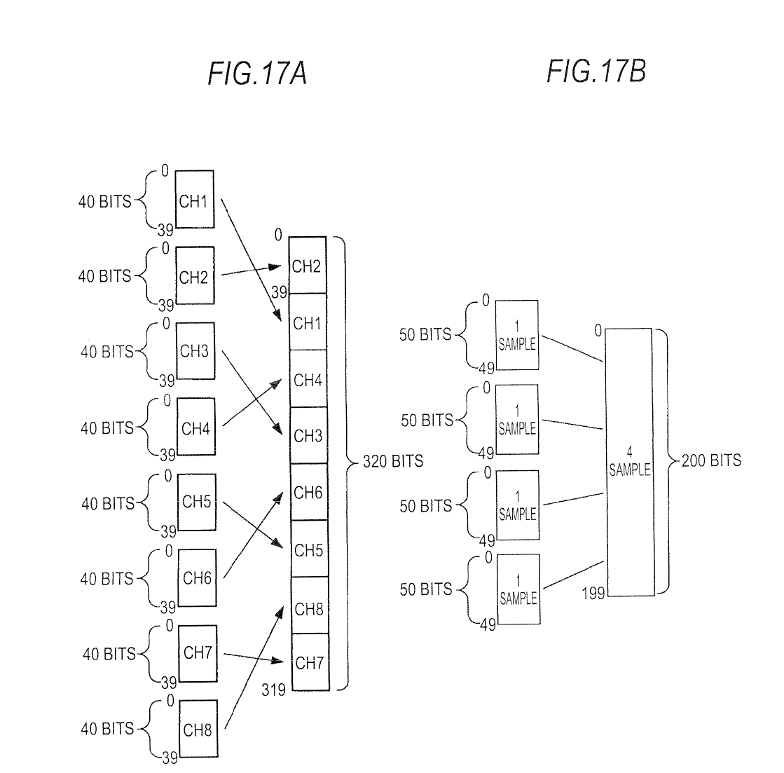

FIGS. 17A and 17B show an example of the data multiplexing process performed by the multiplexing unit 14. FIG. 17A shows a state where 40-bit data of each of scrambled CH1 to CH8 is exchanged in the order of a pair of CH1 and CH2, a pair of CH3 and CH4, a pair of CH5 and CH6, and a pair of CH7 and CH8 and is multiplexed into a width of 320 bits. FIG. 17B shows a state where 8 B/10 B-converted 50 bit/sample data is multiplexed to four samples with a width of 200 bits.

As shown in FIG. 17A, 8 bit/10 bit-encoded data and self-synchronously scrambled data are alternately arranged every 40 bits. Accordingly, it is possible to solve the variation in mark rate (a ratio of 0 and 1) based on the scrambling manner or the unstable transition of 0-1 or 1-0 and to prevent pathological patterns from being generated.

The multiplexing unit 14 multiplexes parallel digital data, in which only the horizontal blanking period of CH1 read from the FIFO memory in the S/P scrambling and 8 B/10 B unit 12 is a width of 50 bits, into a width of 200 bits by four samples.

The parallel digital data with a width of 320 bits and the parallel digital data with a width of 200 bits multiplexed by the multiplexing unit 14 are sent to the data length converting unit 15. The data length converting unit 15 is constructed by shift registers. The parallel digital data with a width of 256 bits is formed using the data with a width of 256 bits into which the parallel digital data with a width of 320 bits is converted and the data with a width of 256 bits into which the parallel digital data with a width of 200 bits is converted. The parallel digital data with a width of 256 bits is then converted into a width of 128 bits.

The parallel digital data with a width of 64 bits sent from the data length converting unit 15 from the FIFO memory 16 is formed as serial digital data of 16 channels with a bit rate of 668.25 Mbps by a multi-channel data forming unit 17. The multi-channel data forming unit 17 is, for example, an XSBI (Ten gigabit Sixteen-bit Interface: 16-bit interface used in the 10 gigabit Ethernet (registered trademark) system). The serial digital data of 16 channels formed by the multi-channel data forming unit 17 are set to a multiplexing and P/S conversion unit 18.

The multiplexing and P/S conversion unit 18 has a function of a parallel/serial converter, multiplexes the serial digital data of 16 channels received from the multi-channel data forming unit 17, and converts the multiplexed parallel digital data in a parallel/serial manner. Accordingly, the serial digital data of 668.25 Mbps×16=10.692 Gbps are created.

The serial digital data with a bit rate of 10.692 Gbps created by the multiplexing and P/S conversion unit 18 are sent to a photoelectric conversion unit 19. The photoelectric conversion unit 19 serves as an output unit outputting the serial digital data of a bit rate of 10.692 Gbps to the CCU 2. The photoelectric conversion unit 19 outputs a transmission stream of 10.692 Gbps multiplexed by the multiplexing unit 14. The serial digital data of a bit rate of 10.692 Gbps converted into an optical signal by the photoelectric conversion unit 19 is transmitted to the CCU 2 from the broadcasting camera 1 via an optical fiber cable 3.

By using the broadcasting camera 1 according to this example, it is possible to 4:2:0/10 bit or 12 bit signal, which are 3840×2160/50P-60P input from an image sensor, as the serial digital data. In the signal transmitting device and the signal transmitting method according to this example, the 3840×2160/50P-60P/4:2:0/10 bit signals are converted into the HD-SDI signals of CH1 to CH8. Thereafter, it is possible to output the converted signals as the serial digital data of 10.692 Gbps.

The 3840×2160/50P-60P/4:2:0/10 bit or 12 bit signals are not transmitted simply from the respective broadcasting cameras 1 to the CCU 2. That is, the above-mentioned return video (a video signal for displaying a video taken by another broadcasting camera 1) is transmitted from the CCU 2 to the broadcasting cameras 1 via the optical fiber cables 3. Since the return video is generated through the use of the known technique (for example, HD-SDI signals of 2 channels are 8 bit/10 bit-encoded, multiplexed, and converted into serial digital data), the circuit constitution thereof will not be described.

### [Internal Constitution and Operational Example of CCU]

The internal constitution of the CCU 2 will be described below.

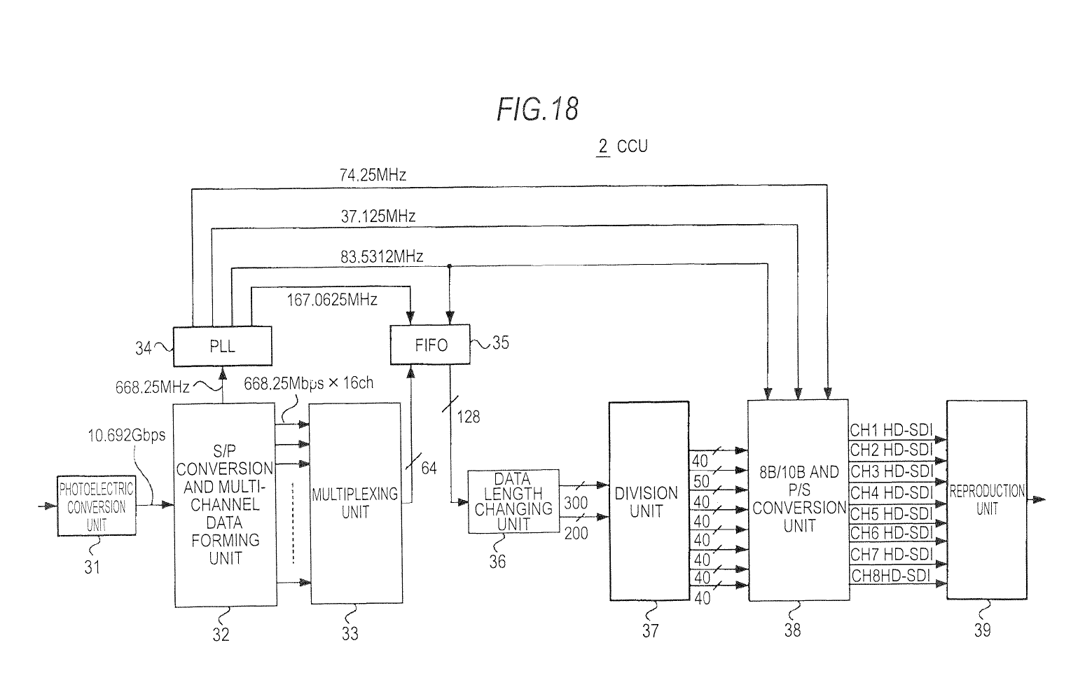

FIG. 18 is a block diagram illustrating a part associated with this embodiment out of the circuit constituents of the CCU 2. In the CCU 2, plural sets of such circuits are installed to correspond to the broadcasting cameras 1 in a one-to-one manner.

The serial digital data with a bit rate of 10.692 Gbps transmitted from the broadcasting camera 1 via the optical fiber cable 3 is converted into an electric signal by the photoelectric conversion unit 31 and is then sent to an S/P conversion and multi-channel data forming unit 32. The S/P conversion and multi-channel data forming unit 32 is, for example, an XSBI. The S/P conversion and multi-channel data forming unit 32 receives the serial digital data with a bit rate of 10.692 Gbps.

The S/P conversion and multi-channel data forming unit 32 converts the serial digital data with a bit rate of 10.692 Gbps in a serial/parallel conversion manner. The S/P conversion and multi-channel data forming unit 32 forms serial digital data of 16 channels with a bit rate of 668.25 Mbps from the serial/parallel-converted parallel digital data and extracts a clock of 668.25 Mbps therefrom.

The parallel digital data of 16 channels formed by the S/P conversion and multi-channel data forming unit 32 are sent to the multiplexing unit 33. The clock of 668.25 Mbps extracted by the S/P conversion and multi-channel data forming unit 32 is sent to the PLL 34.

The multiplexing unit 33 multiplexes the serial digital data of 16 channels received from the S/P conversion and multi-channel data forming unit 32 and sends the parallel digital data with a width of 64 bits to the FIFO memory 35.

The PLL 34 sends a clock of 167.0625 MHz, which is obtained by dividing the clock of 668.25 Mbps received from the S/P conversion and multi-channel data forming unit 32 into quarters, as a writing clock to the FIFO memory 35.

The PLL 34 reads and sends a clock of 83.5312 MHz, which is obtained by dividing the clock of 668.25 Mbps received from the S/P conversion and multi-channel data forming unit 32 into 1/8, as a clock to the FIFO memory 35. The PLL 34 also sends the clock of 83.5312 MHz as a reference clock to the FIFO memory in a descrambling 8 B/10 B and P/S conversion unit 38.

The PLL 34 reads and sends a clock of 37.125 MHz, which is obtained by dividing the clock of 668.25 Mbps received from the S/P conversion and multi-channel data forming unit 32 into 1/18, as a clock to the FIFO memory in the descrambling 8 B/10 B and P/S conversion unit 38. The PLL 34 also sends the clock of 37.125 MHz as a reference clock to the FIFO memory in a descrambling 8 B/10 B and P/S conversion unit 38.

The PLL 34 reads and sends a clock of 74.25 MHz, which is obtained by dividing the clock of 668.25 Mbps received from the S/P conversion and multi-channel data forming unit 32 into 1/9, as a clock to the FIFO memory in the descrambling 8 B/10 B and P/S conversion unit 38.

In the FIFO memory 35, the parallel digital data with a width of 64 bits received from the multiplexing unit 33 are written in response to the clock of 167.0625 MHz received from the PLL 34. The parallel digital data written to the FIFO memory 35 is read as parallel digital data with a width of 128 bits in response to the clock of 83.5312 MHz received from the PLL 34 and is sent to the data length converting unit 36.

The data length converting unit 36 is constructed by shift registers and converts the parallel digital data with a width of 128 bits into a width of 256 bits. The data length converting unit 36 detects K28.5 added to a timing reference signal SAV or EAV. Accordingly, the data length converting unit 36 identifies the respective line periods and converts the data of the timing reference signal SAV, the active line, the timing reference signal EAV, the line number LN, and the error detection code CRC into a width of 320 bits. The data length converting unit 36 converts the data of the horizontal auxiliary data space (the data of the horizontal auxiliary data space of CH1 8 B/10 B-encoded) into a width of 200 bits. The parallel digital data with a width of 320 bits and the parallel digital data with a width of 200 bits, the data length of which is converted by the data length converting unit 36, are sent to the division unit 37.

The division unit 37 divides the parallel digital data with a width of 320 bits received from the data length converting unit 36 into data of CH1 to CH8 data with 40 bits before being multiplexing by the multiplexing unit 14 in the broadcasting camera 1. The parallel digital data include the data of the timing reference signal SAV, the active line, the timing reference signal EAV, the line number LN, and the error detection code CRC. The parallel digital data with a width of 40 bits of CH1 to CH8 are sent to the descrambling 8 B/10 B and P/S conversion unit 38.

The division unit 37 divides the parallel digital data with a width of 200 bits received from the data length converting unit 36 into data with 50 bits before being multiplexed by the multiplexing unit 14 in the broadcasting camera 1. The parallel digital data include the data of the horizontal auxiliary data space of CH1 8 B/10 B-encoded. The parallel digital data with a width of 50 bits are sent to the descrambling 8 B/10 B and P/S conversion unit 38.

The descrambling 8 B/10 B and P/S conversion unit 38 includes 32 blocks corresponding to CH1 to CH8. The descrambling 8 B/10 B and P/S conversion unit 38 in this example serves as a receiver unit receiving first to fourth sub-images on which a video signal is mapped, which each is divided into a first link channel and a second link channel, and which each is divided into two lines.

The descrambling 8 B/10 B and P/S conversion unit 38 includes blocks for CH1, CH3, CH5, and CH7 which are Link A, descrambles the input parallel digital data, converts the descrambled parallel digital data into serial digital data, and outputs the resultant serial digital data.

The descrambling 8 B/10 B and P/S conversion unit 38 includes blocks for CH2, CH4, CH6, and CH8 which are Link B, decodes the input parallel digital data in 8 B/10 B, converts the decoded data into serial digital data, and outputs the resultant serial digital data.

The reproduction unit 39 performs the inverse processes of the processes of the mapping unit 11 in the broadcasting camera 1 on the HD-SDI signals of CH1 to CH8 (Link A and Link B) sent from the descrambling 8 B/10 B and P/S conversion unit 38 in accordance with the SMPTE 435. Through these processes, the reproduction unit 39 reproduces 3840×2160/50P-60P/4:2:0/10 bit or 12 bit signal.

At this time, the reproduction unit 39 reproduces the first to fourth sub-images by sequentially the word multiplexing process, the line multiplexing process, and the two-pixel multiplexing process on the HD-SDI1 to HD-SDI32 signals received by the S/P conversion and multi-channel data forming unit 32. The reproduction unit 39 extracts two pixel samples arranged in the video data areas of the first to fourth sub-images and sequentially multiplex the extracted pixel samples in a frame of a UHDTV1 class image.

The 3840×2160/50P-60P/4:2:0/10 bit or 12 bit signal reproduced by the reproduction unit 39 are output to the CCU 2 and are sent to, for example, a VTR or the like (not shown).

In this example, the CCU 2 performs the signal processing of the party receiving the serial digital data generated by the broadcasting camera 1. In the signal receiving device and the signal receiving method, the parallel digital data is generated from the serial digital data with a bit rate of 10.692 Gbps and the generated parallel digital data is divided into data of the respective channels of Link A and Link B.

The divided data of Link A can be self-synchronously descrambled, but all the values of the registers in the descrambler are set to 0 to start the decoding just before the timing reference signal SAV. Data of at least several bits subsequent to the error detection code CRC can be self-synchronously descrambled. Accordingly, only the data of the timing reference signal SAV, the active line, the timing reference signal EAV, the line number LN, and the error detection code CRC can be self-synchronously descrambled. As a result, although the data of the horizontal auxiliary data space cannot be self-synchronously scrambled, it is possible to perform accurate calculation in consideration of the carry in the descrambler which is a multiplier circuit and to reproduce the original data.

On the other hand, regarding the divided data of Link B, data of the samples of Link B are formed from the bits of ROB 8 bit/10 bit-decoded. The parallel digital data of Link A which has been self-synchronously descrambled and the parallel digital data of Link B forming the samples are converted in a parallel/serial conversion manner. The mapped HD-SDI signals of CH1 to CH8 are reproduced.

### [1-3. Internal Constitution and Operational Example of Reproduction Unit (Example of 3840×2160/50P-60P/4:2:0/10 Bit)]

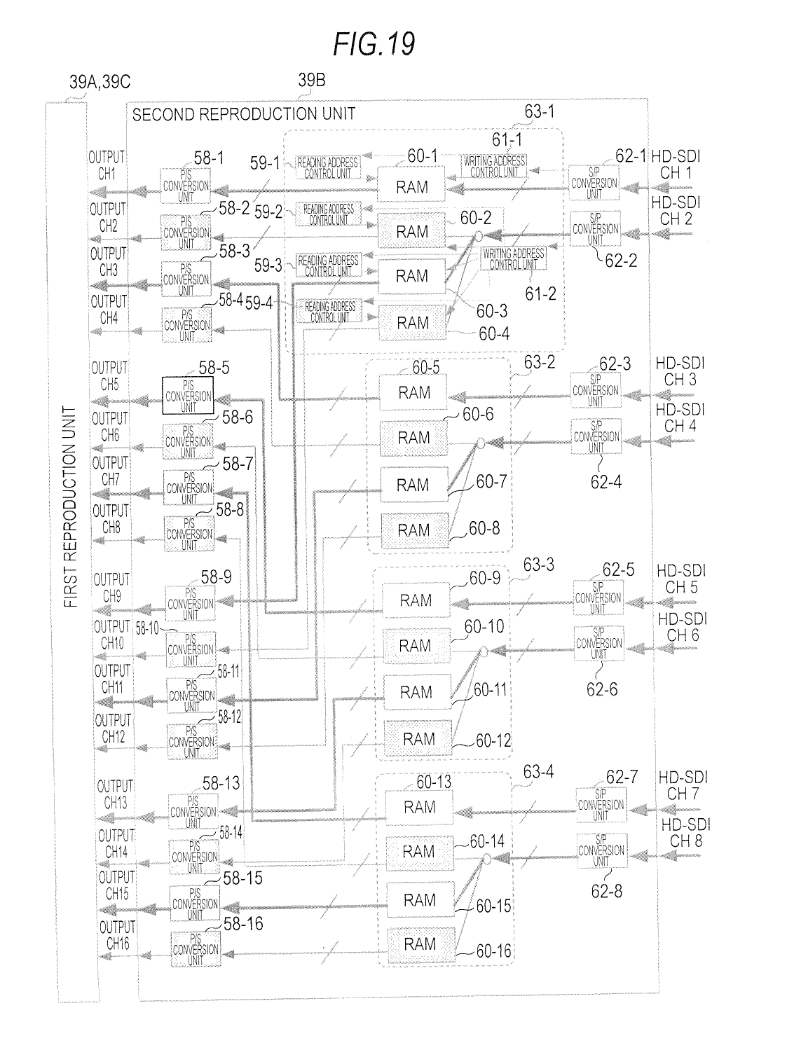

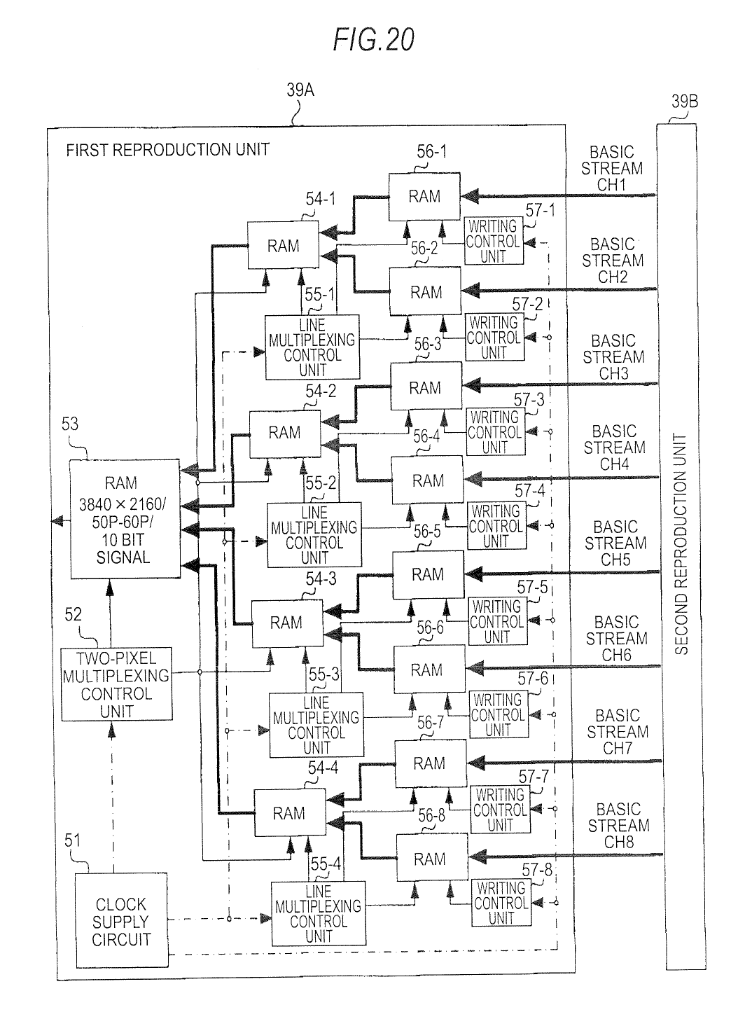

FIGS. 19 and 20 show an internal constitutional example of the reproduction unit 39.

First, an example of a process of reproducing the 3840×2160/50P-60P/4:2:0/10 bit signal will be described. The reproduction unit 39 is a block inversely performing the processes performed on the pixel samples by the mapping unit 11 and includes a first reproduction unit 39A and a second reproduction unit 39B.

The first reproduction unit 39A inversely performs the processes performed by the first mapping unit 11A and the second reproduction unit 39B inversely performs the processes performed by the second mapping unit 11B. Since the processes of the reproduction unit 39 are performed in the order of the second reproduction unit 39B and the first reproduction unit 39A, the constitution and operational example will be described in the order of the second reproduction unit 39B and the first reproduction unit 39A below.

FIG. 19 shows an internal constitutional example for the second reproduction unit 39B generating basic streams of 8 channels to be output to the first reproduction unit 39A from the HD-SDI signals of 8 channels input from the descrambling 8 B/10 B and P/S conversion unit 38.

As described above, the second reproduction unit inversely performs the processes of the second mapping unit 11B.

The second reproduction unit 39B converts any dual link HD-SDI signal with the data structure of a 4:4:4/r bit signal into a 4:2:2/r bit signal and a 4:0:0/r bit signal.

The second reproduction unit 39B includes S/P conversion units 62-1 to 62-8, division units 63-1 to 63-4, and P/S conversion units 58-1 to 58-16. The division unit 63-1 includes writing address control units 61-1 and 61-2, RAMS 60-1 to 60-4, and reading address control units 59-1 to 59-4.

The HD-SDI signals of 8 channels are converted into parallel data by the S/P conversion units 62-1 to 62-8 and then the parallel data are input to the division units 63-1 to 63-4. The division units 63-1 to 63-4 inversely perform the process of mapping the pixel samples shown in FIG. 12 to generate the basic streams from the HD-SDI signals. Here, since the processing blocks of the division units 63-1 to 63-4 are complex, only the processes of the division unit 63-1 will be described and the description of the other division units 63-2 to 63-4 will not be repeated.

The second reproduction unit 39B multiplexes Link A of the dual link HD-SDI signals to the first to fourth basic streams with the data structure of a 4:2:2/10 bit signal and reproduces the first and second sub-images. Regarding Link B of the dual link HD-SDI signals, the second reproduction unit 39B multiplexes the Y signals read from the (sample number+1)-th C′_{B} channels to the Y signals with an even sample number out of the fifth to eighth basic streams with the data structure of a 4:0:0/10 bit signal and reproduces the third and fourth sub-images. Regarding Link B of the HD-SDI signals, the second reproduction unit 39B multiplexes the Y signals read from the (even sample number)-th C channels to the Y signals with an odd sample number out of the 4:0:0/10 bit signals and converts the HD-SDI signals with a data structure of a 4:4:4/10 bit signal into the first to eighth basic streams.

The writing address control units 61-1 and 61-2 included in the division unit 63-1 write the parallel data output from the S/P conversion units 62-1 and 62-2 to the RAMs 60-1 and 60-3. The reading address control units 59-1 and 59-3 included in the division unit 63-1 read the parallel data from the RAMs 60-1 and 60-3 and outputs the read parallel data to the P/S conversion units 58-1 and 58-9. The P/S conversion units 58-1 and 58-9 outputs the parallel data read from the RAMs 60-1 and 60-3 as the basic streams (CH1 and CH9) of 2 channels which are serial data to the first reproduction unit 39A.

The HD-SDI signals (CH3 and CH4) of 2 channels are input to the division unit 63-2 and the parallel data SP-converted by the S/P conversion units 62-3 and 62-4 are written to the RAMs 60-5 and 60-7. Thereafter, the P/S conversion units 58-3 and 58-11 convert the parallel data read from the RAMs 60-5 and 60-7 into serial data and then outputs the serial data as the basic streams (CH3 and CH11) of 2 channels to the first reproduction unit 39A.

The HD-SDI signals (CH5 and CH6) of 2 channels are input to the division unit 63-3 and the parallel data SP-converted by the S/P conversion units 62-5 and 62-6 are written to the RAMs 60-9 and 60-11. Thereafter, the P/S conversion units 58-5 and 58-13 convert the parallel data read from the RAMs 60-9 and 60-11 into serial data and then outputs the serial data as the basic streams (CH5 and CH13) of 2 channels to the first reproduction unit 39A.

The HD-SDI signals (CH7 and CH8) of 2 channels are input to the division unit 63-4 and the parallel data SP-converted by the S/P conversion units 62-7 and 62-8 are written to the RAMs 60-13 and 60-15. Thereafter, the P/S conversion units 58-7 and 58-15 convert the parallel data read from the RAMs 60-13 and 60-15 into serial data and then outputs the serial data as the basic streams (CH7 and CH15) of 2 channels to the first reproduction unit 39A.

FIG. 20 shows an internal constitutional example of the first reproduction unit 39A reproducing the 3840×2160/50P-60P/4:2:0/10 bit signals from the basic streams of 8 channels input from the second reproduction unit 39B.

The first reproduction unit 39A includes a clock supply circuit 51 supplying a clock to the constituent units. The clock supply circuit 51 supplies a clock to the two-pixel multiplexing control unit 52, the line multiplexing control units 55-1 to 55-4, and the writing control units 57-1 to 57-8. The constituent units are synchronized with the clock and the reading or writing of pixel samples is controlled.

The first reproduction unit 39A includes RAMs 56-1 to 56-8 storing the basic streams with the same data structure as the HD-SDI signals of 8 channels of mode-D defined in the SMPTE 435-2. As described above, the basic streams CH1 to CH8 constitute the 1920×1080/50I-60I signals. Basic streams of 8 channels in which the pixel samples of CH1, CH3, CH5, and CH7 as Link A and CH2, CH4, CH6, and CH8 as Link B, which are input from the descrambling 8 B/10 B and P/S conversion unit 38, are exchanged are used as the basic streams CH1 to CH8.

The writing control units 57-1 to 57-8 performs a writing control of storing the input basic streams CH1 to CH8 of 8 channels in the RAMs 56-1 to 56-8 in synchronization with the clock supplied from the clock supply circuit 51.

The line multiplexing control units 55-1 to 55-4 multiplex the interlaced signals read from the RAMs 56-1 to 56-8 for each sub-image and converts the interlaced signals into progressive signals. At this time, the line multiplexing control units 55-1 to 55-4 multiplex the basic streams of the 4:2:0/10 bit signals by the pixel samples for each line of the first to N/2-th (where N is an integer equal to or greater than 2) sub-images which are defined by m′×n′ (where m′ and n′ representing m′ samples and n′ lines are positive integers)/a′−b′ (where a′ and b′ represent a frame rate of a progressive signal)/4:2:2/r bit signals. Similarly, the line multiplexing control units 55-1 to 55-4 multiplexes the basic streams of the 4:0:0/r bit signals by the pixel samples for each line of the (N/2+1)-th to N-th sub-images. In the first to fourth sub-images, m′×n′ is set to 1920×1080 and a′-b′ is set to 50P, 59.94P, and 60P. The line multiplexing control units 55-1 to 55-4 write the 1920×1080/50P-60P/4:2:0/10 bit signals to the RAMs 54-1 to 54-4. That is, the signals stored in the RAMs 54-1 to 54-4 constitute the first to fourth sub-images.

The two-pixel multiplexing control unit 52 maps the pixel samples extracted from the video data areas of the first to fourth sub-images on the UHDTV1 class image. At this time, the two-pixel multiplexing control unit 52 multiplexes two pixel samples so as to be adjacent to each other in the same line of a frame when multiplexing two pixel samples extracted from the first sub-image and the second sub-image out of the first to fourth sub-images defined in the SMPTE 435-1 to the even-number lines of a frame and multiplexing two pixel samples extracted from the third sub-image and the fourth sub-image to the odd-number lines of the frame. That is, the two-pixel multiplexing control unit 52 multiplexes two pixel samples extracted from the first to N-th sub-images so as to be adjacent to each other in the same line in a frame of a class image defined by m×n (where m and n representing m samples and n lines are positive integers)/a−b (where a and b represent a frame rate of a progressive signal)/4:2:0/r bit signals in which the number of pixels in a frame is greater than the number of pixels defined in the HD-SDI format. At this time, the two-pixel multiplexing control unit 52 multiplexes the pixel samples read from the RAMs 54-1 to 54-4 every two pixels through the use of the following processes. That is, the pixel samples extracted from the first to fourth sub-images every two pixels are multiplexed to the UHDTV1 class image. The class image is a 3840×2160/50P-60P/4:2:0/10 bit signal.

FIG. 20 shows an example where the two-pixel multiplexing process and the line multiplexing process are performed in two steps using two types of RAMs. However, the 3840×2160/50P-60P/4:2:0/10 bit may be reproduced using a single RAM.

### [1-4. Internal Constitution and Operational Example of Reproduction Unit (Example of 3840×2160/50P-60P/4:2:0/12 Bit)]

The second reproduction unit 39B performs the following processes when the r bit is set to 12 bits and N=4 is set. That is, the second reproduction unit 39E converts the first, third, fifth, and seventh basic streams with the data structure of upper 10 bits of the 4:2:2/12 bit signal reproduced from CH1, CH3, CH5, and CH7 as Link A of the dual link HD-SDI signals into upper 10 bits of the first and second sub-images. The second reproduction unit 39B converts the Y signals with the same sample number of the second, fourth, sixth, and eighth basic streams with the data structure of the 4:2:2/12 bit signal reproduced from the Y signals with an even sample number of CH2, CH4, CH6, and CH8 as Link B of the dual link HD-SDI signals into the first and second sub-images. The second reproduction unit 39B converts the Y signals reproduced from the (sample number+1)-th C′_{B} channels of CH2, CH4, CH6, and CH8 as Link B of the dual link HD-SDI signals into upper 10 bits of the third and fourth sub-images with an even sample number of the ninth, eleventh, thirteenth, and fifteenth basic streams. The second reproduction unit 39B converts the Y signals reproduced from the (sample number)-th C′_{R} channels of CH2, CH4, CH6, and CH8 as Link B of the dual link HD-SDI signals into upper 10 bits of the third and fourth sub-images with an odd sample number of the ninth, eleventh, thirteenth, and fifteenth basic streams. The second reproduction unit 39B converts the Y signals reproduced from the Y signals with an odd sample number of CH2, CH4, CH6, and CH8 as Link B of the dual link HD-SDI signals into the Y signals with an odd sample number of the second, fourth, sixth, and eighth basic streams. The second reproduction unit 39B converts lower 2 bits of the Y signals of the tenth, twelfth, fourteenth, and sixteenth basic streams with the data structure of the 4:0:0/12 bit signal into the third and fourth sub-images.

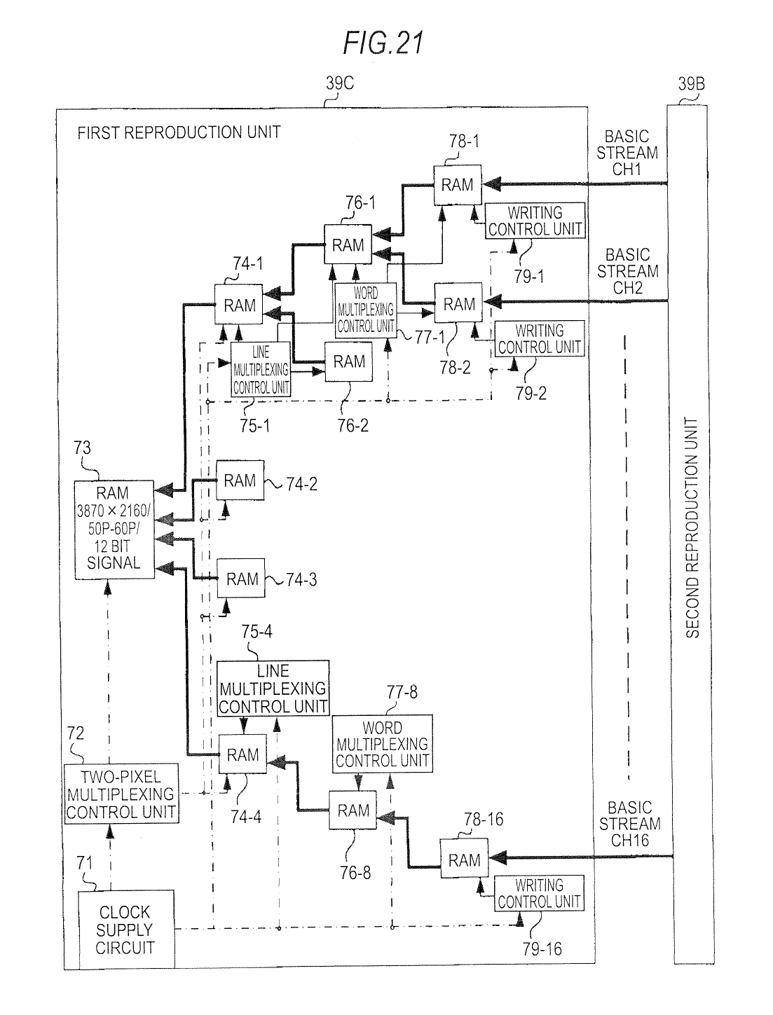

FIG. 21 shows an internal constitutional example of the first reproduction unit 39C generating the 3840×2160/50P-60P/4:2:0/12 bit signals from the basic streams of 16 channels input from the second reproduction unit 39B.

The first reproduction unit 39C is a block inversely performing the processes performed on the pixel samples by the first mapping unit 11C.

The first reproduction unit 39C includes a clock supply circuit 71 supplying a clock to the constituent units. The clock supply circuit 71 supplies a clock to a two-pixel multiplexing control unit 72, line multiplexing control units 75-1 to 75-4, word multiplexing control units 77-1 to 77-8, and writing control units 79-1 to 79-16. The constituent units are synchronized with the clock and the reading or writing of pixel samples is controlled.

The first reproduction unit 39C includes RAMs 78-1 to 78-16 storing the basic streams with the same data structure as the HD-SDI signals of 16 channels of mode-D defined in the SMPTE 435-2. As described above, the basic streams CH1 to CH16 constitute the 1920×1080/50I-60I signals. Basic streams of 16 channels in which the pixel samples of CH1, CH3, CH5, CH7, . . . , and CH31 as Link A and CH2, CH4, CH6, CH8, . . . , and CH16 as Link B, which are input from the descrambling 8 B/10 B and P/S conversion unit 38, are exchanged are used as the basic streams CH1 to CH16.

The writing control units 79-1 to 79-16 perform a writing control of storing the input basic streams CH1 to CH16 of 16 channels in the RAMs 78-1 to 78-16 in synchronization with the clock supplied from the clock supply circuit 71.

The first reproduction unit 39C further includes word multiplexing control units 77-1 to 77-8 controlling the word multiplexing (deinterleaving) process and RAMs 78-1 to 78-16 storing data multiplexed by the word multiplexing control units 77-1 to 77-8. The first reproduction unit 39C further includes line multiplexing control units 75-1 to 75-4 controlling the line multiplexing process and RAMs 74-1 to 74-4 storing data multiplexed by the line multiplexing control units 75-1 to 75-4.

The word multiplexing control units 77-1 to 77-8 multiplex the pixel samples extracted from the video data area of a 10.692 Gbps stream, which is defined in the SMPTE 435-2 and which is determined by mode-D of four channels to correspond to the first to fourth sub-images, for each word.

At this time, the word multiplexing control units 77-1 to 77-8 multiplex the pixel samples extracted from the video data areas of the basic streams read from the RAMs 78-1 to 78-16 for each line into which words are inversely converted. This multiplexing process is performed in accordance with FIG. 9 of the SMPTE 372. Specifically, the word multiplexing control units 77-1 to 77-8 control the timing of each pair of (RAMs 78-1 and 78-2), (RAMs 78-3 and 78-4), . . . , and (RAMs 78-31 and 78-16) to multiplex the pixel samples. The word multiplexing control units 77-1 to 77-8 store the generated 1920×1080/50I-60I/4:2:0/12 bit signals in the RAMs 76-1 to 76-8.

The line multiplexing control units 75-1 to 75-4 multiplex the interlaced signals read from the RAMs 76-1 to 76-8 for each sub-image and converts the interlaced signals into progressive signals. The line multiplexing control units 75-1 to 75-4 write the 1920×1080/50P-60P/4:2:0/10 bit signals to the RAMs 74-1 to 74-4. That is, the signals stored in the RAMs 74-1 to 74-4 constitute the first to fourth sub-images.

The two-pixel multiplexing control unit 72 maps the pixel samples extracted from the video data areas of the first to fourth sub-images on the UDHTV1 class image. In the first to fourth sub-images, m′×n′ is set to 1920×1080 and a′-b′ is set to 50P, 59.94P, and 60P. At this time, the two-pixel multiplexing control unit 72 multiplexes the pixel samples read from the RAMs 74-1 to 74-4 every two pixels through the following process. That is, the two-pixel multiplexing control unit 72 multiplexes the pixel samples extracted by two pixels from the first to fourth sub-images in parallel with the UHDTV1 class image. The class image is a 3840×2160/50P-60P/4:2:0/12 bit signal.

FIG. 21 shows an example where the two-pixel multiplexing process, the line multiplexing process, and the word multiplexing process are performed in three steps using three types of RAMs. However, the 3840×2160/50P-60P/4:2:0/12 bit signal may be reproduced using a single RAM.

Here, when the two-pixel thinning method defined in the SMPTE ST435-1 or the SMPTE ST2036-3 is applied to the 3840×2160/4:2:0/10 bit or 12 bit signal, the even-number lines are 4:2:2 signals. The odd-number lines are 4:0:0 signals. In consideration of the fact, the following process is performed. That is, the 4:2:2 signal to which the even-number lines are multiplexed are set as Link A of newly-created four sets of Link A/B and the data are multiplexed again as follows. Accordingly, upper 10 bits are compatible between the 10 bit signal and the 12 bit signal. By employing the data structure which can match with 4:4:4 (R′G′B′)/10 bit or 12 bit defined in the SMPTE ST372, it is possible to reduce the number of channels of the HD-SDI signals or the 10 G-SDI signals to be multiplexed and transmitted to half the number of channels in the related art.

### 2. Second Embodiment

### Examples of UHDTV1 3840×4320/100P, 119.88P, 120P/4:2:0/10 Bit or 12 Bit

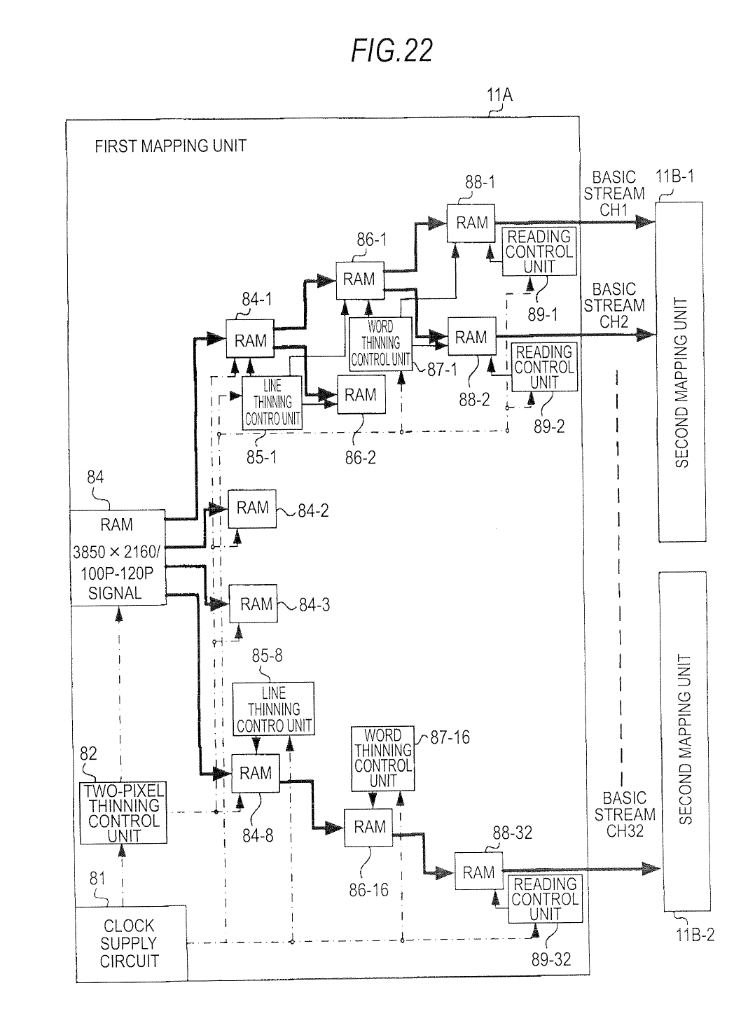

An operational example of a mapping unit 11 and a reproduction unit 39 according to a second embodiment of the present disclosure will be described below with reference to FIGS. 22 to 26.

### [Internal Constitution and Operational Example of Mapping Unit]

An internal constitutional example and an operational example of a first mapping unit 11A and a first reproduction unit 39A according to the second embodiment of the present disclosure will be described below with reference to FIGS. 22 to 26. Here, a method of thinning out pixel samples of 3840×2160/100P-120P/4:2:0/10 bit or 12 bit signal will be described.

In the case of a 4:2:0/10 bit signal in the related, a method of multiplexing and transmitting pixel samples to HD-SDI signals of 16 channels, multiplexing a default value to 0 of a 4:2:0 signal and allocating the default value to only the odd channels of mode-D of a 10 G-SDI signal, and transmitting the 10 G-SDI signal of 4 channels was known. In the case of a 10 bit signal, 200 h was used as the default value.

On the other hand, the first mapping unit 11A according to this embodiment clears out the default value (200 h) from the 3840×2160/100P-120P/4:2:0/10 bit signal multiplexed to basic streams of 16 channels through the method described in the first embodiment. This default value is included in the basic streams of 8 channels with the format of a 4:0:0/10 bit signal. By multiplexing again the content data to Link A/B of dual link HD-SDI signals with the same data structure as 8 sets of 4:4:4 (R′G′B′ or Y′C″_{R})/10 bit, it is possible to transmit the data with mode-D of the 10 G-SDI signals of 2 channels.

Similarly, in the case of a 4:2:0/12 bit signal in the related, as shown in FIG. 19, a method of multiplexing and transmitting pixel samples to HD-SDI signals of 16 channels, multiplexing a default value to 0 of a 4:2:0 signal, and transmitting the 10 G-SDI signal of 4 channels was known. In the case of a 12 bit signal, 800 h was used as the default value.

On the other hand, the first mapping unit 11A according to this embodiment clears out the default value (800 h) from the 3840×2160/100P-120P/4:2:0/12 bit signal multiplexed to basic streams of 32 channels through the method described in the first embodiment. This default value is included in the basic streams of 16 channels with the format of a 4:0:0/12 bit signal. By multiplexing again the content data to Link A/B of dual link HD-SDI signals with the same data structure as 8 sets of 4:4:4 (R′G′B′ or Y′C′_{B}C′_{R})/12 bit, it is possible to transmit the data with mode-D of the 10 G-SDI signals of 2 channels.

FIG. 22 shows an internal constitutional example of the first mapping unit 11A.

The first mapping unit 11A includes a clock supply circuit 81 supplying clocks to the constituent units and a RAM storing 3840×2160/100P-120P video signals. The first mapping unit 11A further includes a two-pixel thinning control unit 82 controlling a two-pixel thinning (interleaving) process of reading two pixel samples, which are included in the class image in units of two continuous frames, from the RAM 83 and RAMs 84-1 to 84-8 storing the thinned two pixel samples as first to eighth sub-images.

The first mapping unit 11A includes line thinning control units 85-1 to 85-8 thinning out lines from the first to eighth sub-images stored in the RAM 84-1 to 84-8. The first mapping unit 11A further includes RAMs 86-1 to 86-16 storing the lines thinned out by the line thinning control unit 85-1 to 85-8.

The first mapping unit 11A further includes word thinning control units 87-1 to 87-16 controlling the process of thinning out words from the data read from the RAMs 86-1 to 86-16. The first mapping unit 11A further includes RAMs 88-1 to 88-32 storing the words thinned out by the word thinning control units 87-1 to 87-16.

The first mapping unit 11A further includes reading control units 89-1 to 89-32 outputting the words read from the RAMs 88-1 to 88-32 as basic streams of 32 channels.

The processing blocks generating the basic streams 1 and 2 are shown in FIG. 22, but the processing blocks generating basic streams 3 to 32 have the same constitution and thus will not be shown nor be described in detail.

An operational example of the first mapping unit 11A will be described below.

First, the clock supply circuit 81 supplies a clock to the two-pixel thinning control unit 82, the line thinning control units 85-1 to 85-8, the word thinning control units 87-1 to 87-16, and the reading control units 89-1 to 89-32. This clock is used to read or write pixel samples and the constituent units are synchronized by this clock.

Video signals defined by a UHDTV1 class image, input from an image sensor not shown, in which the number of pixels in a frame is greater than the number of pixels defined in the HD-SDI format with the maximum number of pixels of 3840×2160 are stored in the RAM 83. The UHDTV1 class image represents a video signal of 3840×2160/100P-120P/4:2:0/10 bit or 12 bit. In this example, the pixel samples thinned out every two pixels from the UHDTV1 class image are mapped on the video data areas of the first to eighth sub-images.

The two-pixel thinning control unit 82 thins out two samples every two continuous frames from the UHDTV1 class image. The two-pixel thinning control unit 82 maps the thinned pixels on the video data areas of the first to eighth sub-images in which m′×n′ is set to 1920×1080 and a′-b′ is set to 50P, 59.94P, and 60P. The 1920×1080/50P-60P is defined in the SMPTE 274. Here, the two-pixel thinning control unit 82 maps the pixel samples in the 0-th line of a first class image on the video data areas of the first and second sub-images and maps the pixel samples in the first line of the first class image on the video data areas of the third and fourth sub-images. The two-pixel thinning control unit 82 maps the pixel samples in the second line of the first class image on the video data areas of the fifth and sixth sub-images and maps the pixel samples in the third line of the first class image on the video data areas of the seventh and eighth sub-images. The two-pixel thinning control unit 82 maps the pixel samples in the 0-th line of a second class image on the video data areas of the first and second sub-images and maps the pixel samples in the first line of the second class image on the video data areas of the third and fourth sub-images. The two-pixel thinning control unit 82 maps the pixel samples in the second line of the second class image on the video data areas of the fifth and sixth sub-images and maps the pixel samples in the third line of the second class image on the video data areas of the seventh and eighth sub-images.

The line thinning control units 85-1 to 85-8 convert the progressive signals into interlaced signals. Specifically, the line thinning control units 85-1 to 85-8 read the pixel samples mapped on the video data areas of the first to eighth sub-images from the RAMs 84-1 to 84-8. At this time, the line thinning control units 85-1 to 85-8 convert a single sub-image into the 1920×1080/50I-60I/4:2:0/10 bit or 12 bit signal of 2 channels. Then, the line thinning control units 85-1 to 85-8 write the 1920×1080/50I-60I signals, which are thinned from the video data areas of the first to eighth sub-images for each line and converted into the interlaced signals, to the RAMs 84-1 to 84-8.

The word thinning control units 87-1 to 87-16 thin out the pixel samples, which have been thinned out for each line, for each word. The word thinning control units 87-1 to 87-16 map the thinned pixel samples on the video data areas of the HD-SDI defined in the SMPTE 435-1. At this time, the word thinning control units 87-1 to 87-16 multiplex the pixel samples on the video data areas of the 10.692 Gbps streams which are defined in the SMPTE 435-1 and which are determined by mode-D of four channels corresponding to the first to eighth sub-images. That is, the word thinning control units 87-1 to 87-16 convert the 1920×1080/50I-60I/4:2:0/10 bit or 12 bit signal into 32 basic streams. Then, the resultant signals are mapped on the video data areas of every four HD-SDI signals defined in the SMPTE 435-1 for each of the first to eighth sub-images.

Specifically, the word thinning control units 87-1 to 87-16 thin out and read the pixel samples for each word from the RAMs 84-1 to 84-8 in the same way as shown in FIGS. 4, 6, 7, 8, and 9 of the SMPTE 372. Then, the word thinning control units 87-1 to 87-16 convert the read pixel samples into the 1920×1080/50I-60I signals of 2 channels and write the resultant signals to the RAMs 88-1 to 88-32.

The reading control units 89-1 to 89-32 output transmission streams of the basic streams of 32 channels read from the RAMs 88-1 to 88-32.

Specifically, the reading control units 89-1 to 89-32 read the pixel samples from the RAMs 88-1 to 88-32 in response to a reference clock supplied from the clock supply circuit 81. Then, the reading control units output basic streams 1 to 32 of 32 channels including 16 pairs of two Link A and Link B to the subsequent second mapping unit 11B.

In this example, in order to perform the two-pixel thinning, the line thinning, and the word thinning, three steps thinning processes are performed using three types of memories (the RAMs 84-1 to 84-8, the RAMs 86-1 to 86-16, and the RAMs 88-1 to 88-32). However, data acquired through the two-pixel thinning, the line thinning, and the word thinning may be stored in a single memory and may be output as the HD-SDI signals of 32 channels.

A detailed process example where the first mapping unit 11A maps the pixel samples will be described below.

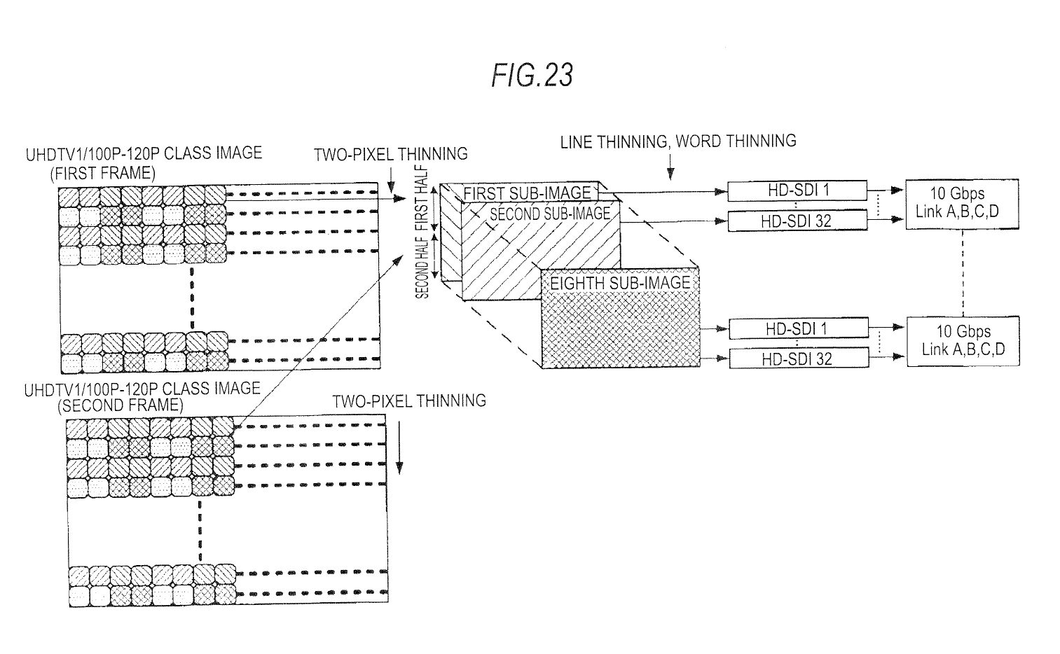

FIG. 23 is a diagram illustrating an example where the first mapping unit 11A maps the pixel samples included in first and second frames continuous in a UHDTV1 class image on the first to eighth sub-images and maps the pixel samples on the basic streams of 32 channels.

The two-pixel thinning control unit 21 divides a frame (a screen) into 8 parts. Accordingly, the two-pixel thinning control unit maps 3840×2160/100P-120P/4:2:0/10 bit or 12 bit signal on 1920×1080/50P-60P/4:2:0/10 bit or 12 bit signal of 8 channels.

At this time, the first mapping unit 11A thins out the pixel samples in the line direction from the UHDTV1 class image of a first frame in which a frame (a screen) is 3840×2160/100P-120P/4:2:0/10 bit or 12 bit signal. Then, the first mapping unit 11A maps the signals thinned out every two pixels on a first half part (effective area, the first to 540-th lines) of the 1920×1080/50P-60P/4:2:0/10 bit or 12 bit signal of 8 channels.

Thereafter, the first mapping unit 11A thins out the pixel samples in the line direction from the UHDTV1 class image of a second frame. Then, the first mapping unit 11A maps the signals thinned out every two pixels on a second half part (effective area, the 541-th to 1080-th lines) of the 1920×1080/50P-60P/4:2:0/10 bit or 12 bit signal of 8 channels. The first mapping unit 11A creates the first to eighth sub-images which are mapped on 1920 samples as the video data area in the HD image format. In the following description, the UHDTV1 class image of the first frame is referred to as a “first class image” and the UHDTV1 class image of the second frame is referred to as a “second class image”.

By causing the line thinning control units 85-1 to 85-8 to thin out the lines and causing the word thinning control units 87-1 to 87-16 to thin out words, the 1920×1080/23.98P-30P/4:2:2/10 bit signals of 32 channels are generated. The reading control units 89-1 to 89-32 read basic streams 1 to 32 and output the read basic streams to the second mapping unit 11B.

Basic streams CH1 to CH32 output from the first mapping unit 11A are input to second mapping units 11B-1 and 11B-2 by two sets of 16 channels. Since the second mapping units 11B-1 and 11B-2 have the same constitution as the second mapping unit 11B described above and perform the same operation, detailed description thereof will not be made. The second mapping unit 11B can transmit the basic streams input through the method shown in FIG. 4 according to the first embodiment by 8 channels as the HD-SDI signals of 8 channels in total.

The detailed process example where the processing blocks of the first mapping unit 11A map the pixel samples will be described below.

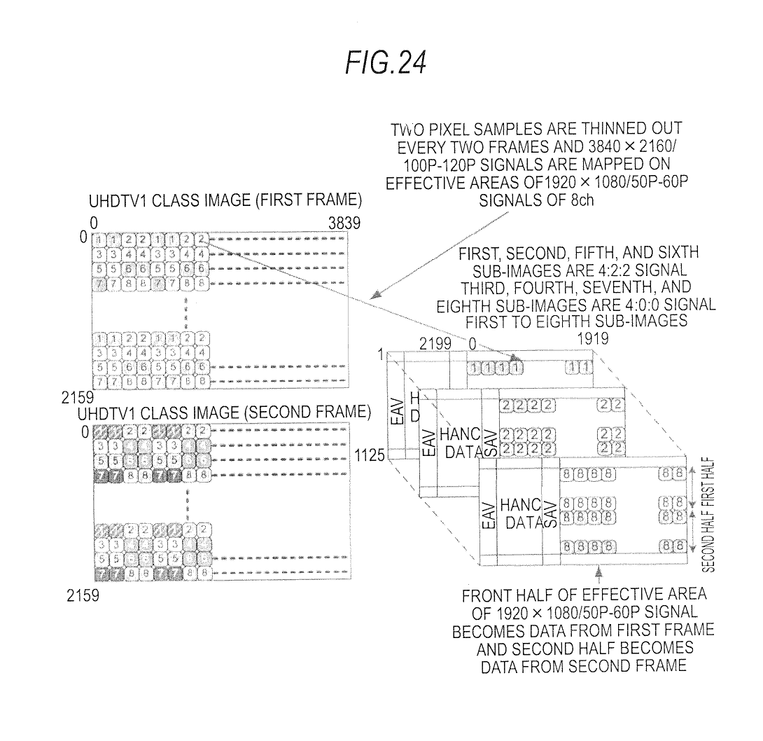

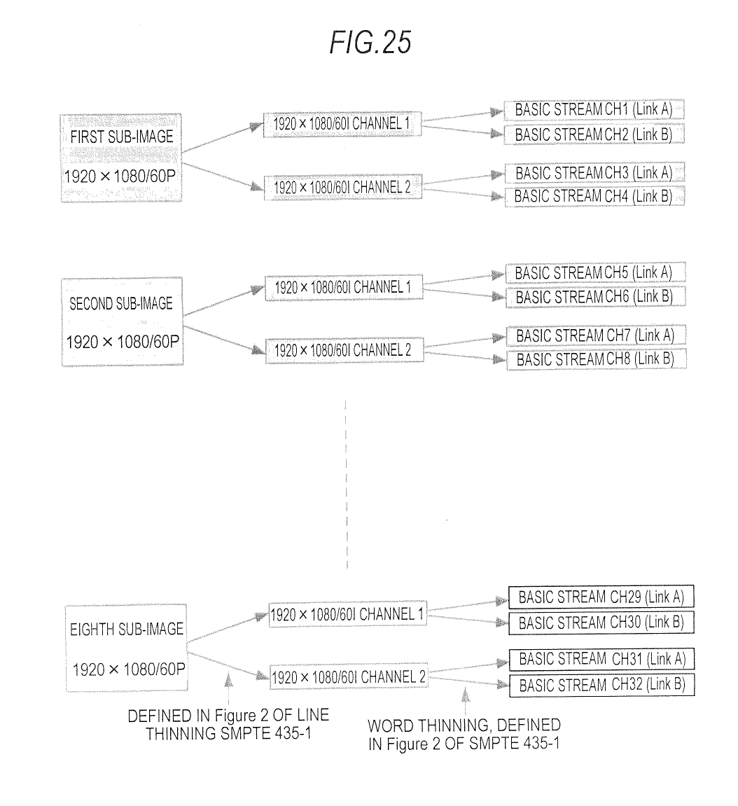

FIG. 24 shows an example where the two-pixel thinning control unit 82 thins out the pixel samples from the first and second class images by two pixels and maps the thinned pixel samples on the first to eighth sub-images.

The first mapping unit 11A maps the pixel samples of the 3840×2160/100P-120P/4:2:0/10 bit or 12 bit signal defined as the UHDTV1 class image on the first to eighth sub-images. At this time, the first mapping unit 11A thins out two pixel samples adjacent to each other in the same line of the UHDTV1 class image and maps the thinned two pixel samples on the first to eighth sub-images. This mapping process is performed under the control of the two-pixel thinning control unit 82 of the first mapping unit 11A.

The two-pixel thinning control unit 82 thins out two pixel samples in the line direction in units of two frames from the 3840×2160/100P-120P/4:2:0/10 bit or 12 bit signal and multiplexes the thinned pixel samples to the video data areas of the first to eight sub-images. The first to eighth sub-images are defined by the 1920×1080/50P-60P/4:2:0/10 bit or 12 bit signal of 8 channels. The 3840×2160/100P-120P/4:2:0/10 bit or 12 bit signal are signals with a frame rate which doubles the frame rate of the 3840×2160/50P-60P/4:2:0/10 bit or 12 bit signal defined in the S2036-1. The 1920×1080/50P-60P is defined in the SMPTE 274M. The digital signal formats such as a forbidden code of the 3840×2160/100P-120P/4:2:0/10 bit or 12 bit signal are the same as the 3840×2160/50P-60P.

Here, the UHDTV1 class image whose number of pixels in a frame is greater than the number of pixels defined in the HD-SDI format is defined as follows. That is, it is defined as an m×n (where m and n representing m samples and n lines are positive integers)/a—b (where a and b represent a frame rate of a progressive signal)/r:g:b (where r, g, and b represent the signal ratio in the case of a predetermined signal transmission system)/10 bit or 12 bit signal. In this example, m×n in the UHDTV1 class image is set to 3840×2160, a-b is set to 100P-120P, and r:g:b is set to 4:2:0. In the UHDTV1 class image, the pixel samples are stored in from the 0-th line to the 2159-th line.

In the UHDTV1 class image, lines are determined by the 0-th line, the first line, the second line, and the third line which are continuous. The two-pixel thinning control unit 82 thins out two pixel samples adjacent to each other in the same line for each of four continuous lines in the first and second UHDTV1 class image which are continuous. The two-pixel thinning control unit 82 maps the thinned pixel samples on the first to eighth sub-images defined by m′×n′/a′−b′/r′:g′:b′/10 bit or 12 bit signal. Here, m′ and n′ represent m′ samples and n′ lines are positive integers, a′ and b′ represent a frame rate of a progressive signal, and r′, g′, and b′ represent a signal ratio in the case of a predetermined signal transmission system.

In this case, the two-pixel thinning control unit 21 maps the thinned pixels on the video data areas of the first to eighth sub-images in which m′×n′ is set to 1920×1080 and a′-b′ is set to 50P-60P. Here, the two-pixel thinning control unit 82 maps the pixel samples in the 0-th line of a first class image on the video data areas of the first and second sub-images and maps the pixel samples in the first line of the first class image on the video data areas of the third and fourth sub-images. The two-pixel thinning control unit 82 maps the pixel samples in the second line of the first class image on the video data areas of the fifth and sixth sub-images and maps the pixel samples in the third line of the first class image on the video data areas of the seventh and eighth sub-images. The two-pixel thinning control unit 82 maps the pixel samples in the 0-th line of a second class image on the video data areas of the first and second sub-images and maps the pixel samples in the first line of the second class image on the video data areas of the third and fourth sub-images. The two-pixel thinning control unit 82 maps the pixel samples in the second line of the second class image on the video data areas of the fifth and sixth sub-images and maps the pixel samples in the third line of the second class image on the video data areas of the seventh and eighth sub-images.

Specifically, the pixel samples extracted from the lines of the first class image are defined as follows. “s” in the “s-th sample” means that pixel samples defined as the s-th sample are mapped on the s-th sub-image out of the first to eighth sub-images.

(1) the 0-th line: first sample, first sample, second sample, second sample, first sample, first sample, second sample, second sample, . . . .

(2) the first line: third sample, third sample, fourth sample, fourth sample, third sample, third sample, fourth sample, fourth sample, . . . .

(3) the second line: fifth sample, fifth sample, sixth sample, sixth sample, fifth sample, fifth sample, sixth sample, sixth sample, . . . .

(4) the third line: seventh sample, seventh sample, eighth sample, eighth sample, seventh sample, seventh sample, eighth sample, eighth sample, . . . .

(5) the fourth line: first sample, first sample, second sample, second sample, first sample, first sample, second sample, second sample, . . . .

(6) the fifth line: third sample, third sample, fourth sample, fourth sample, third sample, third sample, fourth sample, fourth sample, . . . .

(7) the sixth line: fifth sample, fifth sample, sixth sample, sixth sample, fifth sample, fifth sample, sixth sample, sixth sample, . . . .

(8) the seventh line: seventh sample, seventh sample, eighth sample, eighth sample, seventh sample, seventh sample, eighth sample, eighth sample, . . . .

In this way, when the process of thinning out and mapping the pixels included in the first class image is ended, a process of thinning out and mapping the pixels included in the second class image is then started. At this time, similarly to the first class image, two pixel samples adjacent to each other in the 0-th line of the second class image are mapped on the second-half lines in the video data areas of the first and second sub-images. Similarly, two pixel samples adjacent to each other in the first to seventh lines of the second class image are mapped on the second-half lines in the video data areas of the third and fourth sub-images, the fifth and sixth sub-images, and the seventh and eighth sub-images. At this time, the pixel samples are mapped on the 1920×1080/50P-60P/4:2:2 or 4:0:0/10 bit or 12 bit signal of 8 channels defined in the SMPTE 274.

The number of pixel samples thinned out by two pixels and mapped on the first to eighth sub-images is 3840+2=1920 samples. The number of lines after two pixels are thinned out every two continuous frames is 2×2160+4=1080 lines. Accordingly, the number of pixel samples and the number of lines thinned out and multiplexed from the first and second class images are equal to those in the video data areas of 1920×1080.

In the method of thinning two pixel samples every two frames, the first, second, fifth, and sixth sub-images out of the first to eighth sub-images on which the pixel samples are mapped are 4:2:2 signals and the third, fourth, seventh, and eighth sub-images are 4:0:0 signals. The default value (200 h in the case of the 10-bit signal and 800 h in the case of the 12-bit signal) are multiplexed to the signal component of “0” in the respective sub-images. The first mapping unit 11A treats the 4:2:0 signals and the 4:2:2 signals to be equivalent by mapping 200 h (the 10-bit system) and 800 h (the 12-bit system) as the default value of the Cch on “0” of the 4:2:0 signals. The first to eighth sub-images are stored in the RAMS 84-1 to 84-8, respectively.

FIG. 25 shows a process example of dividing the first to eighth sub-images into Link A and Link B in accordance with the definition of the SMPTE 372M by first performing the line thinning process and then performing the word thinning process.

As described above, the line thinning control units 85-1 to 85-8 thin out the pixel samples at the intervals of I line of the first to eighth sub-images on which the pixel samples are mapped and convert the thinned pixel samples into the interlaced signals.

The SMPTE 435 is a standard of a 10 G interface. This standard defines that the HD-SDI signals of plural channels are 8 B/10 B-encoded by two pixels (40 bits), are converted into 50 bits, and are multiplexed for each channel. This standard defines that the video signals are serially transmitted at a bit rate of 10.692 Gbps or 10.692 Gbps/1.001 (hereinafter, simply referred to as 10.692 Gbps). The technique of mapping the 4 k×2 k signals on the HD-SDI signals is described in FIG. 3 and FIG. 4 of 6.4 Octa Lnk 1.5 Gbps Class of the SMPTE 435 Part 1.

The lines are thinned out from the first to eighth sub-images set to the 1920×1080/50P-60P/4:2:0/10 bit or 12 bit signal of 8 channels on which the pixel samples are mapped through the use of the method defined in FIG. 2 of the SMPTE 435-1. In this example, the line thinning control units 85-1 to 85-8 thin out the 1920×1080/50P-60P signals forming the first to eighth sub-images for each line and generates the interlaced signals (1920×1080/50I-60I signals) of 2 channels. The 1920×1080/50I-60I/4:2:0/10 bit or 12 bit signal are signals defined in the SMPTE 274M.

Thereafter, when the line-thinned signal is the 10-bit or 12-bit signal of 4:4:4 or the 12-bit signal of 4:2:2, the word thinning control units 87-1 to 87-16 perform the word thinning process again and outputs the basic streams to the second mapping unit 11B. In the related art, when the line-thinned signal is the 4:4:4 signal or the 4:2:2/12 bit signal, the word thinning process is performed again and the resultant signals are transmitted with the 1.5 Gb/s HD-SDI signals of 4 channels. Therefore, the 3840×2160/100P-120P/4:4:4, 4:2:2, 4:2:0/10 bit or 12 bit signal are transmitted with the HD-SDI signals of 32 channels in total as shown in FIG. 25. Here, in the case of the 4:2:2 or 4:2:0/10 bit signal, the signals are transmitted with the HD-SDI signals of 16 channels.

In this way, the 3840×2160/100P-120P/4:2:0/10 bit or 12 bit signal mapped on the HD-SDI signals of 32 channels are multiplexed to the 10 G-SDI mode-D of 4 channels and are then transmitted. (In the case of 4:2:2 or 4:2:0, Link B is not used but CH1, CH3, CH5, and CH7 are used.)

On the other hand, the second mapping unit 11B according to this embodiment displaces data of the basic streams. Accordingly, the HD-SDI signals in the 4:2:2/10 bit signal format and the HD-SDI signals of 8 channels in the 4:0:0/10 bit signal D format can be transmitted as the 10 Gbps HD-SDI mode-D signals of 2 channels. Similarly, the HD-SDI signals in the 4:2:2/12 bit signal format and the HD-SDI signals of channels in the 4:0:0/12 bit signal D format can be transmitted as the 10 G-SDI mode-D signals of 2 channels.

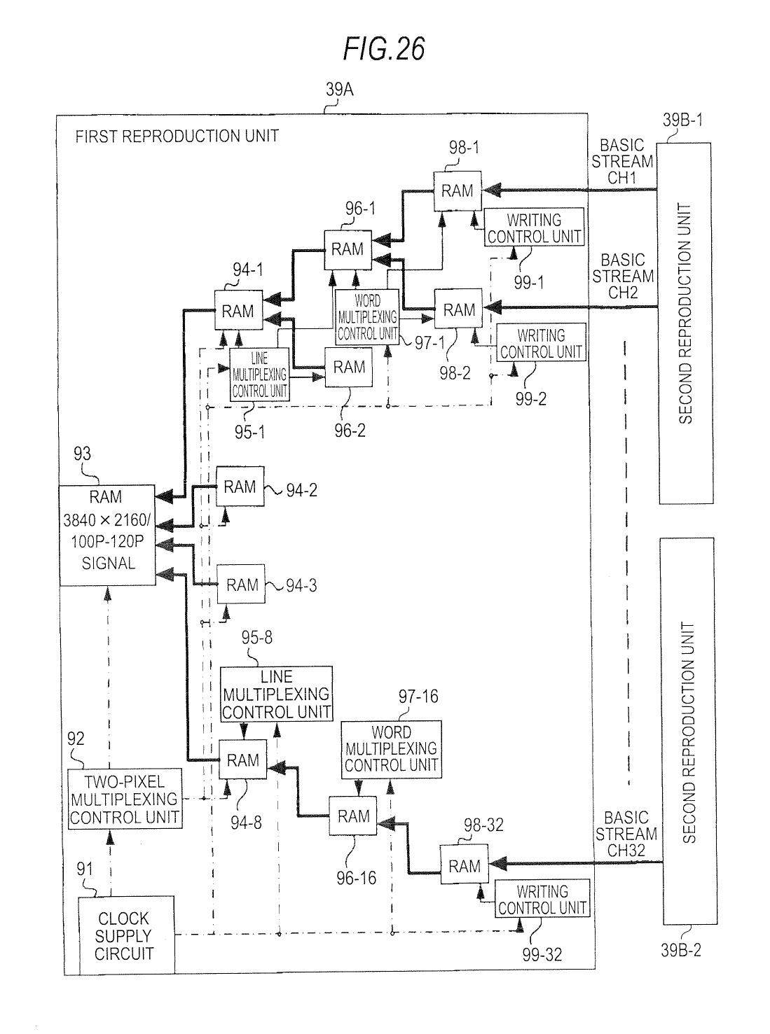

FIG. 26 shows an internal constitution example of the first reproduction unit 39A.

The first reproduction unit 39A is a block inversely performing the processes performed on the pixel samples by the first mapping unit 11A.

When the HD-SDI signals of 32 channels in total are input, two sets of second reproduction units 39B-1 and 39B-2 convert the input HD-SDI signals into basic streams CH1 to CH32 through the use of the method shown in FIG. 19 according to the first embodiment and outputs the resultant basic streams to the first reproduction unit 39A.

The first reproduction unit 39A includes a clock supply circuit 91 supplying a clock to the constituent units. The clock supply circuit 91 supplies a clock to a two-pixel multiplexing control unit 92, a line multiplexing control units 95-1 to 95-8, word multiplexing control units 97-1 to 97-16, and writing control units 99-1 to 99-32. The constituent units are synchronized with the clock and the reading or writing of pixel samples is controlled.

The first reproduction unit 39A includes RAMs 98-1 to 98-32 storing 32 basic streams 1 to 32 defined in the SMPTE 435-2. As described above, basic streams 1 to 32 constitute the 1920×1080/50I-60I signals. CH1, CH3, CH5, CH7, . . . , and CH31 as Link A and CH2, CH4, CH6, CH8, . . . , and CH32 as Link B, which are input from the descrambling 8 B/10 B and P/S conversion unit 38 are used as basic streams 1 to 32.

The writing control units 99-1 to 99-32 perform a writing control of storing the input basic streams 1 to 32 of 32 channels in the RAMs 98-1 to 98-32 in synchronization with the clock supplied from the clock supply circuit 91.

The first reproduction unit 39A further includes word multiplexing control units 97-1 to 97-16 controlling the word multiplexing (deinterleaving) process and RAMs 96-1 to 96-16 storing data multiplexed by the word multiplexing control units 97-1 to 97-16. The first reproduction unit 39A further includes line multiplexing control units 95-1 to 95-8 controlling the line multiplexing process and RAMs 94-1 to 94-8 storing data multiplexed by the line multiplexing control units 95-1 to 95-8.

The word multiplexing control units 97-1 to 97-16 multiplex the pixel samples extracted from the video data area of a 10.692 Gbps stream, which is defined in the SMPTE 435-2 and which is determined by mode-D of four channels to correspond to the first to eighth sub-images, for each word. At this time, the word multiplexing control units 97-1 to 97-16 multiplex the pixel samples extracted from the video data areas of the basic streams read from the RAMs 98-1 to 98-32 for each line into which words are inversely converted. This multiplexing process is performed in accordance with FIG. 9 of the SMPTE 372. Specifically, the word multiplexing control units 97-1 to 97-16 control the timing of each pair of (RAMs 98-1 and 98-2), (RAMs 98-3 and 98-4), . . . , and (RAMs 98-31 and 98-32) to multiplex the pixel samples. The word multiplexing control units 97-1 to 97-16 store the generated 1920×1080/50I-60I/4:2:0/10 bit or 12 bit signal in the RAMs 96-1 to 96-16.

The line multiplexing control units 95-1 to 95-8 multiplex the pixel samples, which are read from the RAMs 96-1 to 96-16 and word-multiplexed for each line, for each sub-image and convert the multiplexed signals into progressive signals. The line multiplexing control units 95-1 to 95-8 generate the 1920×1080/50P-60P/4:2:0/10 bit or 12 bit signal and store the generated signals in the RAMs 94-1 to 94-8. That is, the signals stored in the RAMs 94-1 to 94-8 constitute the first to eighth sub-images.

The two-pixel multiplexing control unit 92 maps the pixel samples extracted from the video data areas of the first to eighth sub-images on the UDHTV1 class image. In the first to eighth sub-images, m′×n′ is set to 1920×1080 and a′-b′ is set to 50P-60P. At this time, the two-pixel multiplexing control unit 92 multiplexes the pixel samples read from the RAMs 94-1 to 94-8 every two pixels through the following process. The two-pixel multiplexing control unit 92 multiplexes the pixel samples extracted by two pixels from the first-half parts of the first sub-image and the second sub-image in parallel with the UHDTV1 class image. The class image is a 3840×2160/100P-120P/4:2:0/10 bit or 12 bit signal.

The two-pixel multiplexing control unit 92 determines lines by the 0-th line, the first line, the second line, and the third line which are continuous in the UHDTV1 class image, and performs the following process on the first and second class images continuous to each other to multiplex the pixel samples. That is, the two-pixel multiplexing control unit 92 multiplexes the pixel samples extracted from the video data areas of the first and second sub-images so as to be adjacent to each other in the 0-th line of the first class image. The two-pixel multiplexing control unit 92 multiplexes the pixel samples extracted from the video data areas of the third and fourth sub-images so as to be adjacent to each other in the first line of the first class image. The two-pixel multiplexing control unit 92 multiplexes the pixel samples extracted from the video data areas of the fifth and sixth sub-images so as to be adjacent to each other in the second line of the first class image. The two-pixel multiplexing control unit 92 multiplexes the pixel samples extracted from the video data areas of the seventh and eighth sub-images so as to be adjacent to each other in the third line of the first class image. In the RAM 93, the 3840×2160/100P-120P signals are stored in the first frame defined by the UHDTV1 class image and the signals are appropriately reproduced.

The two-pixel multiplexing control unit 92 multiplexes the pixel samples extracted from the video data areas of the first and second sub-images so as to be adjacent to each other in the 0-th line of the second class image. The two-pixel multiplexing control unit 92 multiplexes the pixel samples extracted from the video data areas of the third and fourth sub-images so as to be adjacent to each other in the first line of the second class image. The two-pixel multiplexing control unit 92 multiplexes the pixel samples extracted from the video data areas of the fifth and sixth sub-images so as to be adjacent to each other in the second line of the second class image. The two-pixel multiplexing control unit 92 multiplexes the pixel samples extracted from the video data areas of the seventh and eighth sub-images so as to be adjacent to each other in the third line of the second class image. In the RAM 93, the 3840×2160/100P-120P signals are stored in the second frame defined by the UHDTV1 class image and the signals are appropriately reproduced.

FIG. 26 shows an example where the two-pixel multiplexing process, the line multiplexing process, and the word multiplexing process are performed in three steps using three types of RAMs. However, the 3840×2160/100P-120P/4:2:0/10 biz or 12 bit signal may be reproduced using a single RAM.

The first mapping unit 11A of the broadcasting camera according to the second embodiment maps the 3840×2160/100P-120P signals with a large number of pixels defined in the UHDTV1 class image on the first to eighth sub-images. This mapping process is performed by thinning out two pixel samples every two frames continuous in the UDHTV1 class image. Thereafter, the line thinning and the word thinning are performed and the basic streams are output. The second mapping units 11B-1 and 11B-2 displace the data of the basic streams and transmit the data with the HD-SDI mode-D. Since this thinning process is a method utilizing the memory capacity to the minimum for mapping the signals and the memory capacity is minimized, it is possible to suppress the transmission delay of signals as much as possible.

On the other hand, the second reproduction units 39B-1 and 39B-2 of the CCU 2 displaces data of the received HD-SDI mode-D signals and outputs the basic streams of 32 channels. The first reproduction unit 39A receives the basic streams of 32 channels, performs the word multiplexing process and the line multiplexing process, and multiplexes the pixel samples to the first to eighth sub-images. Thereafter, two pixel samples extracted from the first to eight sub-images are multiplexed to the 3840×2160 signals with a large number of pixels defined by the UHDTV1 class image. In this way, it is possible to transmit and receive the pixel samples defined by the UHDTV1 class image using the HD-SDI format used in the related art.

### 3. Third Embodiment

### Example of UHDTV2 7680×4320/50P, 59.94P, 60P/4:2:0/10 Bit or 12 Bit

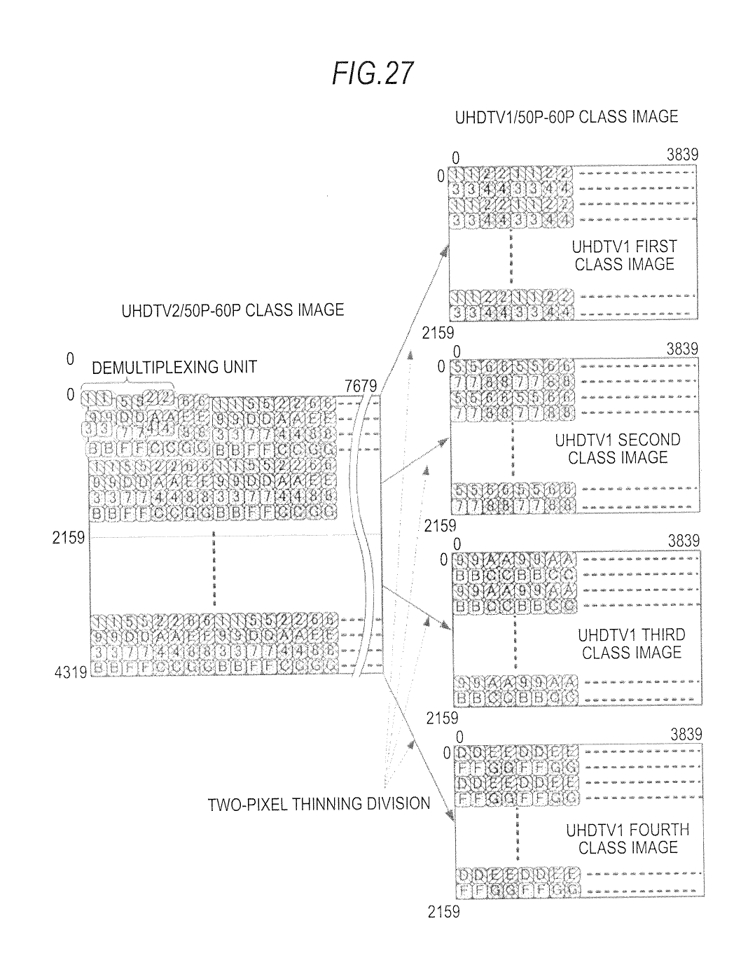

An operational example of a first mapping unit 11A and a first reproduction unit 39A according to a third embodiment of the present disclosure will be described below with reference to FIGS. 27 to 29.

A method of thinning out the pixel samples of the 7680×4320/50P-60P/4:2:0/10 bit or 12 bit signal will be described below.

FIG. 27 shows a processing image in which the first mapping unit 11A maps the pixel samples included in the UHDTV2 class image on the UHDTV1 class image.

In this example, the 7680×4320/50P-60P/4:2:0/10 bit or 12 bit signal defined as the UHDTV2 class image are input to the first mapping unit 11A. The 7680×4320/50P-60P/4:2:0/10 bit or 12 bit signal are defined in the S2036-1.

The first mapping unit 11A maps the 7680×4320/50P-60P/4:2:0/10 bit or 12 bit signal on the class image defined as UHDTV1. This class image is the 3840×2160/50P-60P/4:2:0/10 bit or 12 bit signal.

The first mapping unit 11A maps the pixel samples from the UDHTV2 class image to the UHDTV1 class image every two samples in units of two lines, as defined in the S2036-3. That is, two lines are thinned out every two pixels in the line direction from the 7680×4320/50P-60P/4:2:0/10 bit or 12 bit signal. The resultant signals are mapped on the 3840×2160/50P-60P/4:2:0/10 bit or 12 bit signal of 4 channels.

In the mapping method in the related art, the default values are allocated to the signal component of “0” in the 4:2:0/10 bit signal out of the 3840×2160/50P-60P/4:4:4, 4:2:2, 4:2:0/10 bit or 12 bit signal of 4 channels. 200 h can be allocated in the case of the 10-bit signal and 800 h can be allocated in the case of the 12-bit signal. Accordingly, the signals are mapped on the HD-SDI signals of 8 channels and then output, and are transmitted with the 10 G mode-D of 2 channels by inputting them to the odd-number channels of the 10 G-SDI. In the case of the 4:2:0/12 bit signal, since the default values are allocated to the signal component of “0” and thus the signals are mapped on the HD-SDI signals of 16 channels and then output, the signals can be transmitted with the 10 G mode-D of 2 channels. Accordingly, the 7680×4320/50P-60P/4:2:0/10 bit or 12 bit signal can be transmitted with the 10 G mode-D of 8 channels in total.

On the other hand, the 4:2:0 signals of the first to fourth UHDTV1 class images after the pixel samples are thinned out through the two-pixel thinning method according to the third embodiment are the 4:2:2 signals of the first and second class images of UHDTV1 shown in FIG. 13. The third and fourth class images of UHDTV1 are the 4:0:0 signals, and the default values (200 h in the case of 10 bits and 800 h in the case of 12 bits) are multiplexed to the signal component of “0”.

In the case of the 7680×4320/50P-60P/4:2:0/10 bit signal, the first to fourth UHDTV1 class images mapped through the two-pixel thinning method are multiplexed to the HD-SDI signals of 8 channels through the use of the method described in the second embodiment. The HD-SDI signals of 8 channels to which the first UHDTV1 class image having the 4:2:2 signal format and the third UHDTV1 class image having the 4:0:0 signal format are multiplexed are converted through the use of the method described with reference to FIGS. 11 and 12 in the first embodiment. Accordingly, since 8 sets of dual link HD-SDI Link A/B having the same data structure as the 4:4:4 (R′G′B′ or Y′C′_{B}C′_{R})/10 bit are obtained, it is possible to transmit the signals using the 10 G-SDI mode-D of 2 channels. Similarly, the HD-SDI signals of 8 channels to which the second UHDTV1 class image having the 4:2:2 signal format and the fourth UHDTV1 class image having the 4:0:0 signal format are multiplexed are converted. At this time, 8 sets of dual link HD-SDI Link A/B having the same data structure as the 4:4:4 (R′G′B′ or Y′C′_{b}C′ᵣ)/10 bit are obtained using the method described in FIGS. 15 and 16 in the first embodiment. Accordingly, since the signals can be transmitted using the 10 G-SDI mode-D of 2 channels, the signals can be transmitted using the 10 G-SDI mode-D signals of 4 channels in total, thereby reducing the transmission rate to a half in comparison with the method in the related art.

In the case of the 7680×4320/50P-60P/4:2:0/12 bit signal, the first to fourth UHDTV1 class images mapped through the two-pixel thinning method are multiplexed to the HD-SDI signals of 16 channels through the use of the method described in the second embodiment. The HD-SDI signals of 16 channels to which the first UHDTV1 class image having the 4:2:2 signal format and the third UHDTV1 class image having the 4:0:0 signal format are multiplexed are converted through the use of the method described with reference to FIGS. 15 and 16 in the first embodiment. Accordingly, since 8 sets of dual link HD-SDI Link A/B having the same data structure as the 4:4:4 (R′G′B′ or Y′C′_{B}C′_{R})/12 bit are obtained, it is possible to transmit the signals using the 10 G-SDI mode-D of 2 channels. Similarly, the HD-SDI signals of 8 channels to which the second UHDTV1 class image having the 4:2:2 signal format and the fourth UHDTV1 class image having the 4:0:0 signal format are multiplexed are converted. At this time, 8 sets of dual link HD-SDI Link A/B having the same data structure as the 4:4:4 (R′G′B′ or Y′C′_{b}C′ᵣ)/12 bit are obtained using the method described in FIGS. 15 and 16 in the first embodiment. Accordingly, since the signals can be transmitted using the 10 G-SDI mode-D of 2 channels, the signals can be transmitted using the 10 G-SDI mode-D signals of 4 channels in total, thereby reducing the transmission rate to a half in comparison with the method in the related art.

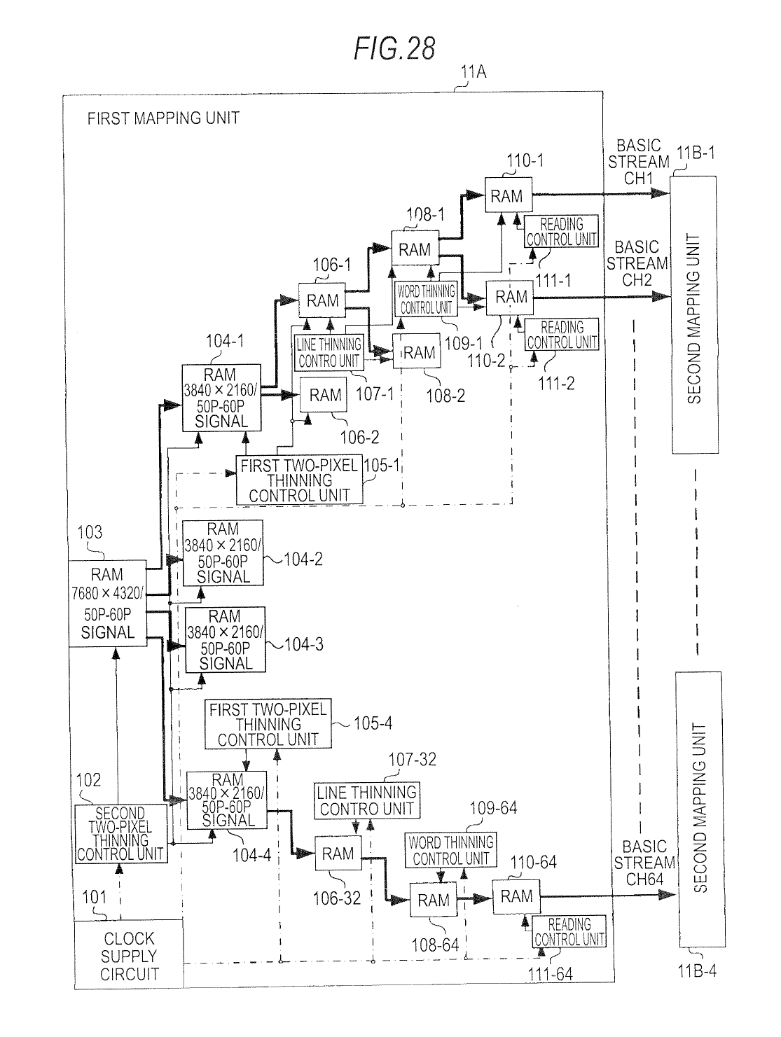

FIG. 28 shows an internal constitutional example of the first mapping unit 11A.

The first mapping unit 11A includes a clock supply circuit 61 supplying a clock to the constituent units and a RAM 103 storing video signals of 7680×4320/50P-60P. The first mapping unit 11A further includes a second two-pixel thinning control unit 102 controlling the two-pixel thinning (interleaving) process of reading the pixel samples by two pixels from the video signals of 7680×4320/50P-60P stored in the RAM 103. The pixel samples thinned out by two pixels are stored in the RAMs 104-1 to 104-4 as the first to fourth class images which are the 3840×2160/50P-60P/4:2:0/10 bit or 12 bit signal defined by UHDTV1.

The first mapping unit 11A further includes a first two-pixel thinning control units 105-1 to 105-4 controlling the two-pixel thinning process of reading the pixel samples by two pixels from the first to fourth class images read from the RAMs 104-1 to 104-4 every two continuous frames. The operation of the first two-pixel thinning control units 105-1 to 105-4 of mapping the pixel samples on the sub-images are the same as the operation of the two-pixel thinning control unit 122 according to the second embodiment. The pixel samples thinned out by two pixels are stored in the RAMs 106-1 to 106-32 as the first to eighth sub-images for each of the first to fourth class images.

The first mapping unit 11A includes the line thinning control units 107-1 to 107-32 thinning out lines from the data read from the RAMs 106-1 to 106-32. The first mapping unit 11A further includes RAMs 108-1 to 108-64 storing the data thinned out by the line thinning control units 107-1 to 107-32.

The first mapping unit 11A further includes word thinning control units 109-1 to 109-64 controlling the word thinning process on the data read from the RAMs 108-1 to 108-64. The first mapping unit 11A further includes RAMs 110-1 to 110-64 storing the data thinned out by the word thinning control units 109-1 to 109-64. The first mapping unit 11A further includes reading control units 111-1 to 111-64 outputting the pixel samples of the data read from the RAMs 110-1 to 110-64 as the basic streams of 64 channels.

The processing blocks generating basic stream CH1 are shown in FIG. 28, but the processing blocks generating basic streams CH2 to CH64 have the same constitution and thus will not be shown nor be described in detail.

An operational example of the first mapping unit 11A will be described below.

The clock supply circuit 61 supplies a clock to the second two-pixel thinning control unit 102, the first two-pixel thinning control units 105-1 to 105-4, the line thinning control units 107-1 to 107-32, the word thinning control units 109-1 to 109-64, and the reading control units 111-1 to 111-64. This clock is used to read or write pixel samples and the constituent units are synchronized by this clock.

The UDHTV2 class image defined by the 7680×4320/50P-60P/4:2:0/10 bit or 12 bit signal of UHDTV2 and input from an image sensor not shown is stored in the RAM 103. The second two-pixel thinning control unit 102 thins out two pixels adjacent to each other in the same line from the UHDTV2 class image of 7680×4320/50P, 59.94P, 60P/4:2:0/10 bit or 12 bit and then maps the pixel samples on the first to fourth UHDTV1 class images in which m×n is 3840×2160 and a-b is set to 50P, 59.94P, and 60P.

Specifically, the second two-pixel thinning control unit 102 maps the pixel samples thinned out by two pixels adjacent to each other in the same line for each line of four continuous lines on the first to fourth UHDTV1 class images. At this time, the second two-pixel thinning control unit 102 maps the pixel samples included at intervals of 1 line in the 0-th line of the UHDTV2 class image on the same line in the video data area of the first UHDTV1 class image at intervals of two pixel samples for each line. Pixel samples different from the pixel samples mapped on the first UHDTV1 class image are mapped as the pixel samples included at intervals of 1 line in the 0-th line of the UHDTV2 class image. At this time, the pixel samples are mapped on the same line in the video data area of the second UHDTV1 class image at intervals of two pixel samples. The second two-pixel thinning control unit 102 maps the pixel samples included at intervals of I line in the first line of the UHDTV2 class image on the same line in the video data area of the third UHDTV1 class image at intervals of two pixel samples for each line. The second two-pixel thinning control unit 102 maps the pixel samples included at intervals of I line in the first line of the UHDTV2 class image. Pixel samples different from the pixel samples mapped on the third UHDTV1 class image are mapped on the same line in the video data area of the fourth UHDTV1 class image at intervals of two pixel samples. This mapping process is repeatedly performed until all the pixel samples of the UHDTV2 class image are extracted.

The process of causing the first two-pixel thinning control units 105-1 to 105-4 to map the pixel samples on the first to eighth sub-image and the processes of line thinning and word thinning are performed in the same way as the pixel sample thinning process according to the second embodiment, and thus the detailed description thereof will not be made.

Basic streams CH1 to CH64 output from the first mapping unit 11A are input to the second mapping unit 11B in 8 sets of 16 channels. The second mapping unit 11B can transmit 64 HD-SDI channels in total by 8 channels in the method shown in FIG. 4 in the first embodiment in parallel.

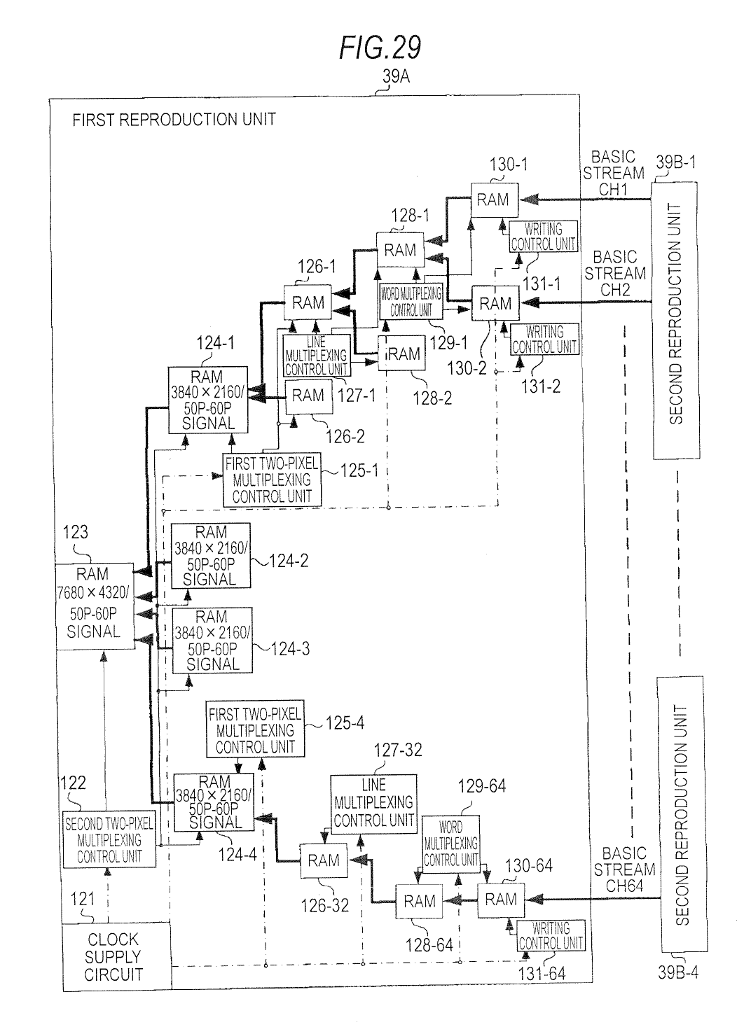

FIG. 29 shows an internal constitution example of the first reproduction unit 39A.

The first reproduction unit 39A is a block inversely performing the processes performed on the pixel samples by the first mapping unit 11A.

When the HD-SDI signals of 64 channels in total are input, 8 sets of second reproduction units 39B convert the input HD-SDI signals into basic streams CH1 to CH64 through the use of the method shown in FIG. 19 according to the first embodiment and outputs the resultant basic streams to the first reproduction unit 39A.

The first reproduction unit 39A includes a clock supply circuit 121 supplying a clock to the constituent units. The first reproduction unit 39A includes RAMs 130-1 to 130-64 storing 64 basic streams CH1 to CH64 constituting the 1920×1080/50I-60I signals. Basic streams CH1 to CH64 correspond to CH1, CH3, CH5, CH7, . . . , and CH63 as Link A and CH2, CH4, CH6, CH8, . . . , and CH64 as Link B, which are input from the descrambling 8 B/10 B and P/S conversion unit 38. The writing control units 131-1 to 131-64 perform a writing control of storing the 64 basic streams CH1 to CH64 defined in the SMPTE 435-2 in the RAMs 130-1 to 130-64 in synchronization with the clock supplied from the clock supply circuit 121.

The first reproduction unit 39A further includes word multiplexing control units 129-1 to 129-64 controlling the word multiplexing (deinterleaving) process and RAMs 64-1 to 64-64 storing data multiplexed by the word multiplexing control units 129-1 to 129-64. The first reproduction unit 39A further includes line multiplexing control units 127-1 to 127-32 controlling the line multiplexing process and RAMs 126-1 to 126-32 storing data multiplexed by the line multiplexing control units 127-1 to 127-32.

The first reproduction unit 79A further includes first two-pixel multiplexing control units 125-1 to 125-4 controlling the process of multiplexing two pixel samples extracted from the RAMs 126-1 to 126-32. The first reproduction unit 39A further includes RAMs 124-1 to 124-4 storing the pixel samples multiplexed to the UHDTV1 class image by the first two-pixel multiplexing control units 125-1 to 125-4. The first reproduction unit 39A further includes a second two-pixel multiplexing control unit 122 multiplexing the pixel samples of the UHDTV1 class image extracted from the RAMs 124-1 to 124-4 to the UHDTV2 class image. The first reproduction unit 39A further includes a RAM 123 storing the pixel samples multiplexed to the UHDTV2 class image.

An operational example of the first reproduction unit 39A will be described below.

The clock supply circuit 121 supplies a clock to the second two-pixel multiplexing control unit 122, the first two-pixel multiplexing control units 125-1 to 125-4, the line multiplexing control units 127-1 to 127-32, the word multiplexing control units 129-1 to 129-64, and the writing control units 131-1 to 131-64. The constituent units are synchronized with the clock and the reading or writing of pixel samples is controlled.

The process of mapping the pixel samples extracted from the first to eighth sub-images on the UHDTV1 class image and the processes of line multiplexing and word multiplexing are performed in the same way as the pixel sample multiplexing process according to the second embodiment, and thus the detailed description thereof will not be made.

The second two-pixel multiplexing control unit 122 multiplexes the pixel samples read from the RAMs 124-1 to 124-4 every two pixels through the use of the following processes. That is, the second two-pixel multiplexing control unit 122 extracts two pixel samples from the first to fourth UHDTV1 class images in which m×n is 3840×2160 and a-b is set to 50P, 59.94P, and 60P, and multiplexes the extracted pixel samples to be adjacent to each other in the same line of the UHDTV2 class image of 7680×4320/50P, 59.94P, 60P/4:2:0/10 bit or 12 bit.

Here, the second two-pixel multiplexing control unit 122 multiplexes the pixel samples extracted by two pixel samples for each line from the same line in the video data area of the first UHDTV1 class image. At this time, the second two-pixel multiplexing control unit 122 multiplexes the pixel samples at intervals of 1 line in the 0-th line of the UHDTV2 class image and at intervals of two pixel samples in the same line. The second two-pixel multiplexing control unit 122 multiplexes the pixel samples extracted every two pixel samples for each line from the same line in the video data area of the second UHDTV1 class image. At this time, the second two-pixel multiplexing control unit 122 multiplexes the pixel samples at intervals of 1 line in the 0-th line of the UHDTV2 class image and at intervals of two pixel samples in the same line at positions different from the pixel samples multiplexed from the first UHDTV1 class image.

The second two-pixel multiplexing control unit 122 multiplexes the pixel samples extracted by two pixel samples for each line from the same line in the video data area of the third UHDTV1 class image. At this time, the second two-pixel multiplexing control unit 122 multiplexes the pixel samples at intervals of 1 line in the first line of the UHDTV2 class image and at intervals of two pixel samples in the same line. The second two-pixel multiplexing control unit 122 multiplexes the pixel samples extracted every two pixel samples for each line from the same line in the video data area of the fourth UHDTV1 class image. At this time, the second two-pixel multiplexing control unit 122 multiplexes the pixel samples at intervals of 1 line in the first line of the UHDTV2 class image and at intervals of two pixel samples in the same line at positions different from the pixel samples multiplexed from the third UHDTV1 class image.

This multiplexing process is repeatedly performed until all the pixel samples of the UHDTV1 class images are extracted and completely multiplexed to the UHDTV2 class images.

As a result, the 7680×4320/100P-120P/4:2:0/10 bit or 12 bit signal which are the class images defined by the UHDTV2 are stored in the RAM 123 and these signals are sent to a VTR or the like for reproduction.

FIG. 29 shows an example where the first and second two-pixel multiplexing processes, the line multiplexing process, and the word multiplexing process are performed in four steps using four types of RAMs. However, the 7680×4320/50P-60P/4:2:0/10 bit or 12 bit signal may be reproduced using a single RAM.

In the broadcasting camera 1 according to the third embodiment, the following thinning process is performed. That is, two pixel samples are thinned out twice from the 7680×4320 signal with a large number of pixels are mapped on plural 1920×1080 signals and then line thinning process is performed. Since this thinning process is a method utilizing the memory capacity to the minimum for mapping the signals and the memory capacity is minimized, it is possible to suppress the transmission delay of signals as much as possible.

The CCU 2 according to the third embodiment performs the word multiplexing process, the line multiplexing process, and the two-pixel multiplexing process on the basis of 64 HD-SDI signals received from the broadcasting camera 1 to generate the UHDTV1 class image. By generating the UHDTV2 class image from the UHDTV1 class image, it is possible to transmit the UHDTV2 class image through the current transmission interface to the broadcasting camera 1.

The CWDM/DWDM wavelength multiplexing technique can be used to transmit 10 G 16-channel signals via a single optical fiber.

### 4. Fourth Embodiment

### Process Example of Reducing Number of HD-SDI or 10 G-SDI Channels to be Transmitted to Half as Result of Investigation of UHDTV2 7680×4320/100P-120P/4:2:0/10 Bit or 12 Bit Multiplexing System

The 7680×4320/100P-120P/4:2:0/10 bit or 12 bit signal are signals whose frame rate doubles the frame rate of a signal defined in the S2036-1. The signal defined in the S2036-1 is a 7680×4320/50P-60P/4:2:0/10 bit or 12 bit signal. The digital signal formats such as a forbidden code of the 7680×4320/100P-120P signal and the 7680×4320/50P-60P signal are the same.

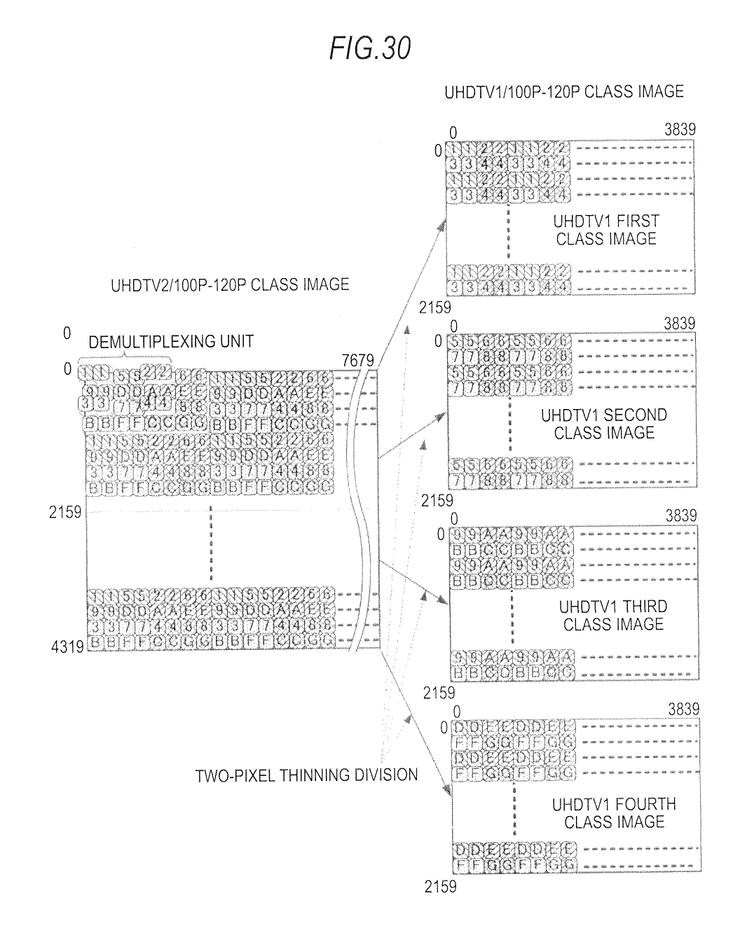

FIG. 30 shows an example where two pixel samples are thinned out in the line direction in units of two frames from the 7680×4320/100P-120P/4:2:0/10 bit or 12 bit signal.

At this time, the second two-pixel thinning control unit 102 shown in FIG. 28 thins out two pixel samples adjacent to each other in the same line from the UHDTV2 class image of 7680×4320/100P, 119.88P, 120P/4:2:0/10 bit or 12 bit. Then, the second two-pixel thinning control unit 102 maps the pixel samples on the first to fourth UHDTV1 class images in which m×n is set to 3840×2160 and a-b is set to 100P, 119.88P, and 120P.

Specifically, the pixel samples of the 7680×4320/100P-120P/4:2:0/10 bit or 12 bit signal are mapped on the 3840×2160/100P-120P/4:2:0/10 bit or 12 bit signal of channels. In the 4:2:0/10 bit signal out of the 3840×2160/100P-120P/4:2:0/10 bit or 12 bit signal of 4 channels, the default values are allocated to the signal component of “0” in the related art. Accordingly, the signals are mapped on the HD-SDI signals of 16 channels and then output through the use of the method described in the second embodiment and the resultant signals are input to the odd-number channels of the 10 G-SDI, whereby the signals can be transmitted with the 10 G mode-D of 4 channels.

Similarly, the default values are allocated to the signal component of “0” in the 4:2:0/12 bit signal. As the default values, 200 h can be allocated in the case of the 10-bit signal and 800 h can be allocated in the case of the 12-bit signal. Accordingly, since the 4:2:0/12 bit signals are mapped on the HD-SDI signals of 32 channels and the resultant signals are output, the signals can be transmitted with the 10 G mode-D of 4 channels. Therefore, the 7680×4320/100P-120P/4:2:0/10 bit or 12 bit signal can be transmitted with the 10 G mode-D of 16 channels in total.

Out of the 4:2:0 of the first to fourth UHDTV1 class images after performing the two-pixel thinning process, the first and second UHDTV1 class images are converted into the 4:2:2 signals and the third and fourth UHDTV1 class images are converted into 4:0:0 signals. Here, the default values (200 h in the case of the 10-bit signal and 800 h in the case of the 12-bit signal) are multiplexed to the signal component of “0”.

In the case of the 7680×4320/100P-120P/4:2:0/10 bit signal, the first to fourth UHDTV1 class images mapped through the two-pixel sample thinning are multiplexed to the HD-SDI signals of 16 channels through the method described in the second embodiment. However, 16 channels of HD-SDI signals to which the first UHDTV1 class image having the 4:2:2 signal format and the third UHDTV1 class image having the 4:0:0 signal format are multiplexed are converted. At this time, by converting the signals into 16 sets of dual link HD-SDI Link A/B having the same data structure as the 4:4:4 (R′G′B′ or Y′C′_{B}C′_{R})/10 bit signal through the use of the method shown in FIGS. 11 and 12 in the first embodiment, it is possible to transmit the video signal using the 10 G-SDI mode-D of 8 channels.

Similarly, 16 channels of HD-SDI signals to which the second UHDTV1 class image having the 4:2:2 signal format and the fourth UHDTV1/120P class image having the 4:0:0 signal format are multiplexed are converted. At this time, the signals are converted into 16 sets of dual link HD-SDI Link A/B having the same data structure as the 4:4:4 (R′G′B′ or Y′ C′_{B}C′_{R})/10 bit signal through the use of the method described in the first embodiment. Accordingly, since the video signal can be transmitted using the 10 G-SDI mode-D of 4 channels, it is possible to transmit the video signal using the 10 G-SDI mode-D of 8 channels in total and thus to reduce the transmission rate to a half in comparison with the method in the related art.

On the other hand, the second two-pixel multiplexing control unit 122 shown in FIG. 29 extracts two pixel samples from the first to fourth UHDTV1 class images in which m×n is 3840×2160 and a-b is set to 100P, 119.88P, and 120P. Then, the second two-pixel multiplexing control unit 122 multiplexes the two pixel samples to be adjacent in the same line of the UHDTV2 class image of 7680×4320/50P, 59.94P, 60P/4:2:0/10 bit or 12 bit.

In the broadcasting camera 1 according to the fourth embodiment, in the case of the 7680×4320/100P-120P/4:2:0/12 bit signal, the first to fourth UHDTV1 class images mapped through the two-pixel sample thinning are multiplexed to the HD-SDI signals of 32 channels through the use of the method described in the second embodiment. 32 channels of HD-SDI signals to which the first UHDTV1 class image having the 4:2:2 signal format and the third UHDTV1 class image having the 4:0:0 signal format are multiplexed are converted. At this time, the signals are converted into 16 sets of dual link HD-SDI Link A/B having the same data structure as the 4:4:4 (R′G′B′ or Y′C′_{B}C′_{R})/12 bit signal through the use of the method described in the first embodiment. Accordingly, it is possible to transmit the video signal using the 10 G-SDI mode-D of 4 channels.

Similarly, 32 channels of HD-SDI signals to which the second UHDTV1 class image having the 4:2:2 signal format and the fourth UHDTV1/120P class image having the 4:0:0 signal format are multiplexed are converted. At this time, the signals are converted into 16 sets of dual link HD-SDI Link A/B having the same data structure as the 4:4:4 (R′G′B′ or Y′C′_{B}C′_{R})/12 bit signal through the use of the method shown in FIGS. 7 and 8 in the first embodiment. Accordingly, since it is possible to transmit the video signal using the 10 G-SDI mode-D of 4 channels, it is possible to transmit the video signal using the 10 G-SDI mode-D of 8 channels in total and thus to reduce the transmission rate to a half in comparison with the method in the related a/According to the transmission system 10 according to the first to fourth embodiments, the following advantages can be achieved.

In the case of a 3840×2160/4:2:0/10 bit signal, two sets of Link A/B of the 4:2:2 signals obtained by mapping the even-number lines are converted to 4-channel Link A of 4 sets of newly-changed. Link A/B. The 10-bit signal obtained by multiplexing Link A/B of two sets of 4:0:0 signals, which are obtained by mapping the odd-number lines, to the Y channels is multiplexed again to the C channels of 4-channel Link B of 4 sets of newly-changed Link A/B. Accordingly, the same structure as the data structure of the 4:4:4 (R′G′B′ or Y′C′_{B}C′_{R})/10 bit signal defined in the SMPTE ST372 is achieved.

In the case of a 3840×2160/4:2:0/12 bit signal, the following process is performed. That is, out of 4 sets of Link A/B of the 4:2:2 signals obtained by mapping the even-number lines, 4-channel Link A to which the upper 10 bits of a 12 bit signal are multiplexed are converted into 4-channel Link A of sets of newly-changed Link A/B. The Y-channel (even number)-th pixel samples of 4-channel Link B obtained by multiplexing the lower 2 bits of the 12-bit signal are converted into the Y-channel (even number)-th pixel samples of 4-channel Link B of 4 sets of newly-changed Link A/B. The lower 2 bits of the 12-bit signal obtained by multiplexing 4-channel Link B of Link A/B of the 4:0:0 signal, which is obtained by mapping the Y-channel (odd number)-th pixel samples and the odd-number lines, to the Y channels are multiplexed to the (odd number)-th pixel samples again. This multiplexing process is performed on the Y-channel pixel samples of Link B of newly-changed Link A/B of 4 channels. By multiplexing again the upper 10 bits of the 12-bit signal multiplexed to the Y channels to the C channels, the same structure as the data structure of the 4:4:4 (R′G′B′ or Y′C′_{B}C′_{R})/12 bit signal defined in the SMPTE ST372 is achieved.

Accordingly, a 3840×2160 or 7680×4320/100P-120P signal which is a next-generation video signal under deliberation of the ITU or SMPTE are multiplexed as follows. That is, regarding the 4:2:0 sample signal, the details of 2-channel or 4-channel HD-SDI signal after mapping the 3840×2160 or 7680×4320/100P-120P signal on the multi-channel HD-SDI signals are multiplexed again. The data structure of the dual link HD-SDI signal converted into the format of the 4:4:4 (R′G′B′ or Y′C′_{B}C′_{R})/10 bit or 12 bit signal is achieved. Accordingly, it is possible to reduce the number of transmission channels of the HD-SDI signal or 10 G interface to be transmitted.

The 3840×2160/100P-120P or 7680×4320/100P-120P signal which has a high possibility of use is subjected to the two-pixel thinning or the line thinning and is finally subjected to the word thinning. Accordingly, It is possible to map the signal on the multi-channel 1920×1080/50I-60I signals. The mapping methods according to the first to fourth embodiments are the smallest in memory capacity to be used and small in time delay. The 1920×1080/50I-60I signal defined in the SMPTE 274M can be measured through the use of the current measuring instruments. The 3840×2160/100P-120P or 7680×4320/100P-120P signal may be thinned out and measured in units of pixels or in units of time. Since it is possible to match with all the current SMPTE mapping standards, these methods have a high possibility of favor in the future standardization of the SMPTE.

By thinning 4 k and 8 k signals every two pixel samples, it is possible to observe a video of the overall screen through the use of a current HD monitor or waveform monitor or to observe 8 k signals through the use of a 4 k monitor for the future. Accordingly, it is advantageous for analysis of defects in development of video devices or the like.

When transmitting the 3840×2160/100P-120P or 7680×4320/100P-120P signal at 10.692 Gbps of 4-channel or 16-channel mode-D, it is possible to construct a transmission system with the smallest delay. The method of thinning out two pixel samples from the frame of a 3840×2160 or 7680×4320 class image can be matched with the S2036-3 standard under deliberation of the SMPTE. The S2036-3 is associated with the standard of mapping 3840×2160/23.98P-60P or 7680×4320/23.98P-60P on multi-channel 10.692 Gbps mode-D signal.

It is possible to reduce the number of pixels extracted when thinning out or multiplexing the pixels and thus to suppress the amount of memory used as a temporary storage area. Here, the line thinning process of line-thinning out and converting the 1920×1080/50P-60P signals into 1920×1080/50I to 60I signals of 2 channels employs a method defined in the SMPTE 372 standard. This standard defines a method of mapping the 1920×1080/50P-60P signals on 1920×1080/50I-60I of 2 channels. Accordingly, by using the mapping method according to the above-mentioned embodiments, it is possible to match with the mapping method defined in the SMPTE 372 standard.

### 5. Modifications

The series of processes in the above-mentioned embodiments can be performed by hardware, but may be performed by software. When the series of processes is performed by software, programs constituting the software can be executed by a computer mounted on dedicated hardware or a computer having installed therein programs for performing various functions. For example, the programs constituting the software can be installed and executed in a general-purpose personal computer or the like.

A recording medium having recorded thereon program codes of the software for performing the functions of the above-mentioned embodiments may be supplied to a system or apparatus. Of course, a computer (a control unit such as a CPU) of the system or apparatus may read and execute the program codes stored in the recording medium to perform the functions.

Examples of the recording medium used to supply the program codes in this case include a flexible disk, a hard disk, an optical disc, a magneto-optical disc, a CD-ROM, a CD-R, a magnetic tape, a nonvolatile memory card, and a ROM.

By executing the program codes read by a computer, the functions of the above-mentioned embodiments can be performed. In addition, an OS operating in a computer may perform all or apart of the actual processes. The present disclose includes an example where the functions of the above-mentioned embodiment are performed through such a part or all of the actual processes.

The present disclosure is not limited to the above-mentioned embodiments, but includes various other applications and modifications without departing from the concept of the present disclosure described in the appended claims.

The present disclosure contains subject matter related to that disclosed in Japanese Priority Patent Application JP 2011-151191 filed in the Japan Patent Office on Jul. 7, 2011, the entire contents of which are hereby incorporated by reference.

What is claimed is:

1. A signal transmitting device comprising:
a first mapping unit including
a two-pixel thinning control unit that thins out two pixel samples adjacent to each other in the same line from a class image defined by an m×n (where m and n representing m samples and n lines are positive integers)/a−b (where a and b represent a frame rate of a progressive signal)/4:2:0/r bit signal whose number of pixels in a frame is greater than the number of pixels defined in the HD-SDI format and that maps the thinned-out pixel samples onto a video data area of first to N-th (where N is an integer equal to or greater than 2) sub-images defined by an m′×n′ (where m′ and n′ representing m′ samples and n′ lines are positive integers)/a′−b′ (where a′ and b′ represent a frame rate of a progressive signal)/4:2:2 or 4:0:0/r bit signal, and
a line thinning control unit that converts the first to N/2-th sub-images into 4:2:2/r bit signals and converts the (N/2+1)-th to N-th sub-images into 4:0:0/r bit signals when the pixel samples are thinned out at intervals of one line of the first to N-th sub-images onto which the pixel samples are mapped and are converted into interlaced signals; and
a second mapping unit that outputs a dual link HD-SDI signal obtained by converting a data structure of the 4:2:2/r bit signal and a data structure of the 4:0:0/r bit signal in a basic stream output from the first mapping unit into a data structure of a 4:4:4/r bit signal.

2. The signal transmitting device according to claim 1, wherein the r bit is set to 10 bits and N=4 is set,
wherein the second mapping unit multiplexes the first to fourth basic streams, into which the first and second sub-images are converted and which has the data structure of a 4:2:2/10 bit signal, to Link A of the dual link HD-SDI signals, multiplexes Y signals whose sample number is an even number out of the fifth to eighth basic streams, into which the third and fourth sub-images are converted and which has the data structure of a 4:0:0/10 bit signal, as Link B of the dual link HD-SDI signals to the (sample number+1)-th C′_{B} channels, and multiplexes odd-number samples of the Y signals in the 4:0:0/10 bit signals as the Link B of the HD-SDI signals to the (even sample number)-th C′_{R} channels to convert the first to eighth basic streams into the HD-SDI signals with the data structure of a 4:4:4/10 bit signal.

3. The signal transmitting device according to claim 2, wherein the r bit is set to 12 bits and N=4 is set,
wherein the first mapping unit includes a word thinning control unit that thins out the pixel samples, which are thinned out for each line by the line thinning control unit, for each word, that maps the thinned-out pixel samples onto an effective video data area of the HD-SDI defined in SMPTE 435-1, and that outputs the first to sixteenth basic streams, and
wherein the second mapping unit multiplexes the first, third, fifth, and seventh basic streams, into which the first and second sub-images are converted and which has the data structure of a 4:2:2/12 bit signal, to Link A of the dual link HD-SDI signals, multiplexes Y signals whose sample number is an even number in the second, fourth, sixth, and eighth basic streams, into which the first and second sub-images are converted and which has the data structure of a 4:2:2/12 bit signal, to the Y signals of the same sample numbers of CH2, CH4, CH6, and CH8 as Link B of the dual link HD-SDI signals, multiplexes the Y signals whose sample number is an even number in the ninth, eleventh, thirteenth, and fifteenth basic streams, into which the third and fourth sub-images are converted and which has the data structure of a 4:0:0/12 bit signal, to the (sample number+1)-th C′_{B} channels of CH2, CH4, CH6, and CH8 as the Link B of the dual link HD-SDI signals, multiplexes the Y signals whose sample number is an odd number in the ninth, eleventh, thirteenth, and fifteenth basic streams to the (sample number)-th C′_{R} channels of CH2, CH4, CH6, and CH8 as the Link B of the dual link HD-SDI signals, and multiplexes lower two bits of the Y signals whose sample number is an odd number in the second, fourth, sixth, and eighth basic streams and the Y signals of the tenth, twelfth, fourteenth, and sixteenth basic streams, into which the third and fourth sub-images are converted and which has the data structure of a 4:0:0/12 bit signal, to the Y signals whose sample number is an odd number in CH2, CH4, CH6, and CH8 as the Link B of the dual link HD-SDI signals.

4. The signal transmitting device according to claim 2, wherein the two-pixel thinning control unit thins out two pixel samples adjacent to each other in the same line of the frame, maps the pixel samples in the even-number lines of the frame in the first to fourth sub-images defined in the SMPTE 435-1 onto the first sub-image and the second sub-image every two pixel samples, and maps the pixel samples in the odd-number lines of the frame onto the third sub-image and the fourth sub-image.

5. The signal transmitting device according to claim 2, wherein the m×n is 3840×2160 in a UHDTV1 class image and the a-b is 100P, 119.88P, or 120P, and
wherein when the pixel sample are mapped onto the video data areas of the first to eighth sub-images in which the m′×n′ is 1920×1080 and the a′-b′ is 50P, 59.94P, and 60P, the two-pixel thinning control unit maps the pixel samples in the 0-th line of the first class image onto the video data areas of the first and second sub-images, maps the pixel samples in the first line of the first class image onto the video data areas of the third and fourth sub-images, maps the pixel samples in the second line of the first class image onto the video data areas of the fifth and sixth sub-images, maps the pixel samples in the third line of the first class image onto the video data areas of the seventh and eighth sub-images, maps the pixel samples in the 0-th line of the second class image onto the video data areas of the first and second sub-images, maps the pixel samples in the first line of the second class image onto the video data areas of the third and fourth sub-images, maps the pixel samples in the second line of the second class image onto the video data areas of the fifth and sixth sub-images, and maps the pixel samples in the third line of the second class image onto the video data areas of the seventh and eighth sub-images.

6. The signal transmitting device according to claim 2, further comprising a second two-pixel thinning control unit that thins out two pixel samples adjacent to each other in the same line from a UDHTV2 class image of 7680×4320/50P, 59.94P, 60P/4:2:0/10 bit or 12 bit and that maps the pixel samples onto first to fourth UHDTV1 class images in which the m×n is 3840×2160 and the a-b is 50P, 59.94P, and 60P.

7. The signal transmitting device according to claim 2, further comprising a second two-pixel thinning control unit that thins out two pixel samples adjacent to each other in the same line from a UDHTV2 class image of 7680×4320/100P, 119.88P, 120P/4:2:0/10 bit or 12 bit and that maps the pixel samples onto first to fourth UHDTV1 class images in which the m×n is 3840×2160 and the a-b is 100P, 119.88P, and 120P.

8. A signal transmitting method comprising:
thinning out two pixel samples adjacent to each other in the same line from a class image defined by an m×n (where and n representing m samples and n lines are positive integers)/a−b (where a and b represent a frame rate of a progressive signal)/4:2:0/r bit signal whose number of pixels in a frame is greater than the number of pixels defined in the HD-SDI format and mapping the thinned-out pixel samples onto a video data area of first to N-th (where N is an integer equal to or greater than 2) sub-images defined by an m′×n′ (where m′ and n′ representing m′ samples and n′ lines are positive integers)/a′−b′ (where a′ and b′ represent a frame rate of a progressive signal)/4:2:2 and 4:0:0/r bit signal;
converting the first to N/2-th sub-images into 4:2:2/r bit signals and converting the (N/2+1)-th to N-th sub-images into 4:0:0/r bit signals when the pixel samples are thinned out at intervals of one line of the first to N-th sub-images onto which the pixel samples are mapped and are converted into interlaced signals; and
outputting dual link HD-SDI signals obtained by converting a data structure of the 4:2:2/r bit signal and a data structure of the 4:0:0/r bit signal into a data structure of a 4:4:4/r bit signal.

9. A signal receiving device comprising first and second reproduction units that reproduce dual link HD-SDI signals,
wherein the second reproduction unit converts the dual link HD-SDI signals with a data structure of a 4:4:4/r bit signal into a basic stream with a data structure of a 4:2:2/r bit signal and a basic stream with a data structure of a 4:0:0/r bit signal,
wherein the first reproduction unit includes
a line multiplexing control unit that multiplexes the basic stream of the 4:2:0/r bit signals by pixel samples for each line of first to N/2-th (where N is an integer equal to or greater than 2) sub-images which are defined by m′ (where m′ and n′ representing m′ samples and n′ lines are positive integers)/a′−b′ (where a′ and b′ represent a frame rate of a progressive signal)/4:2:2/r bit signals and that multiplexes the basic stream of the 4:0:0/r bit signals by the pixel samples for each line of the (N/2+1)-th to N-th sub-images; and
a two-pixel multiplexing control unit that multiplexes two pixel samples extracted from the first to N-th sub-images so as to be adjacent to each other in the same line in a frame of the class image defined by m×n (where m and n representing m samples and n lines are positive integers)/a−b (where a and b represent a frame rate of a progressive signal)/4:2:0/r bit signals whose number of pixels in a frame is greater than the number of pixels defined in the HD-SDI format.

10. The signal receiving device according to claim 9, wherein when the r bit is set to 10 bits and N=4 is set, the second reproduction unit multiplexes Link A of the dual link HD-SDI signals to the first to fourth basic streams with the data structure of a 4:2:2/10 bit signal to reproduce the first and second sub-images, multiplexes Y signals as Link B of the dual link HD-SDI signals which are read from the (sample number+1)-th C′_{B} channels to the Y signals whose sample number is an even number out of the fifth to eighth basic streams with the data structure of a 4:0:0/10 bit signal to reproduce the third and fourth sub-images, and multiplexes the Y signals as the Link B of the HD-SDI signals which are read from the (even sample number)-th C′_{R} channels to the Y signals whose sample number is an odd number out of the 4:0:0/10 bit signals to convert the HD-SDI signals with the data structure of a 4:4:4/10 bit signal into the first to eighth basic streams.

11. The signal receiving device according to claim 9, wherein the r bit is set to 12 bits and N=4 is set,
wherein the first reproduction unit includes a word multiplexing control unit that multiplexes the pixel samples extracted from video data areas of the HD-SDI signals in which input first to sixteenth basic streams are defined in SMPTE 435-1 for each word, and
wherein the second reproduction unit converts the first, third, fifth, and seventh basic streams with the data structure of upper 10 bits of a 4:2:2/12 bit signal reproduced from CH1, CH3, CH5, and CH7 which are the Link A of the dual link HD-SDI signals into CH1, CH3, CH5, and CH7 created from the first and second sub-images, converts the Y signals having the same sample number as the second, fourth, sixth, and eighth basic streams with the data structure of a 4:2:2/12 bit signal reproduced from the Y signals with an even sample number of CH2, CH4, CH6, and CH8 which are the Link B of the dual link HD-SDI signals into the first and second sub-images, converts the Y signals reproduced from the (sample number+1)-th C′_{B} channels of CH2, CH4, CH6, and CH8 which are the Link B of the dual link HD-SDI signals into upper 10 bits of the third and fourth sub-images whose sample number is an even number in the ninth, eleventh, thirteenth, and fifteenth basic streams, converts the Y signals reproduced from the (sample number)-th C′_{R} channels of CH2, CH4, CH6, and CH8 which are the Link B of the dual link HD-SDI signals into upper 10 bits of the third and fourth sub-images whose sample number is an odd number in the ninth, eleventh, thirteenth, and fifteenth basic streams, converts the Y signals reproduced from the Y signals whose sample number is an odd number in CH2, CH4, CH6, and CH8 which are the Link B of the dual link HD-SDI signals into the Y signals whose sample number is an odd number in the second, fourth, sixth, and eighth basic streams, and converts lower 2 bits of the Y signals of the tenth, twelfth, fourteenth, and sixteenth basic streams with the data structure of a 4:0:0/12 bit signal into the third and fourth sub-images.

12. The signal receiving device according to claim 10, wherein the two-pixel multiplexing control unit multiplexes two pixel samples to be adjacent to each other in the same line of the frame when multiplexing two pixel samples extracted from the first sub-image and the second sub-image out of the first to fourth sub-images defined in the SMPTE 435-1 to the even-number lines of the frame and multiplexing two pixel samples extracted from the third sub-image and the fourth sub-image to the odd-number lines of the frame.

13. The signal receiving device according to claim 10, wherein the m×n in an UHDTV1 class image is 3840×2160 and the a-b is 100P, 119.88P, or 120P, and
wherein when multiplexing the pixel samples extracted from the video data areas of the first to eighth sub-images in which the m′×n′ is 1920×1080 and the a′-b′ is 50P, 59.94P, and 60P to the class image, the two-pixel multiplexing control unit multiplexes the pixel samples extracted from the video data areas of the first and second sub-images to the 0-th line of the first class image so as to be adjacent to each other, multiplexes the pixel samples extracted from the video data areas of the third and fourth sub-images to the first line of the first class image so as to be adjacent to each other, multiplexes the pixel samples extracted from the video data areas of the fifth and sixth sub-images to the second line of the first class image so as to be adjacent to each other, multiplexes the pixel samples extracted from the video data areas of the seventh and eighth sub-images to the third line of the first class image so as to be adjacent to each other, multiplexes the pixel samples extracted from the video data areas of the first and second sub-images to the 0-th line of the second class image so as to be adjacent to each other, multiplexes the pixel samples extracted from the video data areas of the third and fourth sub-images to the first line of the second class image so as to be adjacent to each other, multiplexes the pixel samples extracted from the video data areas of the fifth and sixth sub-images to the second line of the second class image so as to be adjacent to each other, and multiplexes the pixel samples extracted from the video data areas of the seventh and eighth sub-images to the third line of the second class image so as to be adjacent to each other.

14. The signal receiving device according to claim 10, further comprising a second two-pixel multiplexing control unit that extracts two pixel samples from the first to fourth UHDTV1 class images in which the m×n is 3840×2160 and the a-b is 50P, 59.94P, and 60P and multiplexes the extracted two pixel samples to be adjacent to each other in the same line of a UDHTV2 class image of 7680×4320/50P, 59.94P, 60P/4:2:0/10 bit or 12 bit.

15. The signal receiving device according to claim 10, further comprising a second two-pixel multiplexing control unit that extracts two pixel samples from the first to fourth UHDTV1 class images in which the m×n is 3840×2160 and the a-b is 100P, 119.88P, and 120P and multiplexes the extracted two pixel samples to be adjacent to each other in the same line of a UDHTV2 class image of 7680×4320/100P, 119.88P, 120P/4:2:0/10 bit or 12 bit.

16. A signal receiving method comprising:
converting dual link HD-SDI signals with a data structure of a 4:4:4/r bit signal into a 4:2:2/r bit signal and a 4:0:0/r bit signal;
multiplexing the basic stream of the 4:2:0/r bit signals by pixel samples for each line of first to N/2-th (where N is an integer equal to or greater than 2) sub-images which are defined by m′×n′ (where m′ and n′ representing m′ samples and n′ lines are positive integers)/a′−b′ (where a′ and b′ represent a frame rate of a progressive signal)/4:2:2/r bit signals and multiplexing the basic stream of the 4:0:0/r bit signals by pixel samples for each line of the (N/2+1)-th to N-th sub-images; and
multiplexing the two pixel samples extracted from the first to N-th sub-images so as to be adjacent to each other in the same line of a frame of the class image defined by m×n (where m and n representing m samples and n lines are positive integers)/a−b (where a and b represent a frame rate of a progressive signal)/4:2:0/r bit signals whose number of pixels in a frame is greater than the number of pixels defined in the HD-SDI format.

17. A signal transmission system comprising a signal transmitting device and a signal receiving device,
wherein the signal transmitting device includes
a two-pixel thinning control unit that thins out two pixel samples adjacent to each other in the same line from a class image defined by an m×n (where m and n representing m samples and n lines are positive integers)/a−b (where a and b represent a frame rate of a progressive signal)/4:2:0/r bit signal whose number of pixels in a frame is greater than the number of pixels defined in the HD-SDI format and that maps the thinned-out pixel samples onto a video data area of first to N-th (where N is an integer equal to or greater than 2) sub-images defined by an m′×n′ (where m′ and n′ representing m′ samples and n′ lines are positive integers)/a′−b′ (where a′ and b′ represent a frame rate of a progressive signal)/4:2:2 and 4:0:0/r bit signal,
a first mapping unit including a line thinning control unit that converts the first to N/2-th sub-images into 4:2:2/r bit signals and converts the (N/2+1)-th to N-th sub-images into 4:0:0/r bit signals when the pixel samples are thinned out at intervals of one line of the first to N-th sub-images onto which the pixel samples are mapped and are converted into interlaced signals, and
a second mapping unit that outputs a dual link HD-SDI signal obtained by converting a data structure of the 4:2:2/r bit signal and a data structure of the 4:0:0/r bit signal in a basic stream output from the first mapping unit into a data structure of a 4:4:4/r bit signal,
wherein the signal receiving device includes first and second reproduction units that reproduce dual link HD-SDI signals,
wherein the second reproduction unit converts the dual link HD-SDI signals into a data structure of a 4:2:2/r bit signal and a data structure of a 4:0:0/r bit signal, and
wherein the first reproduction unit includes
a line multiplexing control unit that multiplexes the 4:2:0/r bit signals by pixel samples for each line of the first to N/2-th (where N is an integer equal to or greater than 2) sub-images which are defined by m′×n′/a′−b′/4:2:2/r bit signals and that multiplexes the 4:0:0/r bit signals by the pixel samples for each line of the (N/2+1)-th to N-th sub-images, and
a two-pixel multiplexing control unit that multiplexes two pixel samples extracted from the first to N-th sub-images so as to be adjacent to each other in the same line in a frame of the class image defined by m×n/a−b/4:2:0/r bit signals whose number of pixels in a frame is greater than the number of pixels defined in the HD-SDI format.
